(19) United States
(12) Patent Application Publication
(10) Pub. No.: US 2026/0073605 A1
(43) Pub. Date: Mar. 12, 2026

(54) INFORMATION PROCESSING SYSTEM USING COLLECTIVE INTELLIGENCE, AND METHOD THEREFOR

(71) Applicant: DOCTER DAVID COMPANY, Seoul (KR)

(72) Inventor: Haeng Chul Kim, Gyeonggi-do (KR)

(21) Appl. No.: 18/862,980

(22) PCT Filed: May 4, 2023
(86) PCT No.: PCT/KR2023/006127

§ 371 Date: Sep. 18, 2025

(30) Foreign Application Priority Data
May 5, 2022 (KR) 10-2022-0055802
Jun. 20, 2022 (KR) 10-2022-0074901
Jun. 24, 2022 (KR) 10-2022-0077869
Jun. 28, 2022 (KR) 10-2022-0078565
Jun. 30, 2022 (KR) 10-2022-0080939
Jul. 1, 2022 (KR) 10-2022-0081533
Jul. 2, 2022 (KR) 10-2022-0081537
Jul. 3, 2022 (KR) 10-2022-0081573
Jul. 6, 2022 (KR) 10-2022-0083421
Jul. 7, 2022 (KR) 10-2022-0083434
Jul. 7, 2022 (KR) 10-2022-0083435
Jul. 13, 2022 (KR) 10-2022-0086003
Jan. 7, 2023 (KR) 10-2023-0002561
Jan. 11, 2023 (KR) 10-2023-0004191
Feb. 3, 2023 (KR) 10-2023-0014544
Feb. 4, 2023 (KR) 10-2023-0015225
Feb. 16, 2023 (KR) 10-2023-0020396
Feb. 16, 2023 (KR) 10-2023-0020402
Mar. 3, 2023 (KR) 10-2023-0028678
Mar. 5, 2023 (KR) 10-2023-0028841
Mar. 13, 2023 (KR) 10-2023-0032212
Apr. 4, 2023 (KR) 10-2023-0044101
Apr. 4, 2023 (KR) 10-2023-0044428
Apr. 5, 2023 (KR) 10-2023-0044453
Apr. 26, 2023 (KR) 10-2023-0054478
May 4, 2023 (KR) 10-2023-0058299

(51) Int. Cl. G06T 13/40; G06V 10/764; G06V 20/70

(52) U.S. Cl. CPC G06T 13/40; G06V 10/764; G06V 20/70

(57) ABSTRACT

The present invention provides an information processing system using collective intelligence, and a method therefor. The present invention labels one or more pieces of raw data related to specific content provided from a user, performs a learning function on the labeled raw data through a preset classification model and prediction model, additionally labels a first image, which is an output value of the prediction model, performs an additional learning function on the additionally-labeled first image through the classification model and the prediction model, so as to output a second image, and thus provides an avatar and/or an item related to the raw data to the user, and can improve the reasoning ability of artificial intelligence through labeling of the raw data.

### FIELD OF THE INVENTION

The present invention relates to an information processing system and method using collective intelligence, and more specifically, to a system and method that perform labeling on one or more raw data items related to specific content provided by the user, perform learning on the labeled raw data using pre-set classification models and prediction models, perform additional labeling on the first video output from the prediction model, and perform additional learning on the additionally labeled first video using the classification models and prediction models to output a second video.

### BACKGROUND OF THE INVENTION

Collective intelligence refers to the intelligence that results from the intellectual capabilities accumulated by group members through cooperation or competition, or the representation of such collective abilities.

With the advancement of information database technologies for avatars, items, robotics, and more, there is a growing need to connect this collective intelligence with new big data-based knowledge services.

### BRIEF SUMMARY OF THE INVENTION

### Technical Challenge

The objective of the present invention is to provide an information processing system and method using collective intelligence, wherein labeling is performed on one or more pieces of raw data related to specific content provided by a user; learning is performed on the labeled raw data through a predetermined classification model and prediction model; additional labeling is performed on a first image, which is an output value of the prediction model; and additional learning is performed on the additionally labeled first image through the classification model and prediction model, thereby outputting a second image.

Another objective of the present invention is to provide an information processing system and method using collective intelligence, wherein an operation-related video of an actual human, a virtual avatar, or an item is reconstructed into a robot operation video; labeling is performed on the reconstructed robot operation video; learning is performed on the labeled robot operation video through a predetermined classification model and prediction model; additional labeling is performed on a first robotics video, which is the result of the learning; and additional learning is performed on the additionally labeled first robotics video through the classification model and prediction model, thereby outputting a second robotics video.

### Means for Solving the Problem

According to an embodiment of the present invention, an information processing system using collective intelligence may include a terminal that transmits one or more pieces of raw data collected in relation to a specific subject together with metadata related to the raw data, a comparison target image, metadata related to the comparison target image, and identification information of the terminal, and a server that receives from the terminal the raw data, the metadata, the comparison target image, the metadata related to the comparison target image, and the identification information of the terminal. The server cooperates with the terminal to perform selective labeling on the one or more pieces of raw data, performs artificial intelligence-based machine learning on the selectively labeled raw data based on the information thereof, and generates a classification value for the raw data on the basis of the result of the machine learning. The server then performs additional machine learning using, as input values, the classification value for the raw data, the information on the selectively labeled raw data, the raw data, the metadata related to the raw data, the comparison target image, and the metadata related to the comparison target image, thereby generating, based on the result of the machine learning, a first image corresponding to the raw data, and transmitting the generated first image to the terminal.

In an exemplary embodiment, the server, in conjunction with the terminal, may perform additional selective labeling on the first video, performs machine learning based on artificial intelligence using the information about the additionally selectively labeled first video, generates classification values for the first video based on the machine learning results, and performs machine learning using the classification values of the first video, the information about the additionally selectively labeled first video, the first video itself, meta information related to the first video, comparison videos, and meta information related to the comparison videos as input values. The server generates a second video corresponding to the first video based on the machine learning results and transmits the generated second video to the terminal.

In an exemplary embodiment, the server, for a specific subject, may perform the earlier processes of selective labeling, classification model inference, prediction model inference, additional selective labeling on the generated first video, additional classification model inference, and additional prediction model inference on the multiple raw data items provided by multiple terminals, thereby generating a second video aggregated by collective intelligence for the specific subject.

In order to achieve the above object, exemplary embodiments of the present invention can provide an information processing method using collective intelligence including a step in which the server receives one or more raw data items related to a specific subject, meta information related to the raw data, comparison videos, meta information related to the comparison videos, and the identification information of the terminal from the terminal; a step in which the server, in conjunction with the terminal, performs selective labeling on the one or more raw data items; a step in which the server performs machine learning based on artificial intelligence using the information about the selectively labeled raw data, and generates classification values for the raw data based on the machine learning results; a step in which the server performs machine learning using the generated classification values of the raw data, information about the selectively labeled raw data, the raw data itself, meta information related to the raw data, comparison videos, and meta information related to the comparison videos as input values, and generates a first video corresponding to the raw data based on the machine learning results; a step in which the server transmits the generated first video to the terminal; and a step in which the terminal outputs the first video transmitted from the server.

In an exemplary embodiment, the step of performing selective labeling on the one or more raw data items may involve setting label values at one or more specific points and/or one or more specific sections of the raw data displayed on the terminal, based on user input.

In an exemplary embodiment, the step of performing selective labeling on the one or more raw data items may involve setting label values for correct or incorrect motions of an object within the raw data displayed in the video display area of the terminal, at specific points or specific sections, based on user input from the terminal.

In an exemplary embodiment, before or after performing selective labeling on the one or more raw data items, the server, in conjunction with the terminal, may further perform hierarchical labeling on the one or more raw data items.

In an exemplary embodiment, the step of performing hierarchical labeling on the one or more raw data items may involve setting label values at different specific points and/or different specific sections of the raw data displayed on the terminal, based on user input and pre-set multiple label classifications, and dividing the raw data into multiple sub-raw data.

In an exemplary embodiment, the step of generating classification values for the raw data based on the machine learning results may involve performing machine learning on the information about the selectively labeled raw data as input into a pre-set classification model and generating classification values for the raw data based on the machine learning results.

In an exemplary embodiment, the step of generating a first video corresponding to the raw data based on the machine learning results may involve performing machine learning using the classification values of the raw data, the information about the selectively labeled raw data, the raw data itself, meta information related to the raw data, the comparison videos, and meta information related to the comparison videos as input into a pre-set prediction model, and generating the first video related to the raw data based on the machine learning results.

In an exemplary embodiment, the server, in conjunction with the terminal, performs additional selective labeling on the first video, the server may perform machine learning based on artificial intelligence using the information about the additionally selectively labeled first video, generates classification values for the first video based on the machine learning results, performs machine learning using the classification values of the first video, the information about the additionally selectively labeled first video, the first video itself, meta information related to the first video, the comparison videos, and meta information related to the comparison videos as input values, and generates a second video corresponding to the first video based on the machine learning results; the server transmits the generated second video to the terminal; and the terminal outputs the second video transmitted from the server.

the server may perform iterative processes of selective labeling, classification model inference, prediction model inference, additional selective labeling on the generated first video, additional classification model inference, and additional prediction model inference on the multiple raw data items provided by multiple terminals, thereby generating a second video aggregated by collective intelligence for the specific subject.

In an exemplary embodiment, the step of performing additional selective labeling on the first video may involve the terminal dividing the first video into multiple sub-videos based on information about the sub-raw data divided through hierarchical labeling of the raw data; the terminal receiving user input of label values for correct or incorrect motions for each of the sub-videos; the terminal receiving label values indicating the order of the sub-videos to sort them, based on user input the terminal transmitting the label values for the correct or incorrect motions of the sub-videos, the label values for sorting the sub-videos, and the identification information of the terminal to the server; and the server receiving the label values for the correct or incorrect motions of the sub-videos, the label values for sorting the sub-videos, and the identification information of the terminal, in response to performing time-series division selective labeling on the first video.

In an exemplary embodiment, the step of performing additional selective labeling on the first video may involve the terminal dividing the first video into multiple sub-videos based on information about the sub-raw data divided through hierarchical labeling of the raw data; the terminal receiving user input of label values for the motion sequence of the avatar contained in each of the sub-videos; the terminal receiving label values for sorting the motion sequences of the avatar by body part in each of the sub-videos, based on user input; the terminal transmitting the label values for the motion sequence of the avatar contained in the sub-videos, the label values for sorting the sub-videos, and the identification information of the terminal to the server; and the server receiving the label values for the motion sequence of the avatar contained in the sub-videos, the label values for sorting the sub-videos, and the identification information of the terminal, in response to performing body-part-specific selective labeling on the first video.

In order to achieve the above object, exemplary embodiments of the present invention can provide an information processing system using collective intelligence including a server and a terminal The server may collect movement-related videos of actual humans, avatars, and items, and meta information related to the movement-related videos, related to a specific subject, may reconstruct the collected movement-related videos as robot operation videos to implement the actual robot's movement, may perform selective labeling on the robot operation videos in conjunction with the terminal, may perform machine learning based on artificial intelligence using the information about the selectively labeled robot operation videos, may generate classification values for the robot operation videos based on the machine learning results, may generate a first robotics video corresponding to the robot operation videos using the classification values of the robot operation videos, the information about the selectively labeled robot operation videos, the robot operation videos themselves, meta information related to the robot operation videos, comparison videos, and meta information related to the comparison videos, and may transmit the generated first robotics video to the terminal. The terminal may output the first robotics video transmitted from the server.

In an exemplary embodiment, the server, in conjunction with the terminal, may perform additional selective labeling on the first robotics video, performs machine learning based on artificial intelligence using the information about the additionally selectively labeled first robotics video, generates classification values for the first robotics video based on the machine learning results, performs machine learning using the classification values of the first robotics video, the information about the additionally selectively labeled first robotics video, the first robotics video itself, meta information related to the first robotics video, comparison videos, and meta information related to the comparison videos as input values, and generates a second robotics video corresponding to the first robotics video based on the machine learning results. The server then transmits the generated second robotics video to the terminal.

In an exemplary embodiment, the server, for a specific subject, may perform iterative processes of selective labeling, classification model inference, prediction model inference, additional selective labeling on the generated first robotics video, additional classification model inference, and additional prediction model inference on the multiple movement-related videos provided by multiple terminals related to actual humans, avatars, or items, thereby generating a second robotics video aggregated by collective intelligence for the specific subject.

In order to achieve the above object, exemplary embodiments of the present invention can provide an information processing method using collective intelligence including a step in which the server collects movement-related videos and meta information related to the movement-related videos of actual humans, avatars, or items related to a specific subject, a step in which the server reconstructs the collected movement-related videos as robot operation videos to implement the actual robot's movement, a step in which the server, in conjunction with the terminal, performs selective labeling on the robot operation videos, a step in which the server performs machine learning based on artificial intelligence using the information about the selectively labeled robot operation videos and generates classification values for the robot operation videos based on the machine learning results, a step in which the server performs machine learning using the classification values of the robot operation videos, the information about the selectively labeled robot operation videos, the robot operation videos themselves, meta information related to the robot operation videos, comparison videos, and meta information related to the comparison videos as input values, and generates a first robotics video corresponding to the robot operation videos based on the machine learning results, a step in which the server transmits the generated first robotics video to the terminal, and a step in which the terminal outputs the first robotics video transmitted from the server.

In an exemplary embodiment, before or after performing selective labeling on the robot operation videos, the server, in conjunction with the terminal, may further perform hierarchical labeling on the robot operation videos.

In an exemplary embodiment, the server, in conjunction with the terminal, may perform additional selective labeling on the first robotics video, performs machine learning based on artificial intelligence using the information about the additionally selectively labeled first robotics video, generates classification values for the first robotics video based on the machine learning results, performs machine learning using the classification values of the first robotics video, the information about the additionally selectively labeled first robotics video, the first robotics video itself, meta information related to the first robotics video, comparison videos, and meta information related to the comparison videos as input values, and generates a second robotics video corresponding to the first robotics video based on the machine learning results, the server then transmits the generated second robotics video to the terminal, and the terminal outputs the second robotics video transmitted from the server.

the server, for a specific subject, may perform iterative processes of selective labeling, classification model inference, prediction model inference, additional selective labeling on the generated first robotics video, additional classification model inference, and additional prediction model inference on the multiple movement-related videos provided by multiple terminals related to actual humans, avatars, or items, thereby generating a second robotics video aggregated by collective intelligence for the specific subject.

### The Effect of Invention

The present invention provides the effect of enabling avatars and/or items related to raw data to be provided to a user, and of improving the inference capability of artificial intelligence through labeling of the raw data, by performing labeling on one or more pieces of raw data related to specific content provided by the user, performing learning on the labeled raw data through a predetermined classification model and prediction model, performing additional labeling on a first image that is an output value of the prediction model, and performing additional learning on the additionally labeled first image through the classification model and prediction model so as to output a second image.

The present invention also provides the effect of improving the learning capability of artificial intelligence by repeatedly applying the outcome generated by artificial intelligence to the classification model and prediction model of the artificial intelligence itself, wherein an operation-related video of an actual human, a virtual avatar, or an item is reconstructed into a robot operation video, labeling is performed on the reconstructed robot operation video, learning is performed on the labeled robot operation video through a predetermined classification model and prediction model, additional labeling is performed on a first robotics video that is the result of the learning, and additional learning is performed on the additionally labeled first robotics video through the classification model and prediction model so as to output a second robotics video.

### BRIEF DESCRIPTION OF THE DRAWINGS

FIG. 1 is a block diagram illustrating the configuration of an information processing system using collective intelligence according to an embodiment of the present invention.

FIG. 2 is a schematic diagram of hierarchical clustering of raw data (real-world data/robot operation video) according to an embodiment of the present invention.

FIG. 3 is a conceptual diagram illustrating the definition of three-dimensional shapes in the divided motion video from FIGS. 4 to 6 according to an embodiment of the present invention.

FIG. 4 is a conceptual diagram illustrating the collection of n pieces of information regarding the motion of an avatar (human) and/or robotics in the form of three-dimensional shapes according to an embodiment of the present invention.

FIG. 5 is a conceptual diagram illustrating the collection of n′ pieces of information regarding the motion of an avatar (human) and/or robotics in the form of three-dimensional shapes according to an embodiment of the present invention.

FIG. 6 is a conceptual diagram illustrating the collection of N pieces of information regarding the motion of an avatar (human) and/or robotics in the form of three-dimensional shapes according to an embodiment of the present invention.

FIG. 7 is a schematic diagram of hierarchical clustering processed based on data unit 3 according to an embodiment of the present invention.

FIG. 8 is a schematic diagram of hierarchical clustering processed based on digital unit 3 according to an embodiment of the present invention.

FIG. 9 is a schematic diagram of hierarchical clustering processed based on data unit 4 according to an embodiment of the present invention.

FIG. 10 is a schematic diagram of hierarchical clustering processed based on digital unit 4 according to an embodiment of the present invention.

FIG. 11 is a schematic diagram of hierarchical clustering processed based on digital unit 5 according to an embodiment of the present invention.

FIG. 12 is a flowchart illustrating how processed data is applied in an inference and/or reasoning algorithm according to an embodiment of the present invention.

FIG. 13 is a diagram illustrating the principle of a GNN regression model according to an embodiment of the present invention.

FIG. 14 is a diagram illustrating a method for generating virtual avatars and items using GAN according to an embodiment of the present invention.

FIG. 15 is a diagram illustrating the principle of applying continuously collected basic video information to a single model along with existing data according to an embodiment of the present invention.

FIG. 16 is a diagram illustrating the principle of visual rendering performed by the server and outputted and generated on the terminal according to an embodiment of the present invention.

FIG. 17 is a diagram illustrating the principle of creating digital units through labeling according to an embodiment of the present invention.

FIG. 18 is a diagram illustrating the principle of how collective intelligence robotics operate on the server according to an embodiment of the present invention.

FIG. 19 is a diagram illustrating the principle of advancing collective intelligence robotics through robotics labeling according to an embodiment of the present invention.

FIG. 20 is a diagram illustrating a virtuous cycle structure as a platform where users, participants, and companies generate profit and enhance the fun element according to an embodiment of the present invention.

FIG. 21 is a diagram illustrating a method for providing a platform for generating and/or outputting virtual avatars and items using GAN and/or GNN according to an embodiment of the present invention.

FIG. 22 is a flowchart illustrating an information processing method using collective intelligence according to the first embodiment of the present invention.

FIGS. 23 to 28 are diagrams illustrating examples of the terminal screens according to an embodiment of the present invention.

FIG. 29 is a flowchart illustrating an information processing method using collective intelligence according to the second embodiment of the present invention.

FIGS. 30 to 32 are diagrams illustrating examples of the terminal screens according to an embodiment of the present invention.

### BEST MODE FOR CARRYING OUT THE INVENTION

It should be noted that the technical terms used in the present invention are merely used to explain specific embodiments and are not intended to limit the invention. Also, unless otherwise defined in the present invention, the technical terms used herein should be interpreted in the sense generally understood by those skilled in the art to which this invention belongs, and should not be interpreted in an excessively broad or excessively narrow sense. Furthermore, if the technical terms used in this invention are incorrect and do not accurately express the concept of the invention, they should be replaced with correct technical terms that can be properly understood by those skilled in the art. In addition, general terms used in the present invention should be interpreted according to their definition in the dictionary or based on the context, and should not be interpreted in an overly narrow sense.

Moreover, singular expressions used in the present invention should be understood to include plural expressions unless the context clearly indicates otherwise. Terms such as “comprises” or “includes” in the present invention should not be interpreted as requiring all of the listed components or steps, and it should be understood that some components or steps may not be included, or additional components or steps may be included.

Additionally, terms like “first” and “second,” etc., that include ordinal numbers, may be used to describe components but should not limit the components by these terms. These terms are only used to distinguish one component from another. For example, without departing from the scope of the invention, a “first” component may be referred to as a “second” component, and similarly, a “second” component may be referred to as a “first” component.

Hereinafter, preferred embodiments of the present invention will be described in detail with reference to the accompanying drawings. However, the same or similar components are given the same reference numerals regardless of the figure, and redundant explanations are omitted.

Additionally, in the description of the present invention, detailed descriptions of related known technologies may be omitted if it is determined that they may obscure the essence of the present invention. Also, it should be noted that the attached drawings are only to facilitate understanding of the concept of the invention and should not be interpreted as limiting the scope of the invention by the drawings.

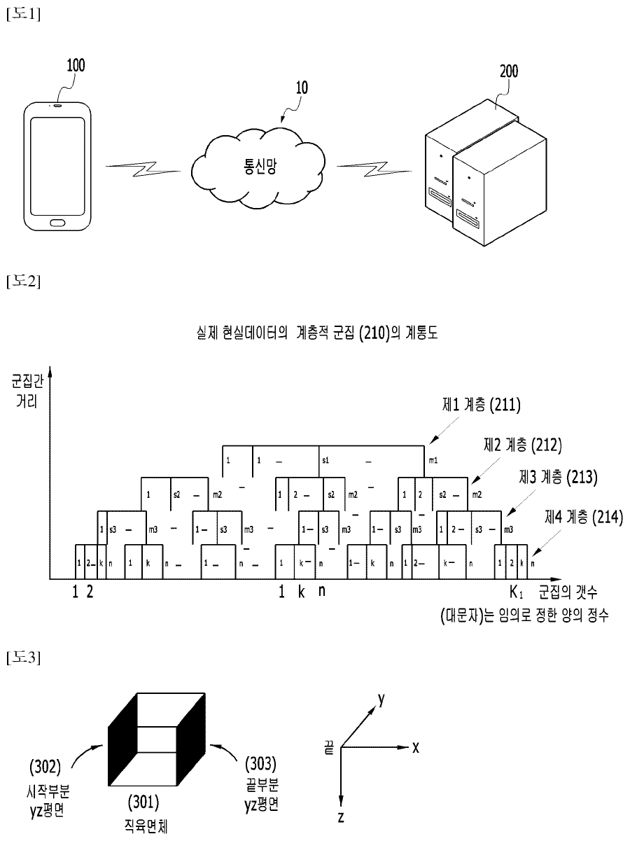

FIG. 1 is a block diagram illustrating the configuration of an information processing system (10) using collective intelligence according to an embodiment of the present invention.

As shown in FIG. 1, the information processing system (10) using collective intelligence consists of a terminal (100) and a server (200). Not all components of the information processing system (10) using collective intelligence shown in FIG. 1 are essential, and the system (10) can be implemented with more or fewer components than those depicted in FIG. 1.

The terminal (100) may be applied to various devices such as a smartphone, portable terminal, mobile terminal, foldable terminal, personal digital assistant (PDA), portable multimedia player (PMP), telematics terminal, navigation terminal, personal computer, notebook computer, slate PC, tablet PC, ultrabook, wearable devices (e.g., smartwatch, smart glasses, head-mounted display (HMD)), WiBro terminal, IPTV terminal, smart TV, digital broadcasting terminal, AVN (Audio Video Navigation) terminal, A/V system, flexible terminal, digital signage device, VR simulator, robot, and others.

The server (200) may be implemented in forms such as cloud computing, grid computing, server-based computing, utility computing, network computing, quantum cloud computing, web server, database server, or proxy server. Additionally, the server (200) may have various software installed, including a network load balancing mechanism, allowing the server to operate on the internet or other networks. The server may be formed a computerized system using the various software as mentioned the above. The network can be an HTTP network, a private line, an intranet, or any other type of network. Furthermore, the connection between the terminal (100) and the server (200) can be secured to prevent attacks from hackers or other third parties. The server (200) may also include multiple database servers connected, and the database servers can be implemented in a manner that connects them separately to the server (200) through any type of network connection, including distributed database server architecture.

Each of the terminal (100) and server (200) may include a communication unit (not shown) for performing communication functions with other terminals, a storage unit (not shown) for storing various information and programs (or applications), a display unit (not shown) for displaying the results of various information and program execution, a voice output unit (not shown) for outputting voice information corresponding to the results of executing various programs, and a control unit (not shown) for controlling the various components and functions of the terminals.

The terminal (100) communicates with the server (200). In this case, the terminal (100) may be a device owned by a user (or an expert in a specific field) that performs functions such as collecting raw data, hierarchical labeling of information/videos, selective labeling of information/videos, time-series division selective labeling of information/videos, and selective labeling of information/videos by body parts through a dedicated app provided by the server (200).

The terminal (100), in conjunction with the server (200), may be used to register a user as a member. The membership of the member is allowed to access functions like raw data collection, hierarchical labeling of information/videos, selective labeling of information/videos, time-series division selective labeling of information/videos, and selective labeling of information/videos by body parts, via a dedicated app and/or website provided by the server (200). The user registers personal information, such as an ID, email address, password, name, gender, date of birth, contact information, and address, with the server (200).

The user of the terminal (100) may also registered as user for the server (200) using SNS account information or account information from other sites or mobile messenger accounts. The SNS accounts may include Facebook, Twitter, Instagram, Kakao Story, or Naver Blog, while other site accounts could include YouTube, Kakao, or Naver. The mobile messenger accounts could include KakaoTalk, Line, Viber, WeChat, WhatsApp, Telegram, or Snapchat.

During the membership registration process, the terminal (100) may require authentication through personal identification means (such as a mobile phone, credit card, I-PIN, etc.) to complete the membership registration process with the server (200).

Once membership registration is completed, the terminal (100) installs the dedicated app (or application) provided by the server (200) to use the services offered by the server (200). The dedicated app may include a native app, mobile web app, responsive web design (RWD) app, adaptive web design (AWD) app, or hybrid app and may perform functions such as raw data collection, hierarchical labeling of information/videos, selective labeling of information/videos, time-series division selective labeling of information/videos, and selective labeling of information/videos by body parts.

After membership is completed, the terminal (100) may display discount coupons provided by the server (200) through the dedicated app. These discount coupons may include discounts on services such as raw data collection, hierarchical labeling of information/videos, selective labeling of information/videos, time-series division selective labeling of information/videos, and selective labeling of information/videos by body parts.

To execute these services of the server (200), the terminal (100) may be linked with the server (200) and a payment server (not shown) to perform payment functions according to a subscription model. The server (200) may execute payments using various methods such as credit card payments, automatic transfers linked to a bank payment account, cash or cash-equivalent points remaining in the terminal (100)'s account, or simple payment methods like KakaoPay or NaverPay.

If a payment fails, the terminal (100) receives failure information (e.g., insufficient funds, limit exceeded) from the server (200) (or the payment server) and displays the failure status.

Moreover, after the payment function is successfully executed, the terminal (100) receives the payment execution result transmitted from the server (200). This payment execution result includes information such as the subscription period, payment amount, payment date, and time.

Additionally, the terminal (100) runs a dedicated app that was pre-installed on the terminal (100) and displays the app execution result screen. This app execution result screen displays a collection menu (or button/item) for collecting one or more raw data related to a specific topic and meta-information related to the raw data, a view menu for displaying collected information or information provided by the server (200), and a settings menu for configuration purposes. Here, the terminal (100) is registered to the server (200) providing the dedicated app. Through the execution of the dedicated app, the login procedure may be carried out using the user ID and password or a barcode or QR code containing the user ID. Then the terminal (100) can perform one or more functions of the app, such as raw data collection, hierarchical labeling of information/videos, selective labeling of information/videos, time-series division selective labeling of information/videos, and selective labeling of information/videos by body parts.

Moreover, if a pre-set collection menu is selected on the app execution result screen displayed on the terminal (100), the terminal (100) shows a collection screen corresponding to the selected collection menu in order to collect one or more raw data related to a specific topic, meta-information related to the raw data, comparison videos, and meta-information related to the comparison videos from one or more visual set devices (not shown) as configured by user settings. The collection screen displays information collection target selection items for selecting one or more visual set devices to be linked with the terminal (100), collection information type selection items for selecting the type of information to be collected from the selected target, and collection start items to initiate the collection of information from the selected information collection target.

Additionally, the terminal (100) receives multiple input values corresponding to multiple input items through user input (or selection/touch/control by a user or expert) on the collection screen displayed on the terminal (100). These input values include the information collection target (or information about the visual set device/identification information of the visual set device) and the type of information to be collected, such as sequential still images (or multiple sequential still images), video, measurement values, sensor values, and others.

Furthermore, the terminal (100) interacts with one or more visual set devices based on the received input values to collect one or more raw data, meta-information related to the raw data, comparison videos, and meta-information related to the comparison videos, all related to a specific topic. This specific topic (or content) could include medical procedures (e.g., treatments, surgeries), dance, sports activities (e.g., soccer, basketball, table tennis), games, e-sports, and more. The terminal (100) may collect one piece of raw data from one user or multiple different raw data (or annotation stage data/attribute item raw data/basic video information) from one user. The comparison videos in this context should not violate intellectual property rights such as copyrights or portrait rights.

The visual set device communicates with the terminal (100), the server (200), and other devices.

The visual set device may include a camera unit, LiDAR, eye-tracker, motion capture and motion tracker, and medical equipment (e.g., CT, scanner, MRI, medical ultrasound).

The visual set device acquires (or collects/shoots/measures) real-world videos (or real-world video information) related to the location (or area) where the device is configured (or arranged/installed). The real-world video represents raw data (or original/source/visual data) and includes sequential still images (or multiple sequential still images/attributes), video (or target attributes), measurement values obtained (or collected/shot/measured) from the real world. These measurement values may include video information (or 3D data) measured through the LiDAR, eye-tracker, motion capture and tracker, and medical equipment. The obtained real-world video can also be merged and used.

Furthermore, the terminal (100) may work in conjunction with the Cinematic Reality of the Siemens Healthineers, which is a medical support application developed using Microsoft's HoloLens 2, to acquire real-world video. The Cinematic Reality may render voxel data obtained from medical CT and MRI. Data rendered by the Cinematic Reality is used as a dataset for creating digital cadavers, 3D printed artificial cadavers, and more. At this time, the voxel data is used by merging the voxel data with GNN-type point cloud data.

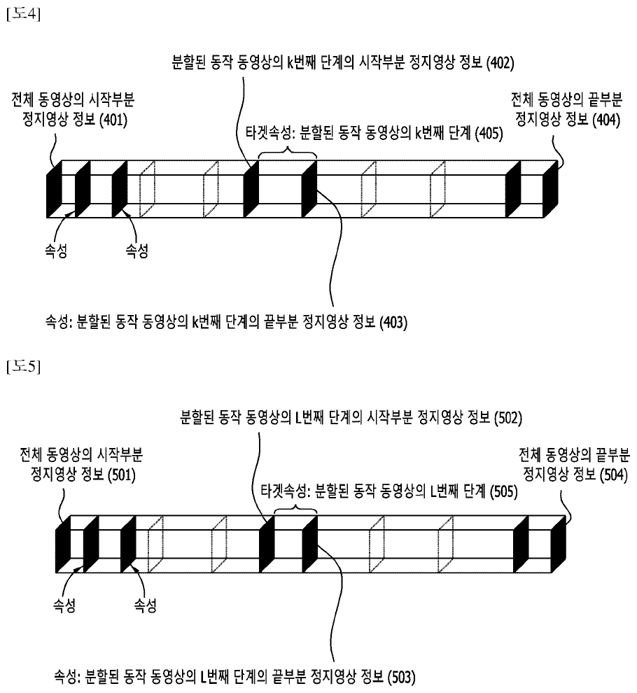

FIG. 2 illustrates raw data according to an embodiment of the present invention. The raw data includes real-world video (or real-world data), robot operation video (or robot operation video information), and more. The robot operation video is acquired from the operation of an actual robot using a visual set device, and the robot operation video is applied to the embodiments in FIGS. 1 through 17 and FIG. 22 in the same manner as the raw data of an avatar and/or item.

The raw data shown in FIG. 2 represents K₁ clusters (or sequential data/static images), where K may be a natural number (or a positive integer). The virtual generated data (Augmentation data) produced by the server (200) is also included in the raw data.

Additionally, the virtual generated data produced by using the raw data in FIG. 2 is provided as attribute items (or multiple data in the annotation stage).

The primary goal of this invention is to maximize performance in virtual surgery simulation and virtual tooth deletion simulation by using a small amount of real-world surgical data (or real-world video information/raw data). For this, the generated virtual digital cadaver data is provided during the training and simulation stages, and the virtual digital cadaver data may be labeled by the doctor so as to train the artificial intelligence (or classification/prediction models) in a supervised learning manner.

The digital cadaver is the avatar of the patient. To compensate the limitations of the digital cadavers, where it is difficult to reflect individual patients' distinct anatomical structures (or variations) due to the uniform digital properties, medical data collected from medical devices in the clinical field (or from the visual set device), such as CT, X-ray, ultrasound devices, oral scanners, and more, along with the expertise and knowledge of professionals, can be used. By using this comprehensive information, digital cadavers and artificial cadavers that reflect the variations of specific patients can be used in combination to conduct virtual treatments, virtual surgeries, and other procedures through virtual reality (VR) and 3D simulators (not shown).

Furthermore, the terminal (100) transmits at least one raw data related to a specific subject, meta information related to the raw data, comparison target video, meta information related to the comparison target video, the terminal's identification information, and so on, to the server (200). The identification information of the terminal (100) includes MDN (Mobile Directory Number), mobile IP, mobile MAC, unique SIM card information (Subscriber Identity Module), serial number, etc.

If the comparison target video related to the raw data is not collected from the terminal (100), the terminal (100) transmits at least one more raw data related to the collected specific subject, the meta information related to the raw data, the terminal(100)'s identification information and so on, to the server (200).

Additionally, the terminal (100) receives the comparison target video related to the raw data and the meta information related to the comparison target images, in response to the transmission from the server (200). The terminal (100) matches (or maps) the received comparison target video related to the received row data and the meta information related to the received comparison target video with at least one more raw data related to the specific subject and meta information related to the raw data, for management.

Furthermore, the terminal (100) displays (or outputs) at least one more raw data, meta information related to the raw data, comparison target video, and the meta information related to the comparison target video, with respect to the collected specific subject. The terminal (100) may also apply virtual reality (VR), augmented reality (AR), extended reality (XR), or mixed reality (MR) to display the raw data.

When a pre-configured view menu is selected in the app execution screen displayed on the terminal (100), the terminal (100) displays the view screen corresponding to the selected view menu in order to display the collected information in the terminal (100) or the information provided by the server (200). The view screen may display a video display area for the raw data or generated video, a comparison target video display area for the target video display area, a hierarchical labeling input menu for selecting variable values (or label values) for hierarchical labeling, a selective labeling input menu for selecting settings for selective labeling, and a playback bar for providing play, pause, and stop functions for videos.

Additionally, when the playback bar on the viewing screen within the app execution result screen displayed on the terminal (100) is selected, or when the play button within the viewing screen is selected, the terminal (100) displays (or outputs) the collected raw data in the video display area and displays (or outputs) the comparison target video corresponding to the collected raw data (or the comparison target video corresponding to the raw data provided by the server (200)) in the comparison target video display area. At this time, the terminal (100) performs synchronization of the raw data and the comparison target video based on the meta information corresponding to the raw data and the comparison target video, and displays the synchronized raw data and comparison target video in the video display area and the comparison target video display area, respectively. If either the raw data displayed in the video display area or the comparison target video displayed in the comparison target video display area is paused or stopped by the pause or stop function, the terminal (100) controls the other to stop by the same pause or stop function.

Furthermore, the terminal (100), in conjunction with the server (200), sets (or receives/inputs) a label (or label value) for a specific timestamp (or time interval) in the raw data displayed on the terminal (100) by user input (or user selection/touch/control) from the terminal (100).

Additionally, the terminal (100) sets (or receives/inputs) a label (or label value) for a correct motion or an incorrect motion for the movement (or motion) of an object included in the raw data at a specific timestamp (or time interval) displayed in the video display area of the terminal (100), by user input (or user selection/touch/control) from the terminal (100).

In other words, the terminal (100) receives the input of label values for a correct motion (e.g., pre-set approval/ACCEPT labels) or an incorrect motion (e.g., pre-set rejection/REJECT labels) at one or more specific timestamps in the raw data displayed in the video display area, by user input.

Thus, the terminal (100) sets (or receives/inputs) one or more selective labels (or selective label values) at one or more specific timestamps (or time intervals) in the raw data related to a specific subject, by user input of the terminal (100) from an expert user related to the specific subject.

Moreover, in this manner, the user of the terminal (100) makes judgments based on their own expertise regarding the raw data displayed (or output) on the terminal (100), selecting a rejection label when they observe a part related to an incorrect motion and selecting an approval label when they observe a part related to a correct motion.

Furthermore, the terminal (100) can label specific timestamps (or time intervals) in the raw data displayed on the terminal (100) by dragging or tagging with a mouse (not shown), using an object recognition method that automatically detects boundaries and surfaces, employing methods such as binary division, tertiary division, or multiple division. Here, the selective labeling (or selective labeling/first selective labeling/primary selective labeling) refers to the labeling method for setting (or attaching) labels (or label values) regarding the presence of errors (or anomalies) at specific timestamps (or time intervals) in the raw data. At this time, for any timestamps (or time intervals) in the raw data where no label (or label value) has been set according to selective labeling, a pre-set default label value (e.g., an approval label) can be applied. Additionally, the terminal (100) may attach a pre-set not ACCEPT label to any timestamps (or time intervals/attributes/target attributes) in the raw data where the approval label has not been attached, and may attach a pre-set not REJECT label to any points (or sections/attributes/target attributes) in the raw data where the rejection label has not been attached.

Moreover, the artificial neural network for object recognition (object detection) detects one or more incorrect movement parts and motions by dragging or tagging on the raw data displayed on the terminal (100), and then separates and analyzes the images. The terminal (100) also provides inference results to the user through an artificial intelligence inference process.

In various embodiments, the raw data (or video information) includes 2D video information, 3D video information and point cloud information of still images.

Additionally, the terminal (100) allows the user to capture still images at specific timestamps along the timeline of the playback bar by moving the mouse pointer (or the mouse arrow) in the raw data (e.g., video) displayed on the terminal (100), and then automatically detects the boundaries and surfaces of the captured still image to tag them using the mouse buttons and arrow. Furthermore, when tags are attached to multiple 3D still images captured from the video, the terminal (100) controls the automatic recognition of boundaries and surfaces throughout the entire video.

Additionally, if the user wishes to apply either an approval label or a rejection label to the entirety of the raw data (or video information) displayed on the terminal (100), you can directly press the approval or rejection button displayed on the terminal (100) by user input. If the user wishes to apply an approval or rejection label to a more specific part, the user can use mouse dragging to designate boundaries (e.g., straight lines, curves) or surfaces (e.g., closed curves), or specify multiple points with the mouse button, and then press the approval or rejection button to attach the label.

In one embodiment of the present invention, methods such as object detection, position measurement, object and instance segmentation, and posture estimation are applied for object recognition, and are similarly applied in instance tracking, motion recognition, and motion estimation for video analysis. Additionally, a convolutional neural network is combined to detect motions in video clips. Action detection, scene extraction, next-frame prediction, and object tracking are used. Based on the automatically recognized boundaries and surfaces, the approval or rejection button is pressed for the correct or incorrect parts of the objects and motions displayed in the interface, attaching the respective label.

In one embodiment of the present invention, pressing the left mouse button to attach tags or dragging the mouse to attach tags on multiple point clouds of 2D and 3D video information enables the automatic recognition of boundaries and surfaces. Additionally, pressing the left mouse button or dragging the mouse to attach tags on multiple point clouds present on x, y, and z coordinates in 3D still images, enables automatic recognition of boundaries for correct and incorrect information, and the boundary surface can be automatically recognized by a closed curve.

Additionally, the information processing system (10) may include additional input devices (not shown).

The additional input devices communicate with the terminal (100), the server (200), and others.

These additional input devices are used when tagging or dragging on the raw data (or video information) to attach labels.

The additional input devices may include a controller, eye tracker, data glove, speech recognition interface, brain-computer interface (BCI), hand-tracking technology, haptic devices, and more.

The following are examples of usage methods for these additional input devices.

For instance, the using methods for the additional input devices involve operating the mouse arrow or button using a speech recognition interface and a brain-computer interface to attach tags or drag and attach labels. In the methods, a controller emitting light can be operated via the speech recognition interface and brain-computer interface to attach tags or drag and attach labels. In the methods, an eye tracker can be used via the speech recognition interface and brain-computer interface to attach tags or drag and attach labels. In the methods, the data glove can be operated via hand-tracking technology, speech recognition interface, and brain-computer interface to attach tags or drag and attach labels.

In one embodiment of the present invention, the speech recognition interface directly moves the mouse button on the computer. The movement of the controller's light beam can also be used to attach tags or drag. Additionally, the eye tracker detects the user's gaze and identifies the object to be labeled by attaching a tag at the center of the field of view, based on the user's focus. Furthermore, using the data glove and hand-motion interaction (or hand-motion tracking technology), tags can be attached to the video in the user interface, or boundaries and surfaces can be created for the object. If the platform user (or an expert group in the field) uses brain-computer interface technology that connects the human brain to the computer, they can view the video (e.g., still image, video, etc.) and use the mouse to attach tags or drag on the boundaries and surfaces, then activates the approval or rejection button by their intention (or thoughts) to attach the label. Moreover, they can attach tags or drag based solely on their intention (or thoughts) to create boundaries and surfaces in the video or still image, then perform selective labeling on the divided still image or video.

In one embodiment of the present invention, by combining brain-computer interfaces with technologies such as recurrent neural networks, convolutional neural networks, and multi-layer neural network algorithms, along with robotic arm technology, the user can press the approval or rejection button displayed on the terminal (100) and attach labels or perform selective labeling using only thoughts. Additionally, the terminal (100) can use brain-machine interfaces and neuromorphic chips to label still image and video information, and hierarchically cluster the labeled information.

In one embodiment of the present invention, as advanced brain-computer interfaces are developed, the user interface displayed on the terminal (100) can appear in the user's mind, allowing the user to perform labeling using only their thoughts. The terminal (100) or server (200) can then hierarchically cluster the labeled information, which can be utilized for classification and prediction models.

In one embodiment of the present invention, the method of specifying incorrect parts in a still image is as follows.

If a dentist determines that the position of an orthodontic mini-implant inserted into a patient's oral cavity is slightly higher or lower than the optimal position based on their medical knowledge, they can use mouse dragging to designate the boundary (e.g., straight lines, curves) or surface (e.g., closed curves), or specify multiple points with the mouse button, and press the rejection button. The area will then be labeled with a rejection label.

In one embodiment of the present invention, the method of specifying and labeling incorrect parts in a surgical video is as follows.

First, the section of the video where an incorrect medical act and/or incorrect medical motion occurred is delimited on the timeline (or timeline within the playback bar) using the mouse arrow. The video information between the selected times selected by moving the mouse arrow is limited to the information that will be labeled.

In one embodiment of the present invention, to perform selective labeling on a video of an orthodontic mini-implant placement, tags can be attached by dragging the mouse or pressing the mouse button on multiple points to designate the boundaries (e.g., curves, straight lines) and/or surfaces (e.g., closed curves) on the point clouds in the still or video frame. At this time, the video to be selected is automatically recognized, and subsequently, the approval button can be pressed on the recognized video.

Additionally, the terminal (100) transmits one or more selective label values, meta information of the raw data, and the identification information of the terminal (100) at one or more specific timestamps (or time intervals)related to the raw data to the server (200).

Furthermore, in conjunction with the server (200), before or after performing selective labeling on one or more raw data, the terminal (100) can perform hierarchical labeling on the raw data, and may also perform selective labeling before or after the hierarchical labeling. Here, hierarchical labeling (or primary hierarchical labeling) refers to a labeling method that involves input feature engineering (or hierarchical clustering labeling) to be performed by the user, where labels (or label values) representing features of the raw data are assigned, and the raw data is divided (or classified) into multiple sub-raw data according to the features.

In other words, the terminal (100) works in conjunction with the server (200) to reference (or base on) multiple pre-set label classifications related to the specific subject for the raw data displayed on the terminal (100). Based on the user input (or user selection/touch/control) on the terminal (100), labels (or label values) for other specific timestamps (or other specific time intervals) in the raw data are set (or received/input).

The following [Table 1] through [Table 11] provide examples of label classifications (or label classification tables) for specific fields.

These label classifications represent the correct dataset that the artificial intelligence will learn from, and they show a hierarchical classification structure in an arbitrary method and in stages to enable users to refer to them for hierarchical clustering labeling.

For instance, [Table 1] through [Table 6] provide examples of hierarchical label values (or variable values) in the process of implant surgery or laminate procedures performed by a dental professor (or doctor influencer). The label classifications from the doctor influencer exist as m1×m2×m3×n×n′×N (the product of the classifications for each label) for various motions.

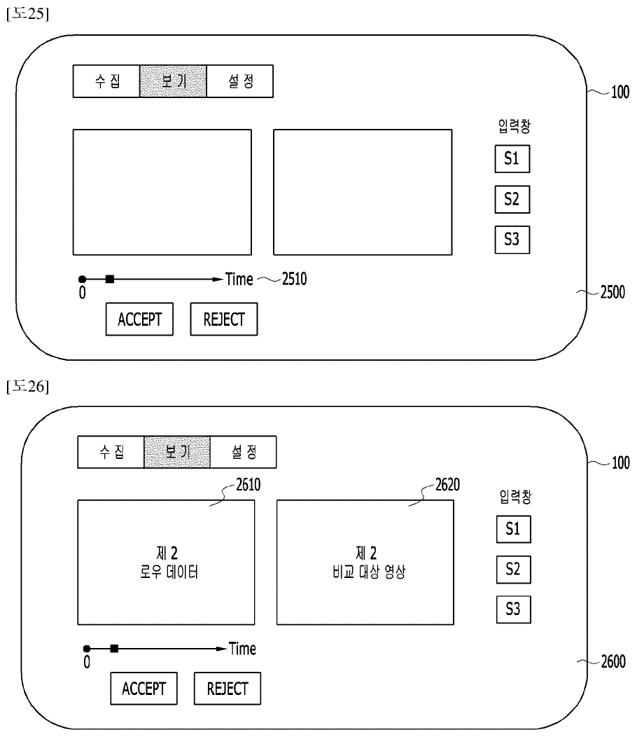

Users refer to the label classifications to input hierarchical clustering-related variable values (or label values) into the input fields (s1, s2, s3) shown in FIGS. 23 through 28 and FIGS. 30 through 32.

The variable value (or label value) of the first-level variable s1 in the first hierarchy (201, 701, 801, 901, 1001, 1101) is input, followed by the variable value (or label value) of the second-level variable s2 in the second hierarchy (102, 702, 802, 902, 1002, 1102), and then the variable value (or label value) of the third-level variable s3 in the third hierarchy (203, 703, 803, 903, 1003, 1103). The number of input fields increases according to the number of hierarchies.

By referring to the label classification, the user moves the marker (or arrow) on the timeline in the playback bar (shown in FIGS. 23 to 28, FIGS. 29 to 32) to capture still image information at the desired point where the video is to be divided. Then, once the user presses the ACCEPT button or makes a selection, the selected timestamp becomes the segmentation point of the video. The terminal (100) (or the server (200)) segments the video based on the selected timestamp corresponding to the selected ACCEPT button.

The video information such as the fourth hierarchy (204, 704, 804, 904, 1004, 1104), fifth hierarchy (905, 1005, 1105), and sixth hierarchy (1106) is divided in the same order as the label values (k, L, f) of the label classification.

TABLE 1

| Variable Value | Specific Avatar | |
|---|---|---|
| (Label) | (Field of Surgery) Specific Avatar | Information Type |
| 1 | Oral Cancer Surgery | Documents, etc. |
| 2 | Double Jaw Surgery (BSSRQ) | Documents, etc. |
| 3 | Colorectal Cancer Surgery | Documents, etc. |
| . . . | . . . | Documents, etc. |
| S1 | Dental Implant Surgery | Documents, etc. |
| . . . | . . . | Documents, etc. |
| m1 | Liver Transplant Surgery | Documents, etc. |

TABLE 2

| | Specific Action of a Specific Avatar | |
|---|---|---|
| | (Cases of patients with specific mutations undergoing | |
| Variable Value | dental implant surgery or digital cadaver cases with | |
| (Label) | specific mutations) | Information Type |
| 1 | Case with narrow ridge width in the maxillary molar region | Videos, etc. |
| 2 | Case with narrow ridge width and severe alveolar bone loss | Videos, etc. |
| | in the anterior region | |
| . . . | . . . | Videos, etc. |
| S2 | Case with narrow ridge width in the mandibular molar | Videos, etc. |
| | region | |
| . . . | . . . | Videos, etc. |
| m2 | . . . | Videos, etc. |

TABLE 3

| | Specific Method of a Specific Action | |
|---|---|---|
| Variable Value | (Surgical methods for cases with narrow ridge width in | |
| (Label) | the mandibular molar region) | Information Type |
| 1 | After performing a ridge split . . . | Videos, etc. |
| 2 | Using a 3D stent to safely insert the drill . . . | Videos, etc. |
| . . . | . . . | Videos, etc. |
| S3 | Surgery with block bone grafting | Videos, etc. |
| . . . | . . . | Videos, etc. |
| m3 | . . . | Videos, etc. |

TABLE 4

| Variable Value | Specific Stage of a Specific Method | |
|---|---|---|
| (Label) | (Surgical steps of block bone graft surgery) | Information Type |
| 1 | Incise and form a flap . . . | Videos, etc. |
| 2 | Harvest block bone from the donor site . . . | Videos, etc. |
| . . . | . . . | Videos, etc. |
| K | Fix the block bone at the graft site | Videos, etc. |
| . . . | . . . | Videos, etc. |
| n | Suture and disinfect . . . | Videos, etc. |

TABLE 5

| | Detailed Action Stage 1 | |
|---|---|---|
| Variable Value | (A 30-second video showing the trimming of maxillary | |
| (Label) | central incisor 11) | Information Type |
| 1 | Position a pre-made tooth trimming index on the mouth | Videos, etc. |
| | and teeth before trimming | |
| 2 | The dentist visually checks the index and measures the | Videos, etc. |
| | amount of trimming | |
| . . . | . . . | Videos, etc. |
| L | Trim one-third of the expected depth of the incisal edge | Videos, etc. |
| | using a depth gauge bur | |
| . . . | . . . | Videos, etc. |
| n′ | Trim the entire maxillary central incisor with a handpiece | Videos, etc. |
| | trimming bur for fine adjustment | |

TABLE 6

| Variable Value | Specific Detailed Action Stage 2 | |
|---|---|---|
| (Label) | (Tooth Numbers) | Information Type |
| 1 | 11 (Corresponds to the right maxillary central incisor) | Videos, etc. |
| 2 | 12 | Videos, etc. |
| . . . | . . . | Videos, etc. |
| f | 35 (Corresponds to the left mandibular second premolar) | Videos, etc. |
| . . . | . . . | Videos, etc. |
| N | 48 (Corresponds to wisdom tooth in the 40 series) | Videos, etc. |

Additionally, [Table 7] to [Table 11] represent examples of hierarchical label values (or variable values) for dance movements from the song “As If It's Your Last” by BLACKPINK, performed by a dance (or dance influencer)

TABLE 7

| Variable Value | Specific Avatar | |
|---|---|---|
| (Label) | (Game character to be deepfaked) | Information Type |
| 1 | BTS Jin | Videos, etc. |
| 2 | BTS Suga | Videos, etc. |
| . . . | . . . | Videos, etc. |
| S1 | BLACKPINK Jennie | Videos, etc. |
| . . . | . . . | Videos, etc. |
| m3 | BLACKPINK Jisoo | Videos, etc. |

TABLE 8

| Variable Value | Specific Action of a Specific Avatar | |
|---|---|---|
| (Label) | (Jennie's dance moves and song types) | Information Type |
| 1 | Shut Down (4 minutes 10 seconds) | Videos, etc. |
| . . . | . . . | Videos, etc. |
| S2 | As If It's Your Last (3 minutes 14 seconds) | Videos, etc. |
| . . . | . . . | Videos, etc. |
| m3 | Tonight's the Night (3 minutes 55 seconds) | Videos, etc. |

TABLE 9

| | Specific Method of a Specific Action | |
|---|---|---|
| Variable Value | (The list of Jennie's ‘As if It's your last’ on different | |
| (Label) | broadcasts) | Information Type |
| 1 | Music Bank broadcast on Mar. 14, 2022 | Videos, etc. |
| . . . | . . . | Videos, etc. |
| S3 | Open Concert broadcast on Jul. 8, 2022 | Videos, etc. |
| . . . | . . . | Videos, etc. |
| m3 | Concert recorded on Jun. 3, 2022 | Videos, etc. |

TABLE 10

| Variable Value | Specific Stage of a Specific Action | |
|---|---|---|
| (Label) | (Open Concert broadcast on Jul. 8, 2022) | Information Type |
| 1 | Left groove | Videos, etc. |
| . . . | . . . | Videos, etc. |
| K | Front-back wave | Videos, etc. |
| . . . | . . . | Videos, etc. |
| n | Upper body popping and pelvis bouncing | Videos, etc. |

TABLE 11

| | Detailed Action Stage 2 | |
|---|---|---|
| Variable Value | (Body movements steps during | |
| (Label) | Jennie's front-back wave) | Information Type |
| 1 | Lifts left arm | Videos, etc. |
| 2 | Lifts right arm | Videos, etc. |
| 3 | Pushes chest forward | Videos, etc. |
| 4 | Pushes belly forward | Videos, etc. |
| 5 | Pushes pelvis forward | Videos, etc. |
| 6 | Pushes legs forward | Videos, etc. |

Similarly, [Table 5] and [Table 10] show label classifications that have been subdivided into characteristic motions to allow videos to be divided into short clips of about 1 to 3 seconds by the user. In the same way as [Table 1] through [Table 12], real-world robot operation videos can be produced as label classifications.

Additionally, in [Table 6] and [Table 11], the labels are assigned for body parts of avatars, humans, and robots. The labels are used for first and second hierarchical labeling, selective labeling, additional selective labeling, time-series division selective labeling, and body-part-specific selective labeling. The classifications for these labels are set arbitrarily by an expert group.

The body-part-specific selection refers to a method in which label values are assigned to each videos of detailed body parts in the order shown in [Table 6] and [Table 11] through object recognition for the detailed body parts in single or multiple divided still image. Using the playback bar (or the marker showing the time) or selecting specifying body part, the video can be divided into data unit 5.

Hierarchical labeling through body part-specific selection (generating data unit 5, segmenting videos, f), is input feature engineering performed by the user. The body part-specific selection can be omitted. The server (200) can call a library related to body part-specific selection (such as object recognition of detailed body parts) and automatically label (label f) and segment the video (data unit 5).

FIG. 11 can be used as a diagram showing hierarchical clustering based on data unit 5.

The body-part-specific selection is hierarchical labeling, and body-part-specific selective labeling is labeling that segments the video by generating digital unit 5 through interaction between the server (200) and the user (such as the user's judgment of the video segmentation point (label value) or the movement sequence of body parts).

Time-series division selection (generating data units 3 and 4) is hierarchical labeling, and time-series division selective labeling is labeling that segments the video by generating digital units 3 and 4 through interaction between the server and the user's judgment of the video segmentation point (label value).

The detailed motion steps are divided into detailed motion step 1 and detailed motion step 2 depending on the method of video segmentation. Here, detailed motion step 1 is the detailed segmentation of motion steps based on time-series division selective labeling, and detailed motion step 2 is the detailed segmentation of motion steps based on body-part-specific selective labeling.

In one embodiment of the present invention, like the final scene of Jennie's dance in [Table 9] (at 3:14) during the broadcast of ‘As if your last’ at the “Open Concert” on Jul. 8, 2022, the dance moves are output as a video through the user's HMD (Head-Mounted Display). Jennie's video is in video form and can be shown to the user in a divided manner. The user can view the still images of the divided video in label sequence and also view the still image at the end of the divided video.

By referring to Jennie's video displayed on the HMD, the user can perform similar or identical movements on a VR treadmill, and the user's movement video information is collected by the visual set device and used as raw data (or basic video/basic video information). Depending on the user's preference, they can either generate an avatar that is synthesized with Jennie's movements or have their own appearance and movements displayed without being synthesized with Jennie's motions.

At this point, based on Jennie's movement, the user can refer to the still images and their corresponding label values to perform hierarchical labeling, selective labeling, time-series division selective labeling, or body-part-specific selective labeling for their own avatar and the avatars of others. The user can also view the movements of their avatar, which has been synthesized with Jennie's avatar and other avatars generated by artificial intelligence, from a third-person perspective through the HMD (Head-Mounted Display). The user performs labeling by comparing these movements with Jennie's dance in the broadcast of the broadcast of ‘As if It's your last’ at the “Open Concert” on Jul. 8, 2022, at the 3:14 mark, as shown in [Table 9].

The user can repeat Jennie's movements multiple times, and this dance movement, as basic video information (or raw data), can be collected by the terminal (100) and transmitted to the server (200). The multiple iterations of dance movements represent multiple data (or multiple raw data) in the attribute section (or annotation stage).

In one embodiment of the present invention, [Table 1] through [Table 6] provide examples of hierarchical label values (or variable values) for implant surgery or laminate procedures performed by a dental professor (or doctor influencer). Dental students or dentists can view the label classifications in [Table 1] through [Table 6], which are the correct dataset, through the HMD while using a VR tooth removal simulator (not shown) to perform virtual surgeries, procedures, or labeling on a digital cadaver.

When the playback bar included in the app execution result screen displayed on the terminal (100) is selected, or when the play button on the viewing screen is selected, the terminal (100) displays (or outputs) the collected raw data in the video display area, and displays (or outputs) the comparison target video corresponding to the raw data (or the comparison target video provided by the server (200)) in the comparison target video display area. At this time, the terminal (100) synchronizes the raw data and the comparison target video based on the meta information corresponding to the raw data and the comparison target video, and displays the synchronized raw data and comparison target video in the video display area and comparison target video display area, respectively. If either the raw data displayed in the video display area or the comparison target video displayed in the comparison target video display area is paused or stopped by the pause or stop function, the terminal (100) also controls the other to stop accordingly.

Furthermore, the terminal (100) sets (or receives/inputs) one or more stepwise labels (or label values) for the movement (or motion) of an object included in the raw data at another specific timestamp (or specific time interval) based on user input (or user selection/touch/control) in the video display area of the terminal (100).

In other words, at one or more other specific timestamps (or specific time intervals) in the raw data displayed in the video display area, the terminal (100) receives hierarchical labels (or hierarchical label values) for the object's movement (or motion) based on user input, which correspond to a specific motion of the object, a specific method of that motion, and a specific step within that method.

Thus, for the raw data related to a specific subject, the terminal (100) sets (or receives/inputs) one or more hierarchical labels (or hierarchical label values) at one or more other specific timestamps (or specific time intervals) based on user input from an expert in the specific subject using the terminal (100).

Additionally, the terminal (100) performs the selective labeling process before or after performing the hierarchical labeling process described earlier.

In this way, the terminal (100) performs hierarchical clustering labeling (hierarchical labeling) by referring to the label classifications that categorize the motions of specific avatars, humans, or robots by their motions, specific methods, steps, or detailed motion stages, and inputs label values.

The motions related to surgeries or procedures performed on patients with anatomical structures (or specific variations) similar to a particular patient are included in the specific motions of avatars, humans, or robots.

In hierarchical clustering of dental procedures or surgical operations, the label classification for specific methods in certain cases shown in [Table 2] through [Table 3] is included in the label classification for specific motions or motion methods of specific avatars, humans, robots, etc., as shown in [Table 7] through [Table 9].

In one embodiment of the present invention, artificial intelligence that has learned the label values for hierarchical labeling from the server (200) returns the label values or video information to the user of the terminal (100), and the user can attach an approval label or rejection label to it.

In various embodiments, the user may be an expert in different fields (e.g., domain experts, dentists, doctors, soccer players, dancers, etc.).

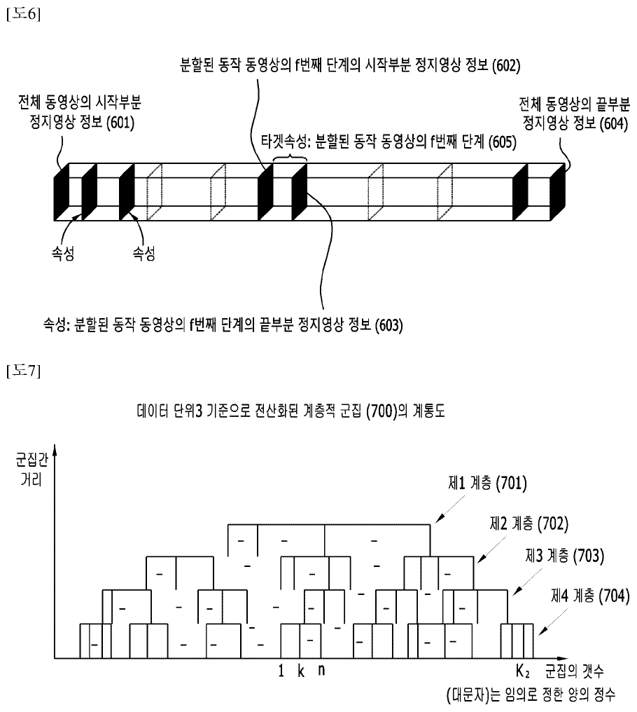

The rectangular cuboid (301) in FIG. 3 represents the video information of the divided video, which is the target attribute in FIG. 4 to 6, and represents the video information of the divided motion in the k-th stage (405), L-th stage (505), and f-th stage (605). The starting yz plane (302) or ending yz plane (303) represents the still image information attribute.

Here, the variables m1, m2, and m3 represent arbitrary positive integers (or natural numbers). s1, s2, and s3 represent variables, and satisfy the conditions of 1≤s1≤m1, 1≤s2≤m2 and 1≤s3≤m3. Additionally, k is represents a variable and satisfy the condition of 1≤k≤n. Variables n, n′, and N represent arbitrary positive integers (or natural numbers), while L and f are variables representing and satisfy the conditions of 1≤L≤n′ and 1≤f≤N.

The user first confirms the output of raw data (or video information) corresponding to the first attribute and first target attribute on the screen displayed on the terminal (100), then inputs the hierarchical clustering-related variable values (or label values) on the screen based on the label classification.

Additionally, the terminal (100) outputs video information related to the movements of avatars, humans, robots, etc. (including attributes and target attributes, for example).

Furthermore, the attributes and target attributes in FIGS. 4 to 6 may represent movement-related video information of virtual avatars, items, humans, robots, etc., generated by the server (200).

Moreover, the terminal (100) receives the variable value (label value) of the variable S1 in the first hierarchy through multiple input fields included in the hierarchical label input menu based on user input, and receives the variable value (or label value) of the variable S2 in the second hierarchy and the variable value (or label value) of the variable S3 in the third hierarchy. The multiple input fields included in the hierarchical label input menu can be configured in various ways depending on the number of hierarchies, as determined by the designer.

Furthermore, the video information of the fourth, fifth, and sixth hierarchies is divided in the same order as the label values (e.g., k, L, f) of the label classification.

In one embodiment of the present invention, the method by which the user divides the steps is by moving the marker (or arrow) indicating the timestamp on the timeline within the playback bar with the mouse, confirming the timestamp of the video to be divided, and selecting it with the mouse.

In this embodiment, the user mainly refers to the label classification to set hierarchical labeling related to specific raw data. However, this is not limited to this, as the terminal (100) can directly receive hierarchical labeling values step-by-step (or hierarchically/in a cascade form) based on user input.

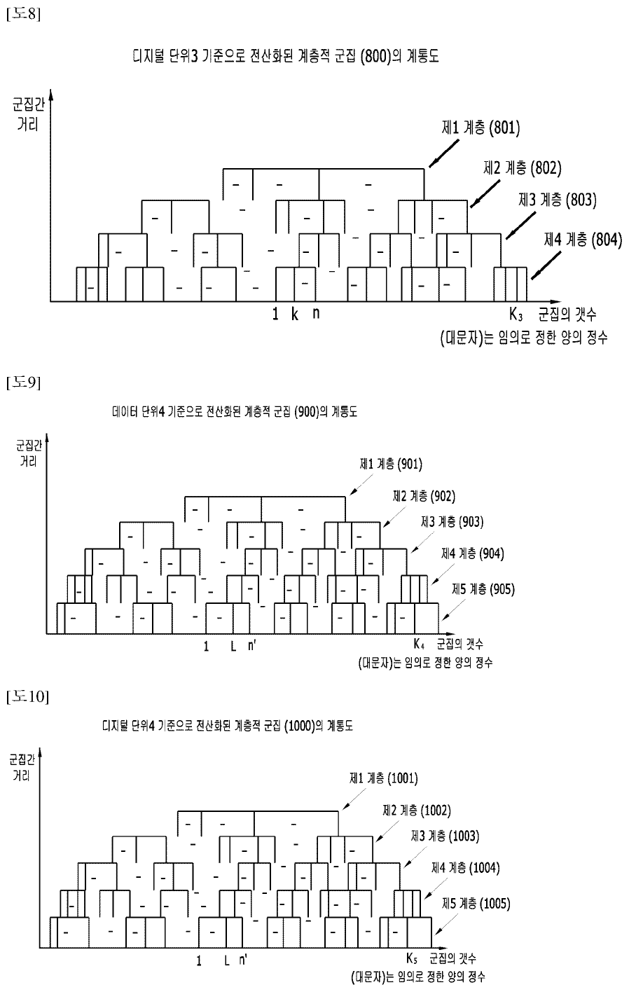

FIG. 4 shows an example of a video (or elongated three-dimensional shape) divided into n parts, FIG. 5 shows a video divided into n′ parts, and FIG. 6 shows a video divided into N parts. n, n′, and N satisfy the conditions of 1≤k≤n, 1≤L≤n′, and 1≤f≤N, and the variables k, L, and f represent positive integers (or natural numbers).

FIGS. 4 to 6 represent one complete motion of an avatar (or human) as a three-dimensional shape. The first black rectangle represents the still image information at the beginning of the motion (or video) (401, 501, 601), and the last black rectangle represents the still image information at the end of the motion (or video) (404, 504, 604). The x-axis represents time, the yz-plane (rectangles) represents still image information, and the divided cuboids represent the divided videos.

One of the divided three-dimensional shapes in FIGS. 4 to 6 corresponds to the rectangular cuboid (301) in FIG. 3.

Additionally, one of the divided three-dimensional shapes in FIG. 5 represents a long rectangular cuboid divided into n′ parts, while one of the divided three-dimensional shapes in FIG. 6 represents a long rectangular cuboid divided into N parts. The elongated rectangular cuboids in FIGS. 4 to 6 represent the entire motion-related video information of an avatar in three-dimensional form.

Furthermore, referring to FIG. 3, the black rectangle at the end yz-plane (303) represents an attribute (or still image), and the cuboid (301) represents the video (or target attribute) of the divided motion.

The following elements match in order. The k, L, f-th beginning still image information (402, 502, 602) in FIGS. 4 to 6 corresponds to the starting still image information (302) in FIG. 3, while the k, L, f-th ending still image information (403, 503, 603) corresponds to the ending still image information (303) in FIG. 3. The k, L, f-th starting still image information (402, 502, 602) and the (k−1, L−1, f−1)-th ending still image information (403, 503, 603) are the same. The k, L, f-th ending still image information (403, 503, 603) is an attribute, and the k, L, f-th stage (405, 505, 605) of the divided motion video is the target attribute. In FIGS. 3 to 6, data unit 1 represents the sum of the beginning still image information (401, 501, 601) and the ending still image information (404, 504, 604) of the entire video of a complete motion performed by an avatar, human, or robot. Data unit 2 represents the sum of the still image information from the first stage to the final stage of the divided motion video of an avatar, human, or robot.

In FIG. 4, data unit 3 represents the sum of the video information and the ending still image information of the k-th stage of the divided motion video of an avatar, human, or robot.

In FIG. 5, data unit 4 represents the sum of the video information and the ending still image information of the L-th stage of the divided motion video of an avatar, human, or robot.

In FIG. 6, data unit 4 represents the sum of the video information and the ending still image information of the f-th stage of the divided motion video of avatars, humans, or robots.

FIG. 7 represents hierarchical clustering based on data units 1, 2, and 3, and FIG. 9 represents hierarchical clustering based on data units 1, 2, 3, and 4.

In data unit 3, the attribute is the ending still image information (403) of the k-th stage of the divided motion video of avatars, humans, or robots, and is represented by the black rectangle in FIG. 4.

Additionally, in data unit 4, the attribute is the ending still image information (503) of the L-th stage of the divided motion video of avatars, humans, or robots, and is represented by the black rectangle in FIG. 5.

Furthermore, in data unit 5, the attribute is the ending still image information (603) of the f-th stage of the divided motion video of avatars, humans, or robots, and is represented by the black rectangle in FIG. 6.

In the embodiment of the invention, the data units used in the classification model and prediction model (or derivation and/or inference model)—such as data unit 3, data unit 4, and data unit 5, can correspond to the divided cuboids (301) in FIG. 3 (the same applies to digital units).

FIG. 2 is a hierarchical clustering diagram (900) of real-world data (or raw data), representing K1 clusters. The raw data (real-world data) includes robot motion video information collected by the visual set device. When robot motion video information is used as raw data, FIG. 22 can be used for robot training.

FIG. 7 and FIG. 9 show hierarchical clustering diagrams created by the label values assigned when the stages of the video are divided by data units.

FIG. 7 represents K2 clusters based on data unit 3, and FIG. 9 represents K4 clusters based on data unit 4.

In one embodiment of the present invention, the starting still image information is also an attribute. By combining the target attribute, the starting still image information forms the data unit, which is used in the forward generation and output of the video in terms of the directionality of the algorithm.

In one embodiment of the present invention, the labeling method related to case, method, and step-by-step hierarchical clustering is as follows.

[Table 1] to [Table 6] were created based on the medical expertise of doctors and dentists, and are examples of label classifications presented for inputting variable values (or label values) on the app execution result screen (or viewing screen) displayed on the terminal (100).

[Table 1] is an example for inputting variable values (or label values) for the surgical field, [Table 2] is an example for inputting variable values (or label values) for surgical cases, [Table 3] is an example for inputting variable values (or label values) for surgical methods, and [Table 4] is an example for inputting variable values (or label values) for surgical steps. This method allows the user (e.g., doctors, dentists, etc.) to input variable values (or label values) by referring to clinical standards (e.g., case, method, step, etc.).

[Table 5] provides an example of a more detailed classification of surgical steps, and [Table 6] provides an example of label classification for the body parts of avatars, humans, or robots.

The classification criteria for case, method, and step in surgeries are applied based on data units from FIGS. 7 and 9 by hierarchical clustering label value input. The basic approach is to hierarchically cluster medical video information and other information by case, method, and step. However, these pieces of information can be labeled in detail in any way, and the video can be divided to achieve more detailed hierarchical clustering, which can then be applied to classification models and/or prediction models, regardless of the number of layers (e.g., three layers, four layers, five layers) or the method of video segmentation.

In one embodiment of the present invention, video information of the patient's body or organs used in actual surgery or procedures, other medical information, and digital cadavers are labeled through the app execution result screen (or viewing screen) displayed on the terminal (100), forming K2, K3, K4, and K5 clusters in FIGS. 7 to 10. Here, K represents a variable (or natural number). Body or organ information of specific patients or digital cadavers belonging to the same cluster corresponds to the meta information (or meta-information) of that cluster. Virtual surgeries, virtual procedures, etc., are carried out based on the artificial intelligence inference or feedback of digital cadavers using this metadata. Doctors and/or dentists perform selective labeling for virtual surgery videos, virtual procedure videos, etc., using the digital cadavers and artificial cadavers output through artificial intelligence inference and feedback, all through the app execution result screen (or viewing screen) displayed on the terminal (100).

In various embodiments, one complete motion of an avatar (or human) in FIGS. 3 to 6 represents one instance of a specific patient's surgery. The first still image information at the start of the motion represents diagnostic information, and the k, L, f-th step in the video information of one complete motion of the avatar (or human) represents the k, L, f-th step in the video information of the specific patient's surgery. The reaction of the digital cadaver undergoing surgery can be seen as a kind of passive avatar motion compared to the movements of the avatar or human (e.g., the digital cadaver is a kind of patient avatar).

Thus, the terminal (100) performs hierarchical labeling, selective labeling, and other functions for videos of avatars, items, robots, etc.

In this embodiment of the invention, the hierarchical labeling function and the selective labeling function are explained separately, but they are not limited to being performed independently The terminal (100) can perform the hierarchical labeling function as part of the selective labeling function, or it can integrate both hierarchical labeling and selective labeling into a single labeling function.

Additionally, the terminal (100) receives the first video transmitted from the server (200). Here, the first video is the result generated by the classification and prediction models based on the raw data from the server (200). This video may include movement-related videos of avatars, items, robots generated based on the raw data, the updated videos of the raw data (e.g., updated videos of human motions/behaviors included in the raw data), and more.

The terminal (100) displays the received first video in the video display area. At this time, the terminal (100) may simultaneously display the synchronized raw data, comparison target video, and the first video by dividing the screen of the terminal (100).

Additionally, the terminal (100) performs additional selective labeling on the first video in collaboration with the server (200). Here, the additional selective labeling (or secondary selective labeling) refers to a labeling method that sets (or attaches) a label (or label value) regarding the presence or absence of errors (or anomalies) at another specific timestamp (or specific time interval) of the first video. If no label (or label value) is set for certain timestamps (or time intervals) during the additional selective labeling, a pre-set default label value (e.g., an approval label) can be applied. Moreover, the terminal (100) attaches a pre-set “not ACCEPT” label to points (or sections/attributes/target attributes) of the first video that do not have an approval label, and a pre-set “not REJECT” label to points (or sections/attributes/target attributes) that do not have a rejection label.

In other words, the terminal (100), in conjunction with the server (200), sets (or receives/inputs) labels (or label values) based on user input (or user selection/touch/control) for the presence or absence of errors (or anomalies) at another specific timestamp (or specific time interval) of the first video displayed on the terminal (100).

Moreover, when the playback bar or play button in the app execution result screen is selected, the terminal (100) displays (or outputs) the first video in the video display area, and displays (or outputs) the comparison target video corresponding to the raw data (or the first video) in the comparison target video display area (or the comparison target video provided by the server (200) corresponding to the raw data/the first video). At this time, the terminal (100) synchronizes the first video and the comparison target video based on the respective meta information of the first video and the comparison target video, and displays the synchronized first video and comparison target video in the video display area and comparison target video display area, respectively. If either the first video or the comparison target video is paused or stopped by the pause or stop function, the terminal (100) controls the other to pause or stop simultaneously.

Furthermore, based on user input (or user selection/touch/control), the terminal (100) sets (or receives/inputs) labels (or label values) regarding correct or incorrect motions of an object (or avatar) contained in the first video at another specific timestamp (or specific time interval).

In other words, at one or more other specific timestamps in the first video displayed in the video display area, the terminal (100) receives input for label values regarding correct motions (e.g., pre-set approval/ACCEPT labels) or incorrect motions (e.g., pre-set rejection/REJECT labels) based on user input.

Thus, for the first video created regarding a specific subject, the terminal (100) sets (or receives/inputs) one or more additional selective labels (or additional selective label values) at one or more other specific timestamps (or specific time intervals) based on user input from an expert on the specific subject using the terminal (100).

At this time, the terminal (100) performs time-series division selective labeling or body-part-specific selective labeling based on user input.

The terminal (100) carries out time-series division selective labeling through the following process.

The terminal (100) receives the label values for correct motions (e.g., pre-set approval/ACCEPT labels) or incorrect motions (e.g., pre-set rejection/REJECT labels) for each of the multiple sub-videos divided from the first video, based on user input. The terminal (100) also receives label values indicating the order of the multiple sub-videos, based on user input, to adjust the sequence of the sub-videos (or to correct the division points if they are incorrect or need adjustment). The division of the first video into multiple sub-videos may be based on the information of the sub raw data that has been divided into multiple parts according to hierarchical labeling of the raw data, or it may result of the first image being divided into multiple sub images by the artificial intelligence or video analysis functions performed by the server (200) on the raw data.

Thus, the terminal (100) receives label values for both a correctly divided state and an incorrectly divided state of the multiple sub-videos based on user input to the terminal (100) targeting the first video. It also receives label values to arrange the order of the multiple sub-videos (or label values indicating the order of the sub-videos, or label values for adjusting the division points if the division timestamps are incorrect or require adjustment).

Additionally, the terminal (100) transmits the label values for the correct and incorrect division states of the multiple sub-videos, the label values for ordering the multiple sub-videos (or adjusting the division timestamps), and the identification information of the terminal (100) to the server (200).

The server (200), based on the time-series division selective labeling performed on the first video, receives the label values for the correct and incorrect division states, the label values for ordering the sub-videos (or adjusting the division timestamps), and the identification information of the terminal (100).

The server (200), using the received label values for correct and incorrect division states, as well as the label values for ordering the sub-videos (or adjusting the division timestamps), reorganizes the sequence of the sub-videos divided from the first video.

As such, the time-series division selection may involve labeling whether each division timestamps (e.g., label values, still image information, etc.), in which the multiple sub-movies are divided from the first movie by the user input through the terminal (100), is correct or incorrect. In addition, the time-series division selection may involve labeling for adjusting the division timestamps or the division order when the division timestamps is incorrect.

The terminal (100) also performs body-part-specific selective labeling through the following process.

That is, for the avatars (or objects) included in the sub-videos divided from the first video, the terminal receives label values for the sequence of motions of the avatars (or objects) based on user input (e.g., whether the sequence of motions is correct or incorrect) included in the sub-videos, and receives label values for indicating the sequence of the multiple sub-movies or adjusting the sequence of the sub-movies including the avatar in order to arrange the operating sequence by body part (or by each part of the robot) in the motions of avatars, humans, robots, etc., included in the multiple sub-movies. This body-part-specific selection can be executed or omitted by the user, and it may also be automatically executed by the server (200) (hierarchical labeling). The division of the first video into multiple sub-videos may be divided from the first movie into the multiple sub-movies based on the information for the sub row data divided by hierarchical labeling of the raw data, or it may be divided from the first movie into the multiple sub-movies by result from the artificial intelligence or video analysis functions performed by the server (200).

Thus, based on user input of the terminal (100) for the first movie, the terminal (100) receives label values for the sequence of motions of the avatars (or objects) included in the multiple sub-videos (or label values indicating whether the motions of the avatars, robots, etc., are in the correct or incorrect order). Additionally, the terminal (100) receives label values for sorting the sequence of the multiple sub-videos (or label values indicating the sequence of motions for avatars or robots in the sub-videos) or the label values indicating the order of the multiple sub-videos/the label values for adjusting the sequence of sub-videos that include avatars or robots are received.

Additionally, the terminal (100) transmits the label values for the sequence of motions of the avatars (or objects) included in the input multiple sub-videos (or label values indicating whether the motions of avatars, robots, etc., are in the correct or incorrect order), the label values for sorting the sequence of the multiple sub-videos (or the motion sequence of the avatars, robots, etc., included in the multiple sub-videos), and the identification information of the terminal (100) to the server (200).

Additionally, the server (200), based on the body-part-specific selective labeling function performed on the first video, receives from the terminal (100) the label values for the motion sequence of the avatar (or object) included in the multiple sub-videos (or the label values indicating whether the motion sequence of the avatar is correct or incorrect), the label values for ordering the multiple sub-videos (or the motion sequence of the avatar in the multiple sub-videos), and the identification information of the terminal (100).

Moreover, the server (200) reorders the divided multiple sub-videos of the first video based on the received label values for the motion sequence of the avatar (or object) included in the received multiple sub movies(or the label values indicating whether the motion sequence of the avatar is correct or incorrect), the label values for ordering the multiple sub-videos (or the motion sequence of the avatar in the multiple sub-videos), and other relevant information.

As such, the body-part-specific selective labeling may involve labeling whether the motion sequence of the avatar (or object) included in the multiple sub movies divided from the first movie, is correct or incorrect, by the user input through the terminal (100) when the multiple sub-movies are divided from the first movie. In addition, the body-part-specific selective labeling may involve labeling for label values for sorting the sequence of the multiple sub-videos (or the motion sequence of the avatar included in the multiple sub-videos) in order to adjust the motion sequence of the avatar.

The body-part-specific selective labeling function further includes the following functions.

That is, the server (200), based on artificial intelligence functions or video analysis functions performed on the multiple sub-videos, provides the terminal (100) with information regarding the motion sequence of avatars, robots, etc., included in the sub-videos.

The terminal (100), based on user input in the terminal (100), labels the motions of avatars (or robots) included in the multiple sub-videos as either correct or incorrect. If the motion sequence of the avatars (or robots) is incorrect or needs adjustment, it receives label values to adjust the motion sequence or the order of the sub-videos that contain the avatars or robots. The terminal (100) transmits the label values indicating whether the motion sequence of avatars (or robots) included in the input multiple sub-videos is correct or incorrect, the label values for adjusting the motion sequence or the order of the sub-videos containing avatars (or robots) if the motion sequence is incorrect or needs adjustment, and the identification information of the terminal (100) to the server (200).

The server (200) receives the label values indicating whether the motion sequence of avatars (or robots) included in the input multiple sub-videos is correct or incorrect, the label values for adjusting the motion sequence or the order of the sub-videos containing avatars (or robots) if the motion sequence is incorrect or needs adjustment, and the identification information of the terminal (100)

The server (200) reorders the multiple sub-videos of the first video based on the received label values indicating whether the motion sequence of avatars (or robots) included in the input multiple sub-videos is correct or incorrect, the received label values for adjusting the motion sequence or the order of the sub-videos containing avatars (or robots) if the motion sequence is incorrect or needs adjustment, and other relevant information.

Additionally, the terminal (100) transmits to the server (200) one or more additional selective label values, one or more time-series division selective label values, one or more body-part-specific selective label values, label values for ordering the multiple sub-videos, and the identification information of the terminal (100) related to one or more other specific points (or specific sections) of the first video.

Furthermore, in conjunction with the server (200), the terminal (100) may perform additional hierarchical labeling on the first video before or after performing additional selective labeling. It is also possible to perform additional selective labeling on the first video before or after performing the additional hierarchical labeling. Additional hierarchical labeling (or secondary hierarchical labeling) is a method of labeling, where input feature engineering by the user assigns labels (or label values) representing the characteristics of the first video, and the first video is divided (or classified) into multiple sub-videos based on those characteristics.

Thus, the terminal (100), in conjunction with the server (200), refers to (or bases on) multiple pre-set label classifications related to the specific subject of the first video displayed on the terminal (100). Based on user input (or user selection/touch/control) on the terminal (100), additional labels (or additional label values) are set (or received/input) for another specific timestamp (or specific time interval) of the first video.

When the playback bar in the app execution result screen or the play button in the viewing screen is selected, the terminal (100) displays (or outputs) the first video in the video display area and displays (or outputs) a comparison target video related to the first video (or a comparison target video provided by the server (200) corresponding to the raw data or the first video) in the comparison target video display area. At this time, the terminal (100) synchronizes the first video and the comparison target video based on the respective meta information of each video and displays the synchronized first video and comparison target video in the video display area and comparison target video display area, respectively. If either the first video or the comparison target video is paused or stopped by the pause or stop function, the terminal (100) also controls the other to pause or stop simultaneously.

Additionally, the terminal (100) sets (or receives/inputs) one or more step-by-step additional labels (or additional label values) for the movement (or behavior) of an object included in the first video at another specific timestamp (or specific time interval) based on user input (or user selection/touch/control) on the terminal (100).

In other words, at one or more other specific timestamps (or specific time intervals) in the first video displayed in the video display area, the terminal (100) receives input for additional hierarchical labels (or additional hierarchical label values) related to the specific motion, method of motion, or step of the object's movement (or behavior) based on user input.

Thus, the terminal (100) sets (or receives/inputs) one or more additional hierarchical labels (or additional hierarchical label values) at one or more other specific timestamps (or specific time intervals) based on user input from an expert on the specific subject using the terminal (100).

Moreover, the terminal (100) performs the additional selective labeling process before or after performing the additional hierarchical labeling process described above.

In this way, the terminal (100) performs additional hierarchical labeling, additional selective labeling, and other functions targeting the first video.

In one embodiment of the present invention, the additional hierarchical labeling function and the additional selective labeling function are explained separately, but they are not limited to being performed independently. The terminal (100) may integrate the additional hierarchical labeling function with the additional selective labeling function and perform them as a unified labeling function.

Furthermore, the terminal (100) receives the second video transmitted from the server (200). Here, the second video is the result generated by the machine-learned classification and prediction models based on the first video from the server (200). The second video may include movement-related videos of avatars, items, robots, or updated versions of the first video, generated from the first video.

Additionally, the terminal (100) outputs the received second video in the video display area. At this time, the terminal (100) may divide the screen and simultaneously display the raw data, the comparison target video, the first video, and the second video in a synchronized state.

Additionally, the terminal (100) can receive the latest collective intelligence second video (or updated second video) related to the specific subject (or the raw data) from the server (200).

The terminal (100) transmits movement-related videos of avatars, items, robots, etc. (or movement-related videos related to at least one of the avatars and items) and meta information related to those movement-related videos to the server (200), in relation to a specific subject. The specific subject (or specific content) may include medical practices (such as procedures or surgeries), dance, sports (such as soccer, basketball, table tennis, etc.), games, e-sports, and more. The movement-related videos of the avatars and/or items may be generated through selective labeling processes, classification model inference processes, prediction model inference processes, etc., based on any raw data related to the specific subject. The robot video is video (or raw data) collected by the visual set device from the actual movements of a real-world robot.

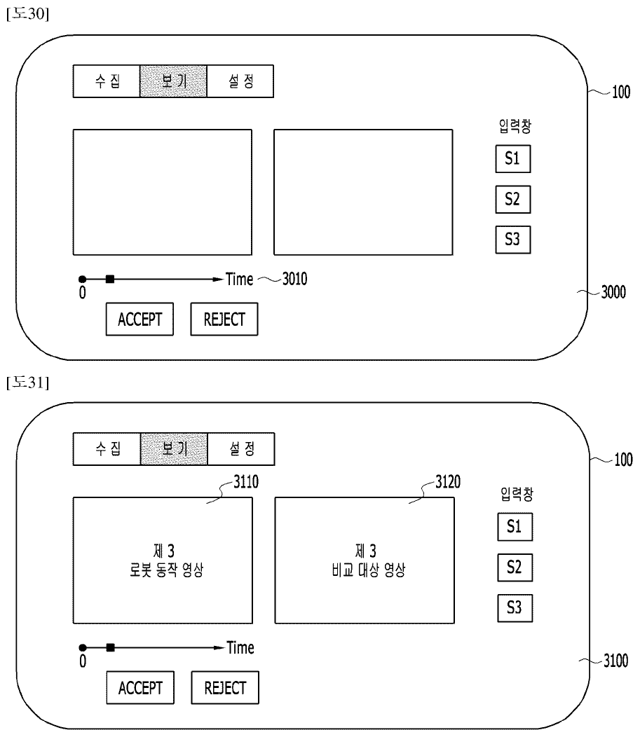

Furthermore, the terminal (100) synchronizes with the server (200) and, based on user input (or user selection/touch/control), sets (or receives/inputs) labels (or label values) for specific timestamps (or specific time intervals) of the robot movement video (depicted as FIG. 29, basic robotics video) displayed on the terminal (100).

When the playback bar or play button on the viewing screen of the app execution result screen is selected, the terminal (100) displays (or outputs) the robot movement video in the video display area, and displays (or outputs) a comparison target video corresponding to the robot movement video (or a comparison target video provided by the server (200) corresponding to the robot movement video) in the comparison target video display area. At this time, the terminal (100) synchronizes the robot movement video and the comparison target video based on the respective meta information of each video and displays the synchronized robot movement video and the comparison target video in the video display area and the comparison target video display area, respectively. If either the robot movement video or the comparison target video is paused or stopped by the pause or stop function, the terminal (100) controls the other to pause or stop simultaneously.

Additionally, the terminal (100) sets (or receives/inputs) labels (or label values) based on user input (or user selection/touch/control) regarding the correct or incorrect motions of objects included in specific timestamps (or time intervals) of the robot movement video displayed in the video display area.

In other words, at one or more specific points in the robot movement video displayed in the video display area, the terminal (100) receives input for label values indicating correct motions (e.g., pre-set approval/ACCEPT labels) or incorrect motions (e.g., pre-set rejection/REJECT labels) based on user input.

Thus, for the robot movement video related to the specific subject, the terminal (100) sets (or receives/inputs) one or more selective labels (or selective label values) at specific timestamps (or time intervals) based on user input from an expert related to the specific subject. Selective labeling (or first selective labeling) refers to a labeling method that sets (or attaches) labels (or label values) indicating the presence or absence of errors (or anomalies) at specific timestamps (or time intervals) of the robot movement video. If labels (or label values) are not set for certain timestamps (or time intervals) during selective labeling, pre-set default label values (e.g., approval labels) may be applied. Additionally, the terminal (100) attaches pre-set “not ACCEPT” labels to points (or sections/attributes/target attributes) of the robot movement video that do not have approval labels, and pre-set “not REJECT” labels to timestamps that do not have rejection labels in the robot movement video.

The terminal (100) also transmits one or more selective label values, meta information related to the robot movement video, and identification information of the terminal (100) to the server (200) based on one or more specific timestamps (or time intervals) of the robot movement video.

Additionally, the terminal (100), in conjunction with the server (200), may perform hierarchical labeling on the robot movement video either before or after performing selective labeling on the robot movement video. Selective labeling can also be performed on the robot motion video before or after performing hierarchical labeling. Hierarchical labeling refers to a labeling method where input feature engineering by the user attaches labels representing characteristics of the robot movement video, and the robot movement video is divided (or classified) into multiple sub-robot movement videos based on those characteristics.

In other words, the terminal (100), in conjunction with the server (200), refers to (or bases on) multiple pre-set label classifications related to the specific subject of the robot movement video displayed on the terminal (100), and based on user input (or user selection/touch/control), sets (or receives/inputs) labels (or label values) for other specific timestamps (or time intervals) of the robot movement video.

When the playback bar in the viewing screen of the app execution result screen on the terminal (100) is selected or the play button in the viewing screen is selected, the terminal (100) displays (or outputs) the robot movement video in the video display area and displays (or outputs) a comparison target video corresponding to the robot movement video (or a comparison target video provided by the server (200) corresponding to the robot movement video) in the comparison target video display area. At this time, the terminal (100) synchronizes the robot movement video and the comparison target video based on the respective meta information of each video and displays the synchronized robot movement video and the comparison target video in the video display area and the comparison target video display area, respectively. If either the robot movement video or the comparison target video is paused or stopped by the pause or stop function, the terminal (100) controls the other to pause or stop simultaneously.

Additionally, the terminal (100), based on user input (or user selection/touch/control), sets (or receives/inputs) one or more step-by-step labels (or label values) for the movement (or behavior) of objects included in different specific points (or specific sections) of the robot movement video displayed in the video display area.

In other words, at one or more other specific timestamps (or specific time intervals) in the robot movement video displayed in the video display area, the terminal (100) receives input for hierarchical labels (or hierarchical label values) related to the specific action of an object, the method of specific action, the specific stage of the specific method (or behavior) of the objects included in the video.

Thus, for the robot movement video related to the specific subject, the terminal (100) sets (or receives/inputs) one or more hierarchical labels (or hierarchical label values) at one or more other specific points (or specific sections) based on user input from an expert on the specific subject using the terminal (100).

Additionally, the terminal (100) performs the selective labeling process described earlier before or after performing the hierarchical labeling process.

The terminal (100) also receives the first robotics video transmitted from the server (200). The first robotics video is the result generated by the machine-leamed classification and prediction models based on the robot movement video from the server (200). The video may include movement-related videos of avatars, items, robots, or updated versions of the raw data (e.g., updated videos of human motions/behaviors included in the raw data).

The terminal (100) displays the received first robotics video in the video display area. At this time, the terminal (100) may divide the screen and simultaneously display the robot movement video, the comparison target video, and the first robotics video in a synchronized state.

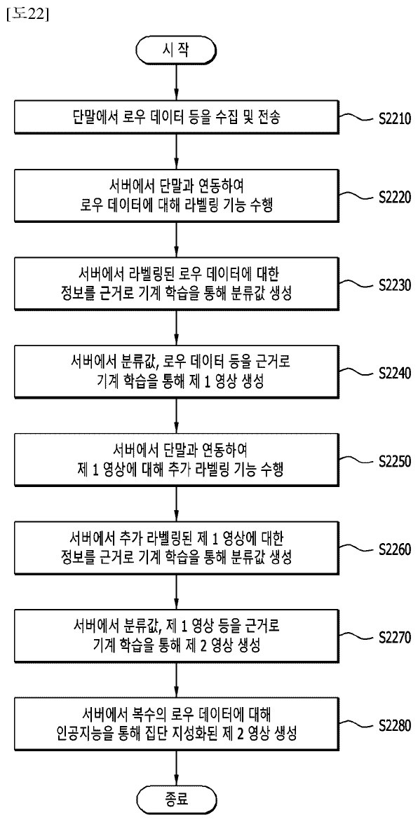

Additionally, the terminal (100), in conjunction with the server (200), performs additional selective labeling on the first robotics video. Here, the additional selective labeling (or secondary selective labeling) refers to a labeling method that sets (or attaches) labels (or label values) regarding the presence or absence of errors (or anomalies) at another specific timestamp (or specific time interval) in the first robotics video. If no labels (or label values) are set for certain timestamp (or time interval) during the additional selective labeling, pre-set default label values (e.g., approval labels) may be applied. Furthermore, the terminal (100) attaches pre-set “not ACCEPT” labels to points (or sections/attributes/target attributes) of the first robotics video that do not have approval labels, and pre-set “not REJECT” labels to points that do not have rejection labels. The secondary selective labeling may correspond to the first robotics selective labeling in FIG. 19.

In other words, the terminal (100), in conjunction with the server (200), sets (or receives/inputs) labels (or label values) for another specific timestamp (or specific time interval) of the first robotics video displayed on the terminal (100) based on user input (or user selection/touch/control).

Additionally, when the playback bar or play button on the viewing screen of the app execution result screen is selected, the terminal (100) displays (or outputs) the first robotics video in the video display area and displays (or outputs) a comparison target video corresponding to the robot movement video (or the first robotics video) in the comparison target video display area (or a comparison target video provided by the server (200) corresponding to the robot movement video/the first robotics video). At this time, the terminal (100) synchronizes the first robotics video and the comparison target video based on the respective meta information of each video and displays the synchronized first robotics video and comparison target video in the video display area and the comparison target video display area, respectively.

Additionally, the terminal (100), based on user input (or user selection/touch/control) on the first robotics video displayed in the video display area of the terminal (100), sets (or receives/inputs) labels (or label values) for correct or incorrect motions of the objects (or avatars) included in the first robotics video at another specific timestamp (or specific time interval).

In other words, at one or more other specific points (or specific sections) in the first robotics video displayed in the video display area, the terminal (100) receives input for label values regarding correct motions (e.g., pre-set approval/ACCEPT labels) or incorrect motions (e.g., pre-set rejection/REJECT labels) based on user input.

Thus, for the first robotics video related to the specific subject, the terminal (100), based on user input from an expert on the specific subject, sets (or receives/inputs) one or more additional selective labels (or additional selective label values) at one or more other specific timestamps (or specific time intervals).

At this time, the terminal (100), based on user input, performs time-series division selective labeling or body-part-specific selective labeling.

The terminal (100) performs time-series division selective labeling through the following process.

That is, for the multiple sub-robotics videos divide from the first robotics video, the terminal (100) receives label values regarding whether each of the sub-robotics videos is correct (e.g., pre-set approval/ACCEPT labels) or incorrect (e.g., pre-set rejection/REJECT labels) based on user input. Additionally, the terminal (100) receives label values for ordering the sub-robotics videos based on user input, which can indicate the correct sequence of the sub-robotics videos or be used to adjust the division timestamps if they are incorrect or need adjustment. The division of the first robotics video into multiple sub-robotics videos may be based on the information of the sub-robotics videos divided based on the information of the sub-robot movement videos by hierarchical labeling of the robot movement video. Alternatively, the division of the first robotics video into multiple sub-robotics videos may be based on the artificial intelligence functions or video analysis functions performed by the server (200) on the robot movement video.

Thus, the terminal (100) receives label values for the correct or incorrect states of the multiple sub-robotics videos, based on user input for the first robotics video. The terminal also receives label values for ordering the multiple sub-robotics videos (or label values for the order of the multiple sub-robotics videos/label values for adjusting the division timestamps when the division timestamp is in correct or needs to be adjusted).

Additionally, the terminal (100) transmits the label values for the correct or incorrect states of the multiple sub-robotics videos, the label values for ordering the sub-robotics videos (or the label values for the order of the sub-robotics videos or the label values for adjusting the division timestamps), and the identification information of the terminal (100) to the server (200).

Furthermore, the server (200), based on the time-series division selective labeling function performed on the first robotics video, receives the label values for the correct or incorrect states of the multiple sub-robotics videos, the label values for ordering the sub-robotics videos (or the label values for the order of the sub-robotics videos or the label values for adjusting the division time points), and the identification information of the terminal (100) from the terminal (100).

The server (200) reorganizes the sequence of the multiple sub-robotics videos divided from the first robotics video based on the received label values for the correct or incorrect states of the sub-robotics videos, the label values for ordering the sub-robotics videos (or the label values for the order of the sub-robotics videos or the label values for adjusting the division timestamps), and other relevant information.

Thus, when the first robotics video is divided into multiple sub-robotics videos, based on user input on the terminal (100), time-series division selective labeling may involve labeling whether each division timestamp (e.g., label values, still image information, etc.) for the multiple sub-robotics videos from the first robotics video is correct or incorrect. If the division timestamps are incorrect, the process may include labeling for adjusting the division timestamps or the sequence of the sub-robotics videos.

Additionally, the terminal (100) performs body-part-specific selective labeling through the following process:

For the avatars (or objects) included in the multiple sub-robotics videos divided from the first robotics video, the terminal receives label values for the avatars (or objects) included in the multiple sub-robotics (or label values for the correct or incorrect states of the motion sequence of the avatar) based on user input. The terminal also receives input for label values that indicate the order of the multiple sub-robotics videos, (or label values for adjusting the order of the sub-robotics videos including the avatar) based on user input. The division of the first robotics video into multiple sub-robotics videos may be based on the information for the multiple sub robotics data divided by performing the hierarchical labeling of the robot movement video, or the division of the first robotics video into multiple sub-robotics videos may be performed by the artificial intelligence or video analysis functions performed by the server (200) on the robot movement video.

Thus, the terminal (100), based on user input for the first robotics video, receives label values for the motion sequence of the avatars (or objects) included in the multiple sub-robotics videos (or label values for the correct or incorrect states of the motion sequence of the avatar). The terminal (100) also receives label values for adjusting (or indicating) the order of the multiple sub-robotics videos (or the order of the motion sequence of the avatar in the multiple sub-robotics videos). The terminal also receives label values to adjust the order of the sub-robotics videos.

Additionally, the terminal (100) transmits the label values for the motion sequence of the avatars (or objects) included in the multiple sub-robotics videos (or label values for the correct or incorrect states of the motion sequence of the avatar), the label values for adjusting (or indicating) the order of the multiple sub-robotics videos (or the order of the motion sequence of the avatar in the multiple sub-robotics videos), and the identification information of the terminal (100) to the server (200).

Furthermore, the server (200), based on the body-part-specific selective labeling function performed on the first robotics video, receives from the terminal (100), the label values for the motion sequence of the avatars (or objects) included in the multiple sub-robotics videos (or label values for the correct or incorrect states of the motion sequence of the avatar), the label values for adjusting (or indicating) the order of the multiple sub-robotics videos (or the order of the motion sequence of the avatar in the multiple sub-robotics videos) and the identification information of the terminal (100).

The server (200), based on the received label values for the motion sequence of the avatars (or objects) in the multiple sub-robotics videos (or label values for the correct or incorrect states of the motion sequence of the avatar) and the label values for adjusting (or indicating) the order of the multiple sub-robotics videos (or the order of the motion sequence of the avatar in the multiple sub-robotics videos) and so on, reorganizes the sequence of the multiple sub-robotics videos divided from the first robotics video.

When the first robotics video is divided into the multiple sub-robotics videos, body-part-specific selective labeling involves labeling for the correction or incorrection of the motion sequence of the avatars (or objects) included in the multiple sub-robotics videos created from the first robotics video. The process may involve labeling for label values for adjusting the order of the sub-robotics videos (or the order of the motion sequence of the avatar in the multiple sub-robotics videos), in order to adjust the order of the motion sequence of the avatars.

Furthermore, the body-part-specific selective labeling function includes the following additional features:

The server (200) provides the terminal (100) with information about the motion sequence of the avatars included in the multiple sub-robotics videos, based on the artificial intelligence functions or video analysis functions performed on the divided sub-robotics videos by the server (200).

Additionally, the terminal (100), based on user input, labels whether the motion sequence of the avatars included in the multiple sub-robotics videos is correct or incorrect, and if the motion sequence is incorrect or needs adjustment, the terminal (100) receives input for label values to adjust the motion sequence or the order of the sub-robotics videos that contain the avatars (or humans). The terminal (100) then transmits the label values indicating whether the motion sequence of the avatars is correct or incorrect (e.g., accept, reject), label values for adjusting the motion sequence or the order of the sub-robotics videos containing avatars, humans, or robots when the motion sequence is incorrect or needs adjustment, and the identification information of the terminal (100) to the server (200).

Additionally, the server (200) receives the label values from the terminal (100) indicating whether the motion sequence of the avatars in the multiple sub-robotics videos is correct or incorrect, label values for adjusting the motion sequence or the order of the sub-robotics videos including the avatar if the motion sequence is incorrect or needs adjustment, and the identification information of the terminal (100).

Furthermore, the server (200), based on the received label values indicating whether the motion sequence of the avatars is correct or incorrect and the label values for adjusting the motion sequence or the order of the sub-robotics videos including the avatar if the motion sequence is incorrect or needs adjustment, reorganizes the sequence of the multiple sub-robotics videos divided from the first robotics video.

Additionally, the terminal (100) transmits to the server (200) one or more additional selective label values, one or more time-series division selective label values, one or more body-part-specific selective label values, label values for ordering the multiple sub-robotics videos based on one or more other specific timestamps (or time interval) related to the first robotics video, and the identification information of the terminal (100).

Furthermore, the terminal (100), in conjunction with the server (200), may perform additional selective labeling before or after performing additional hierarchical labeling on the first robotics video and, additional hierarchical labeling may also be performed on the first robotics video before or after the execution of additional selective labeling. The additional hierarchical labeling refers to a labeling method where input feature engineering by the user assigns labels (or label values) representing the characteristics of the first robotics video, and the first robotics video is divided (or classified) into multiple sub-robotics videos based on these characteristics.

In other words, the terminal (100), in conjunction with the server (200), refers to (or bases on) multiple pre-set label classifications related to the specific subject of the first robotics video displayed on the terminal (100). Based on user input (or user selection/touch/control), the terminal (100) sets (or receives/inputs) additional labels (or additional label values) for other specific points (or specific sections) of the first robotics video.

When the playback bar or play button in the viewing screen of the app execution result screen is selected, the terminal (100) displays (or outputs) the first robotics video in the video display area and displays (or outputs) a comparison target video corresponding to the first robotics video (or a comparison target video provided by the server (200) corresponding to the robot movement video/first robotics video) in the comparison target video display area. The terminal (100) synchronizes the first robotics video and the comparison target video based on the respective meta information of each video and displays the synchronized first robotics video and the comparison target video in the video display area and the comparison target video display area, respectively. If either the first robotics video or the comparison target video is paused or stopped by the pause or stop function, the terminal (100) controls the other to pause or stop simultaneously.

Additionally, the terminal (100), based on user input (or user selection/touch/control), sets (or receives/inputs) one or more step-by-step additional labels (or additional label values) for the movement (or behavior) of the objects included in other specific timestamps (or time intervals) of the first robotics video displayed in the video display area.

In other words, at one or more other specific timestamps (or time intervals) of the first robotics video displayed in the video display area, the terminal (100), based on user input, receives input for additional hierarchical labels (or additional hierarchical label values) related to specific motions, specific methods of the specific motion, or the specific steps of the methods of the objects included in the first robotics video.

Thus, for the first robotics video related to the specific subject, the terminal (100), based on user input from an expert on the specific subject, sets (or receives/inputs) one or more additional hierarchical labels (or additional hierarchical label values) at one or more other specific timestamps (or time intervals).

Additionally, the terminal (100) performs the additional selective labeling process described earlier before or after performing the additional hierarchical labeling process.

In this way, the terminal (100) performs additional hierarchical labeling, additional selective labeling, and other functions on the first robotics video.

In one embodiment of the present invention, the additional hierarchical labeling function and the additional selective labeling function are described separately, but they are not limited to being performed independently. The terminal (100) may integrate the additional hierarchical labeling function with the additional selective labeling function, or it may perform them as a unified additional labeling function.

Furthermore, the terminal (100) receives the second robotics video transmitted from the server (200). The second robotics video is the result generated by the machine-learned classification and prediction models based on the first robotics video from the server (200). This video may include movement-related videos of avatars, items, robots, or updated versions of the first robotics video.

Additionally, the terminal (100) displays the received second robotics video in the video display area. At this time, the terminal (100) may divide the screen and simultaneously display the robot movement video, the comparison target video, the first robotics video, and the second robotics video in a synchronized state.

Moreover, the terminal (100) can receive the latest collective intelligence second robotics video (or an updated second robotics video) related to the specific subject (or raw data) from the server (200).

In one embodiment of the present invention, the terminal (300) in the form of a dedicated app performs functions such as raw data collection, hierarchical labeling for information/video, selective labeling for information/video, time-series division selective labeling for information/video, and body-part-specific selective labeling for information/video. However, this is not limited to the dedicated app, as these functions may also be performed through a website provided by the server (200), which enables raw data collection, hierarchical labeling for information/video, selective labeling, time-series division selective labeling, and body-part-specific selective labeling.

The server (200) communicates with the terminal (100) and other devices.

Additionally, the server (200) performs user registration procedures for users of the terminal (100) and other devices.

Furthermore, the server (200) registers personal information related to users of the terminal (100) and other devices. At this time, the server (200) can register (or manage) the personal information in the DB server (not shown).

Additionally, the server (200) performs user management functions for the users of the terminal (100) and other devices.

Moreover, the server (200) provides the terminal (100) and other devices with a dedicated app and/or website that offers functions such as raw data collection, hierarchical labeling for information/videos, selective labeling for information/videos, time-series division selective labeling for information/videos, and body-part-specific selective labeling for information/videos.

Furthermore, the server (200) provides a bulletin board function for announcements, events, and more.

Additionally, the server (200), in conjunction with the terminal (100) and the payment server, performs payment functions for subscription-based access to raw data collection, hierarchical labeling for information/videos, selective labeling for information/videos, time-series division selective labeling for information/videos, and body-part-specific selective labeling for information/videos, all of which are provided by the server (200) for the terminal (100).

If a payment fails, the server (200) provides the terminal (100) with payment failure information (e.g., payment date, payment amount, failure details such as insufficient balance, or credit limit exceeded) or information indicating that the payment has failed.

Moreover, once the payment process is successfully completed between the terminal (100) and the payment server, the server (200) sends the terminal (100) the payment results provided by the payment server. These results include information such as the subscription period, payment amount, payment date, and time.

Additionally, the server (200) manages (or stores/registers) the payment results by mapping (or linking) them to the terminal (100) (or the account information associated with the terminal (100)).

Furthermore, based on the subscription, the server (200) provides the terminal (100) with various information necessary for performing the raw data collection, hierarchical labeling for information/videos, selective labeling for information/videos, time-series division selective labeling for information/videos, and body-part-specific selective labeling for information/videos via the dedicated app provided by the server (200).

Additionally, the server (200) may further include a bus (not shown), a communication interface (not shown), and other components to provide communication functionality between the server (200)'s components.

The bus can be implemented in various forms, including an address bus, data bus, and control bus.

The communication interface supports wired/wireless internet communication for the server (200).

Additionally, the server (200) includes one or more instructions that, when loaded into memory, cause the processor to perform methods/functions according to various embodiments of the present invention. That is, by executing the one or more instructions, the processor performs the methods/functions according to various embodiments of the present invention.

Furthermore, the server (200) utilizes pre-collected raw data related to a specific subject, the meta information associated with the raw data, comparison target videos, meta information associated with the comparison target videos, first video, meta information associated with the first video, second video, meta information associated with the second video, movement-related videos of avatars and/or items, meta information associated with these movement-related videos, first robotics video, meta information associated with the first robotics video, second robotics video, and meta information associated with the second robotics video as data for continuous machine learning (or deep learning). The input dataset for machine learning includes the pre-collected raw data related to a specific subject, the meta information associated with the raw data, comparison target videos, meta information associated with the comparison target videos, first video, meta information associated with the first video, second video, meta information associated with the second video, movement-related videos of avatars and/or items, meta information associated with these movement-related videos, first robotics video, meta information associated with the first robotics video, second robotics video, and meta information associated with the second robotics video, and they can be divided into training and test sets in a predefined ratio (e.g., 7:3, 8:2, etc.) for training and testing purposes. The input dataset for machine learning can also include raw data to a specific subject, which will be collected later, the meta information associated with the raw data, comparison target videos, and meta information associated with the comparison target videos, a first video, the meta information related to the first video, a second video, the meta information related to the second video, motion-related videos of avatars and/or items, the meta information related to those motion-related videos, a first robotics video, the meta information related to the first robotics video, a second robotics video, and the meta information related to the second robotics video. The output dataset for machine learning includes the parts to be predicted, learning from the collected information to classify or predict later, and categorizing labels related to the raw data, the first video, the second video, the movement-related videos, the first robotics video, the second robotics video, and generating new videos like first video, second video, first robotics video, and second robotics video based on the categorized information.

Thus, the server (200) performs the learning function on the classification model using pre-set training data to classify label values related to raw data, first video, movement-related videos of avatars/items, first robotics video, etc., for a specific subject. In doing so, the server (200) stores the information in a parallel and distributed manner, cleanses unstructured, structured, and semi-structured data related to the pre-collected raw data related to a specific subject, the meta information associated with the raw data, comparison target videos, meta information associated with the comparison target videos, first video, meta information associated with the first video, second video, meta information associated with the second video, movement-related videos of avatars and/or items, meta information associated with these movement-related videos, first robotics video, meta information associated with the first robotics video, second robotics video, and meta information associated with the second robotics video, and conducts preprocessing, including meta data classification. The server (200) then analyzes the preprocessed data, including data mining, and builds big data by conducting machine learning, training, and testing. The machine learning can involve supervised learning, semi-supervised learning, unsupervised learning, reinforcement learning, and deep reinforcement learning, either individually or in combination.

Furthermore, the server (200) performs the learning function on the prediction model using pre-set training data for the specific subject, based on the classification model and the classified values, raw data, meta information associated to raw data, comparison target videos, meta information associated with the comparison target videos, first video, meta information associated with the first video, second video, meta information associated with the second video, movement-related videos of avatars and/or items, meta information associated with these movement-related videos, first robotics video, meta information associated with the first robotics video, second robotics video, meta information associated with the second robotics video and so on to generate new videos (e.g., first video, second video) based on the related information. The server (200) stores the information in a parallel and distributed manner, cleanses the unstructured, structured, and semi-structured data related to the classification model and the classified values, raw data, meta information associated to raw data, comparison target videos, meta information associated with the comparison target videos, first video, meta information associated with the first video, second video, meta information associated with the second video, movement-related videos of avatars and/or items, meta information associated with these movement-related videos, first robotics video, meta information associated with the first robotics video, second robotics video, meta information associated with the second robotics video and so on, conducts preprocessing, analyzes the preprocessed data using data mining, and builds big data by conducting machine learning, training, and testing. This machine learning can include supervised learning, semi-supervised learning, unsupervised learning, reinforcement learning, and deep reinforcement learning, either individually or in combination.

Through this process, the server (200) performs learning functions on the classification model, prediction model, and others using neural networks.

Additionally, the server (200) uses generative neural network algorithms and tracking neural networks. Here, the tracking neural network can be a model that processes sequential inputs and measures the relative values of the xyz coordinates of object video information in four-dimensional vector form and structures the data.

In one embodiment of the present invention, generative neural network algorithms and tracking neural networks may use GNN (Graph Neural Network) and GAN (Generative Adversarial Network).artificial intelligence algorithms may combine GAN and GNN, apply GNN alone without GAN, or use GAN alone without GNN. When GAN is used alone, “GNN Regression Model Type 1” and “GNN Regression Model Type 2” are not used, and deep learning and association rules are used to calculate predictions for attributes and target attributes. GAN enhances the representation, image quality, and precision of still images and videos. Inferences are made using movement pattern association rules to predict the next motions.

The first basic video information, which is raw data, becomes the first attribute (1224) and the first target attribute (1225) clustered through first hierarchical labeling (1210).

Referring to FIG. 3 to FIG. 5, when the user performs first hierarchical labeling (1210) on multiple basic videos (or raw data/basic video information) during the annotation phase, the basic video information is hierarchically clustered. This is referred to as the first hierarchical cluster, and the basic video represents the video output in the viewing screen of the terminal (100).

Additionally, the server (200) receives one or more raw data sets, meta information related to the raw data, comparison target videos, meta information related to the comparison target videos, and identification information of the terminal (100) transmitted from the terminal (100).

If no comparison target video related to the raw data is transmitted from the terminal (100), the server (200) checks (or searches for) the comparison target video related to the raw data from the multiple comparison target videos managed by the server (200) based on the received raw data and the meta information related to the raw data for the specific subject, and provides the identified comparison target video, the meta information related to the identified comparison target video, etc., to the terminal (100).

Furthermore, the server (200) performs selective labeling on the one or more received raw data sets. Here, selective labeling (or selective labeling) refers to a labeling method that sets (or assigns) a label (or label value) for the presence or absence of an error (or anomaly) at a specific point in timestamp (or specific time interval) of the raw data. If no label (or label value) is set at a particular timestamp (or time interval) during the selective labeling of the raw data, a predefined default label value (e.g., an approval label) may be applied.

That is, the server (200), in conjunction with the terminal (100), sets (or receives/inputs) a label (or label value) for specific timestamps (or specific time intervals) of the raw data based on user input (or user selection/touch/control) from the terminal (100) for the raw data displayed at the terminal (100).

Additionally, the server (200) receives from the terminal (100) one or more selective label values, meta information related to the raw data, identification information of the terminal (100), and other information at one or more specific timestamps (or specific time intervals) related to the raw data.

In one embodiment of the present invention, it is primarily described that the terminal (100) sets (or receives/inputs) one or more selective label values at one or more specific timestamps (or time intervals) in the raw data based on user input at the terminal (100). However, this is not limited to that, and the server (200) may also perform video analysis functions on the raw data and the comparison target videos related to the raw data. Based on the results of the video analysis function, one or more selective label values can be automatically set at one or more specific timestamps (or time intervals) of the raw data.

Moreover, when the server (200) sets one or more selective label values at one or more specific timestamps (or time intervals) in the raw data, the server (200) provides the information for one or more selective label values at one or more specific timestamps (or time intervals) in the raw data to the terminal (100), displaying, at the terminal (100), the one or more selective label values at one or more specific timestamps (or time intervals) related to the raw data set in the server (200). The user can then decide whether to approve the one or more selective label values at one or more specific timestamps (or time intervals) based on user input at the terminal (100).

Before or after performing selective labeling on the one or more raw data sets, the server (200), in conjunction with the terminal (100), performs hierarchical labeling on the one or more raw data, and before or after hierarchical labeling, the server may also perform selective labeling on the one or more raw data. Here, hierarchical labeling refers to a labeling method that applies labels (or label values) representing features of the raw data as input feature engineering by user and divides (or classifies) the raw data into multiple sub-raw data based on the features.

That is, the server (200), in conjunction with the terminal (100), sets (or receives/inputs) labels (or label values) at different specific timestamps (or time intervals) in the raw data displayed on the terminal (100) by referencing (or based on) predefined label classifications related to the specific subject.

Additionally, the server (200) divides the raw data into multiple sub-raw data.

In one embodiment of the present invention, it is primarily explained that the terminal (100) sets (or receives/inputs) one or more hierarchical label values at one or more different specific timestamps (or different time intervals) in the raw data based on user input. However, this is not limited to that. The server (200) may also perform video analysis functions on the raw data and the comparison target video related to the raw data, and based on the results of the video analysis function, automatically set one or more hierarchical label values at one or more different specific timestamps (or time intervals) in the raw data.

Moreover, when the server (200) sets one or more hierarchical label values at one or more different specific timestamps (or time intervals) in the raw data, the server (200) provides the information for the one or more hierarchical label values at one or more different specific timestamps (or time intervals) in the raw data to the terminal (100). The terminal (100) displays the information for the one or more hierarchical label values at the one or more different specific timestamps (or time intervals) set by the server (200), allowing the user to decide on the final approval of the one or more hierarchical label values at the one or more different specific timestamps (or time intervals) based on user input at the terminal (100).

Additionally, the server (200) calls a library related to input feature engineering to convert basic video information (or raw data) into input feature vectors. Hierarchical labeling by the user involves dividing the basic video data into data unit 3 or data unit 4, and the attribute values of data unit 3 or data unit 4 become complex input features for training the prediction model through supervised learning. The complex input features represent basic video information converted into input features. The basic video information may include a combination of point clouds, RGB, JPG, video information, voxels (or 3D images), and vector formats.

Moreover, hierarchical labeling by the user can be omitted when the server (200) calls the input feature engineering library to convert the basic video information into input feature vectors.

The first hierarchical cluster (1201) may be automatically created by the server (200). When the user does not perform partial or entire hierarchical labeling such as first or second hierarchical labeling, the artificial intelligence automatically retrieves the input features. This process of hierarchical clustering labeling is performed by the server (200).

In one embodiment of the present invention, the step of receiving hierarchical labeling information for the hierarchical clustering can be omitted. The first, second, and third hierarchical labeling steps of user-driven input feature engineering may be omitted, and the server (200) automatically retrieves the input features. The repetitive hierarchical labeling processes (e.g., first, second, and third hierarchical labeling) performed by the user can be omitted, with the server (200) automatically obtaining the input features.

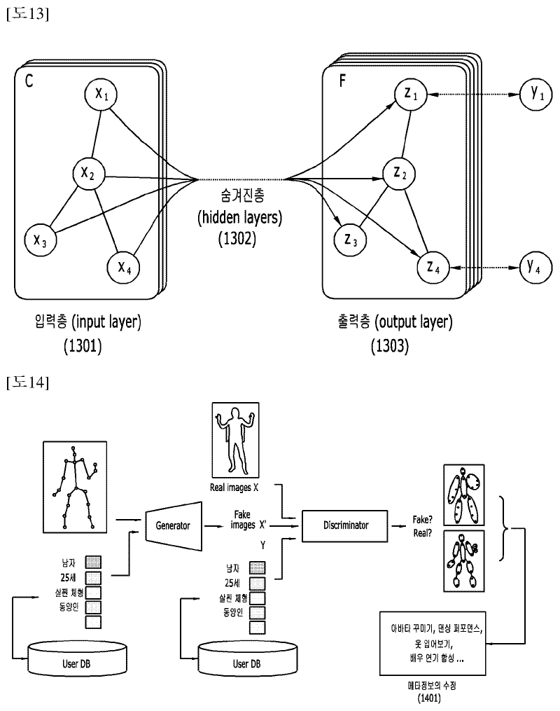

In FIG. 12, the first hierarchical cluster (1201) represents the clustering of the first basic video information through first hierarchical labeling (1210). The first hierarchical cluster (1201) corresponds to hierarchical clustering (700) based on data unit 3 in FIG. 7 or hierarchical clustering (900) based on data unit 4 in FIG. 9.

In one embodiment of the present invention, the hierarchical cluster includes a method in which the server (200) automatically retrieves the input features.

In FIG. 12, the second hierarchical labeling is performed on the first video information displayed on the viewing screen of the terminal (100), where the user refers to the label classifications in [Tables 1] to [Tables 11] to input hierarchical cluster label values for the first video information.

In one embodiment of the present invention, the user (or terminal (100)/server (200)) does not perform specific stage-by-stage labeling or detailed motion labeling. The video may be divided into data unit 3, data unit 4, or data unit 5 by the server (200).

Additionally, the server (200) performs artificial intelligence-based machine learning on the information regarding the selectively labeled raw data and generates (or verifies) classification values for the raw data based on the machine learning results. Here, the classification values for the raw data (or the classification values for the selectively labeled raw data/hierarchically labeled raw data) may be values classified according to the same items, such as selective labeling values or hierarchical labeling values.

In other words, the server (200) uses the information about the selectively labeled raw data as input to a predefined classification model, performing machine learning (or artificial intelligence/deep learning) and generating (or verifying) classification values for the raw data based on the machine learning results (or artificial intelligence results/deep learning results).

In various embodiments, labeling in the labeling stage, such as classifying motions of avatars, humans, robots, etc., as either approved (ACCEPT) or rejected (REJECT), is carried out in a supervised learning manner and constitutes a classification model. Binary classification (ACCEPT/REJECT) can be implemented as a standard binary classification model, and if motions or surgeries are classified on a five-point scale, it can be implemented as a multi-class classification model, where each class yields a probability value.

In various embodiments, labeling can also be done using a binary approach where users select either APPROVE or REJECT in the user interface of the app on the terminal (100), but it is also possible to label the video information using a three-class system of APPROVE, NORMAL, and REJECT. The labeling can be further refined into five or six stages of labeling by classifying motions as either good or bad in degrees. If the labeling is detailed into five or six stages, the motions can be scored from 5 to 1. Actions with scores above a certain threshold (e.g., 4 or higher) are categorized as APPROVE, while motions with scores below a certain threshold (e.g., 2 or lower) are categorized as REJECT. Scores of 3 are classified as NORMAL.

Moreover, the server (200) uses the generated classification values for the raw data (or the classification values for the raw data), the information about the selectively labeled raw data, the raw data, meta information related to the raw data, the comparison target video, and meta information related to the comparison target video as input to the machine learning (or artificial intelligence/deep learning) and generates a first video corresponding to the raw data based on the machine learning results (or artificial intelligence results/deep learning results). The first video may be a movement-related video of avatars, items, robots, or other entities generated based on the raw data or an updated video (e.g., updated human movements/behaviors included in the raw data).

In other words, the server (200) uses the generated classification values for the raw data (or the classification values for the raw data), the information about the selectively labeled raw data, the raw data, meta information related to the raw data, the comparison target video, and meta information related to the comparison target video as input to a predefined prediction model. It performs machine learning (or artificial intelligence/deep learning) and generates the first video related to the raw data based on the machine learning results (or artificial intelligence results/deep learning results).

Furthermore, the server (200) transmits (or provides) the generated first video to the terminal (100).

As shown in FIG. 13, the structure of the GNN is as follows.

Objects within videos or still images are represented as nodes (e.g., x1 to x4, z1 to z4). These objects are interconnected, and there is a sequential movement pattern where these relationships mutually influence each other. The input layer (1301) and output layer (1303) consist of multiple overlapping layers, with a hidden layer (1302) located between the input layer (1301) and output layer (1303). When input data is input, the next output is predicted.

Traditional GAN uses a 3D voxel method. However, when space is voxelized in 3D, the X*, Y*, and Z* coordinates result in 4-dimensional data that can reach hundreds of megabytes, requiring significant hardware, GPU, and memory resources, and taking considerable time to train. Due to these issues, the point cloud method has recently become more popular. The point cloud method enables physical measurement of real spaces using tools such as LiDAR and allows for the physical measurement and structuring of relative xyz coordinate values, making it more effective than the 3D voxel method. However, the downside of the point method is that it is unstructured and unaligned, providing only a limited representation of object features to artificial intelligence. Therefore, it is necessary to represent the sorted information of relative values and features.

In one embodiment of the present invention, the GAN expresses information about the characteristics of videos, poses, and movements, by additionally representing joint characteristics (e.g., only able to fold inward), angles, distances, and landmark points in the connection between points.

In one embodiment of the present invention, the point cloud can be embodied in other data structures within the range that does not deviate from essential characteristics.

In other words, the GAN according to one embodiment of the present invention expresses the characteristics of joints and structures in vector form and can adopt a data structure replaced from the point cloud into a GNN form.

Furthermore, when applying the GAN to 3D spaces, 3D motion, body shapes, and movements, the spatial information is generated as objects composed of multiple points, rather than individual points, and these are structured as GNN data for processing.

When processing in GNN form, meta information is additionally used as another feature of the input value, and if the form of the meta information is different, it cannot be simply changed, so it is used by dividing into layers and merging.

The meta information used as another input value through merging includes user information and item information.

Meta information is used as supplementary information for supervised labels s and also used as conditional information during the training of unsupervised GAN.

This meta information is remembered by the GAN during various visual training sessions in terms of the degree of similarity, and it is utilized as in put data to assist in making adaptive intervention adjustments to visual information when specific attribute information changes in the future. In one embodiment of the present invention, when muscle mass is increased or age is reduced, the shape of the generated virtual avatar can change according to the corresponding meta information value.

A GNN can represent an artificial neural network structure implemented by using modeled data, which is based on data mapped between specific parameters, to derive similarities and key features between the modeled data. Other algorithms aside from those mentioned can also be used and are not limited to the algorithms mentioned.

In one embodiment of the present invention, user information includes the shape and color of the face and body, age, gender, hair, race, degree of fat, degree of musculature, various categorical information, numeric information, and other user attribute information. Item information includes brand, creator ID, advertiser ID, NFT ID, product group ID, and other item attribute information. In cases where it is used in digital cadavers, the information includes the name of each body part, blood type, age, gender, type of disease, and its progress status.

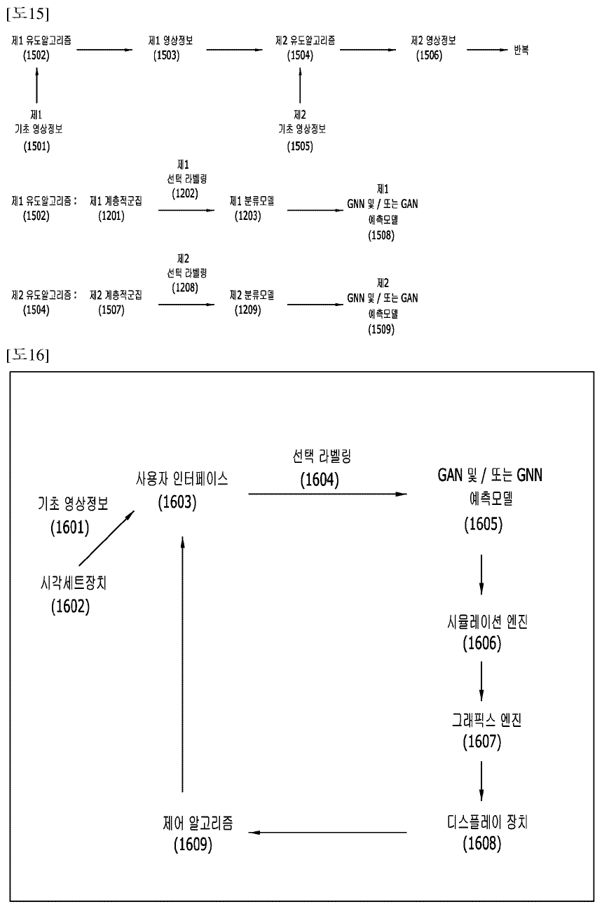

As shown in FIG. 14, the server (200) modifies the conditional meta information of the Conditional GAN (1401) to adjust body shape characteristics of the avatar, such as slimming down or becoming muscular. As shown in FIG. 14, the meta-information can be modified (1401) across various games.

In one embodiment of the present invention, the server (200) generates (or manages) avatars that operates dancing performances, virtual surgeries, virtual soccer games, virtual fighter jets, and more.

In one embodiment of the present invention, the digital cadaver can be an external object that allows for the replacement of items such as dental prostheses or implants during dental surgery. These can be replaced and simulated pre-surgery. In plastic surgery, it can be used for post-surgery simulation, while in general surgery, it can be used for physical combination simulations based on 3D size and structure. Through this, characteristics of pre-trained objects (e.g., the opening and closing of medical equipment, the fact that the doctor's hands and feet cannot be detached from the body and can only bend inward, and medical devices/tools in the digital cadaver can detach and reattach) are used as training features.

This also allows the use of characteristics of pre-trained objects (e.g., a dental handpiece's blade can rotate, tissue can be opened by a surgical scalpel, teeth can be extracted from the gums, and human organs can be replaced) as training features.

This can also be used to train features of pre-trained objects (e.g., car wheels can turn, a house's front door can open, hands and feet cannot be detached from the body and can only bend inward, and hats can be removed from and placed on the head) as training features.

Thus, the server (200) modifies the conditional meta information of the Conditional GAN (1401) to adjust various disease information in digital cadavers, which are a type of avatar, according to variations and cases.

In various embodiments, the terminal (100) may be a VR simulator in various forms. VR simulators, which receive visual rendering provided by GAN and/or GNN predictive models, also provide haptic rendering simultaneously. VR simulators are connected to visual set devices and various types of haptic devices. The types of VR simulators include, but are not limited to, the following: dental removal VR simulators, surgery VR simulators, vehicle VR simulators, VR treadmills, etc.

In one embodiment of the present invention, the dental removal VR simulator requires equipment such as HMD, haptic devices, and a foot pedal system used in a dental chair (e.g., Arduino, Raspberry Pi, etc.). A digital cadaver is created in virtual reality using 3D printing, and an artificial cadaver is made with HD tactile feedback. Virtual dental treatments and surgeries are performed using VR and 3D simulators.

In one embodiment of the present invention, the surgery VR simulator operates as follows. A 3D model of the patient's lesion is created, and based on the location, condition, and visual information of the lesion, the patient's 3D coordinate system is matched with the coordinates of the patient lying on the operating table, allowing the surgeon to perform surgery by predicting the location of the hidden lesion.

In one embodiment of the present invention, in various types of VR simulators (examples of VEHICLES: submarines, tanks, drones, fighter jets, etc.), the driving methods of avatars, humans, and robots using the control devices of the VEHICLE-type VR simulators can be datafied to generate avatars.

The VR VEHICLE simulator simulates using the pilot's own avatar arms, legs, and other body parts. The coordinate system is synchronized according to the rules within the metaverse world from the start to the end. To implement high-level visual rendering, LIDAR, infrared tracking, and motion tracking must be equipped to align the motion data of the human body, and an alignment algorithm for the simulator's location within the metaverse world is also required.

For example, the visual data (basic video information) obtained from virtual flight piloting becomes the dataset for the initial model of the induction and/or inference algorithm in FIG. 12.

The induction and/or inference algorithm (1200) in FIG. 12 is the sum of the partial induction and/or inference algorithms (first and second induction and/or inference algorithms) shown in FIG. 15.

The visual data (basic video information) obtained from virtual flight piloting serves as the foundational data enabling artificial intelligence to operate the flight simulator. If numerous errors and discrepancies occur in the artificial intelligence's virtual flight piloting, the user (pilot) performs selective labeling through the user interface on the app execution results screen (or viewing screen) of the terminal (100).

In one embodiment of the present invention, the avatar control system using a VR treadmill (with HEAD MOUNTED DISPLAY) requires the following technologies:

An alignment algorithm for the user's and avatar's movement, behavior, infinite walking, and rotation, a posture control system, a motion and movement control system using a VIVE tracker, an infinite walking and body motion data alignment algorithm using LIDAR and infrared tracking (utilizing pressure values from shoes and infrared sensor values), a VR treadmill body designed to support almost all human movements, a reaction technology that responds to the coordinate system and environmental variations in the metaverse world, a motion data synchronization system with a dedicated server, and a synchronization system that enables the user's network play.

In FIGS. 7 to 11, the ‘GNN Regression Model Type 1’ is defined as a regression model that uses GNN for the coordinate values and various visual data of the static image attributes belonging to one of the K2 to K6 clusters. The ‘GNN Regression Model Type 2’ is defined as a regression model that uses GNN for the coordinate values and various visual data of the target attribute videos.

Referring to FIG. 13, the model that predicts the relative video information and state values at specific timestamp for the avatar's motions and behaviors is structured in GNN form, and the model that predicts each value is defined as ‘GNN Regression Model Type 1 and Type 2.’

When using GAN alone, the First Association Rule Type 1 (1214) and First Association Rule Type 2 (1215) predict the second attribute (1226) and second target attribute (1227). The association rules Type 1 and Type 2 are models that infer still images and videos using association rules and deep learning (a sequential input model that excludes the GNN regression model) without using GNN. They are the same models as the GNN Regression Model Type 1 and Type 2 in FIG. 13, except they do not use the GNN structure.

In one embodiment of the present invention, the deep learning used in the tracking neural network (a sequential input model excluding the GNN regression model, where the object's x, y, z coordinates are tracked) includes a deep neural network.

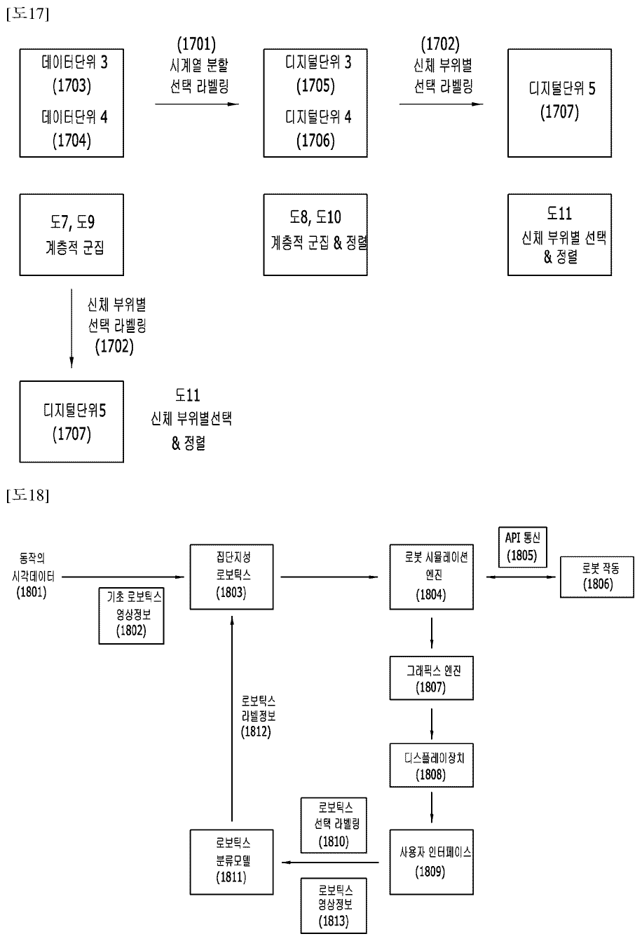

‘GNN Regression Models Type 1 and 2’ or ‘Association Rule Type 1 and 2’ use a sliding window technique and are models that receive sequential input. ‘GNN Regression Models Type 1 and 2’ or ‘Association Rule Type 1 and 2’ are the ‘GAN and/or GNN Prediction Model (1605)’ in FIG. 16.

Referring to FIG. 16, in the user interface (1603) of terminal (100) connected to the visual set device (1602), the user performs selection labeling (1604), and the labeled visual data is used in the GAN and/or GNN Prediction Model (1605). The GAN and/or GNN Prediction Model (1605) transmits the visual data to the simulation engine (1606) to generate or output the avatar's movement. In FIG. 16, the visual data is transmitted sequentially to the simulation engine (1606), the graphics engine (1607), the display device (1608), and the control algorithm (1609), and is displayed through the user interface (1603). The app execution result screen (or view screen) of terminal (100) is the user interface (1603) implemented as a screen on terminal (100).

The GAN and/or GNN Prediction Model (1605) in FIG. 16 includes an interface API process.

In various embodiments, examples of the interface API are as follows. Data received by IoT Edge devices (such as Arduino, Raspberry Pi, etc.) may be raw input data or output results from artificial intelligence inference run on the Edge. The artificial intelligence models written in Python or similar languages can be converted for IoT Edge devices using open-source libraries such as ONNX. Through this process, the output result data first inferred on the Edge and input data are re-inferred through a server API call for more complex collective intelligence models.

The digital unit refers to video units divided by artificial intelligence and user interactions (e.g., time-series division selection labeling, body-part-based selection labeling, etc.).

In the hierarchical clustering in FIG. 7 or FIG. 9, the first attribute (1224) labeled by selection labeling (1604) for each of the K2 or K4 clusters is classified, and the first GNN Regression Model Type 1 (1204) or the first Association Rule Type 1 (1214) is induced and/or inferred.

In the hierarchical clustering in FIG. 7 or FIG. 9, the first attribute (1224) and the first target attribute (1225) in the K2 or K4 clusters are used to induce and/or infer the first GNN Regression Model Type 2 (1205) or the first Association Rule Type 2 (1215).

When the time-series sequence of still image information (data units 1, 2, or the first property, 1224) is input into the first GNN Regression Model Type 1 (1204) or the first Association Rule Type 1 (1214), the first GNN Regression Model Type 1 (1204) or the first Association Rule Type 1 (1214) returns a time-series sequence of the second attribute (1226) to the app execution result screen (or view screen) of terminal (100). The second attribute (1226) is the prediction value (1206, 1216) of the first GNN Regression Model Type 1 (1204) or the first Association Rule Type 1 (1214) and represents the feature vector representation of still image information at the k-th, L-th, or f-th step of the motion video.

When the time-series sequence of the second attribute (1226) is input into the first GNN Regression Model Type 2 (1205) or the first Association Rule Type 2 (1215), the first GNN Regression Model Type 2 (1205) or the first Association Rule Type 2 (1215) generates and outputs the second target attribute (1227), which is the prediction value (1207, 1217) of the first GNN Regression Model Type 2 (1205) or the first Association Rule Type 2 (1215) to the app execution result screen (or view screen) of terminal (100). The second target attribute (1227) represents the feature vector representation of the video information at the k-th, L-th, or f-th step of the motion video.

Referring to FIG. 12 and FIG. 15, the first induction and/or inference algorithm (1502) proceeds as follows: the data of the first hierarchical cluster (1201) is labeled by first selection labeling (1202), and the first classification model (1203) is induced and/or inferred. The classified first attribute (1224) and first target attribute (1225) are used in the inference of the first GAN and/or GNN Prediction Model (1508).

Additionally, the server (200) performs additional selective labeling on the first video. Here, the additional selective labeling (or additional selective labeling) refers to a labeling method for setting (or attaching) a label (or label value) regarding the presence or absence of errors (or anomalies) at another specific timestamp (or time interval) in the first video. At this time, for any timestamps (or time intervals) in the first video where a label (or label value) has not been set according to the additional selective labeling, a pre-set default label value (for example, an approval label) can be applied.

In other words, the server (200), in conjunction with the terminal (100), sets (or receives/inputs) a label (or label value) at another specific timestamp (or time interval) in the first video displayed on the terminal (100), according to the user input (or selection/touch/control) of the terminal (100).

Moreover, the server (200) receives one or more additional selective label values for another specific timestamp (or time interval), one or more time-series division selective label values, one or more body-part selective label values, label values for sorting the order of multiple sub-videos, related to the first video transmitted from the terminal (100) and the identification information of the terminal (100).

In the embodiment of the present invention, although the main explanation is that one or more additional selective label values are set (or received/input) at one or more other specific timestamps (or time intervals) in the first video according to user input from the terminal (100), it is not limited to this. The server (200) may perform video analysis functions on the first video and the comparison target video related to the first video, and based on the results of the video analysis, it may automatically set one or more additional selective label values at one or more other specific timestamps (or time intervals) in the first video.

Additionally, when the server (200) has set one or more additional selective label values at one or more other specific timestamps (or time intervals) in the first video, the server (200) provides the information about the additional selective label values for the first video to the terminal (100). The terminal (100) displays the information about the additional selective label values set for the first video by the server (200) at one or more other specific timestamps (or time intervals) in the first video. Based on the user input from the terminal (100), it may also be configured to make a final decision on whether to approve the one or more additional selective label values at one or more other specific timestamps (or time intervals).

At this time, either before or after performing additional selective labeling on the first video, the server (200), in conjunction with the terminal (100), may perform additional hierarchical labeling on one or more of the first videos. Before or after performing additional hierarchical labeling, additional selective labeling may also be performed on the first video. Here, the additional hierarchical labeling refers to a labeling method in which labels (or label values) representing the features of the first video are applied through input feature engineering by the user, and the first video is divided (or classified) into multiple sub-videos based on these features.

In other words, the server (200), in conjunction with the terminal (100), references (or bases on) multiple pre-set label classifications related to the specific subject, for the first video displayed on the terminal (100) and sets (or receives/inputs) additional labels (or additional label values) at one or more other specific timestamps (or time intervals) in the first video based on the user input (or selection/touch/control) of the terminal (100).

Additionally, the server (200) divides the first video into multiple sub-videos.

In the embodiment of the present invention, although the main explanation is that one or more additional hierarchical labels (or additional hierarchical label values) are set (or received/input) at one or more other specific timestamps (or time intervals) in the first video according to user input from the terminal (100), it is not limited to this. The server (200) may perform video analysis functions on the first video and the comparison target video related to the first video, and based on the results of the video analysis, it may automatically set one or more additional hierarchical label values at one or more other specific timestamps (or time intervals) in the first video.

Additionally, if the server (200) has set one or more additional hierarchical label values at one or more other specific timestamps (or time intervals) in the first video, the server (200) provides the information about the one or more additional hierarchical label values in the one or more other specific timestamps (or time intervals) for the first video to the terminal (100). The terminal (100) displays the information about the additional hierarchical label values set by the server (200) at one or more other specific timestamps (or time intervals) in the first video, and based on the user input from the terminal (100), it allows the user to make a final decision on whether to approve the additional hierarchical label values at one or more other specific timestamps (or time intervals).

In FIG. 15, when second hierarchical labeling (1220) is performed on the first video information (1503), which is the predicted value of the first GNN and/or GAN prediction model (1508), the second hierarchical cluster (1507) is created. Simultaneously, first hierarchical labeling is performed on the second base video information (1506), and the generated cluster is included in the second hierarchical cluster (1507).

In one embodiment of the present invention, the step of receiving the second hierarchical labeling (1220) information, which receives the hierarchical clustering labeling information, is omitted. Input feature engineering by the user can be omitted, and it may be automatically generated by the server (200).

In the embodiment of the present invention, the second hierarchical labeling (1220) can be included and implemented within the second selective labeling (1208).

Additionally, based on the information of the additional selective labeling regarding the first video, the server (200) performs another machine learning process based on artificial intelligence and generates (or verifies) classification values for the first video based on the results of this machine learning. Here, the classification values for the first video (or the classification values of the first video) may be values categorized by the same item for additional selective labeling values, additional hierarchical labeling values, etc.

In other words, the server (200) uses the information of the additional selective labeling regarding the first video as input for the pre-set classification model, performs another machine learning (or another artificial intelligence/deep learning process), and generates (or verifies) classification values for the first video based on the results of this machine learning (or artificial intelligence/deep learning process).

The server (200) includes the step of inducing and/or inferring a second classification model (1209) that induces and/or infers a classification model for the basic video data (or raw data) entered by K7 (several times)*K8 (several persons) users.

The value predicted by the first GAN and/or GNN prediction model (1508) is the first video information (1503). The still image information of the first video information (1503) is the second attribute (1226), and the video information is the second target attribute (1227).

The second classification model (1209) categorizes the ‘second attribute (1226) and second target attribute (1227)’ that belong to a specific cluster, which is one of the second hierarchical clusters (1507). When users input hierarchical clustering label values for the second attribute (1226) and second target attribute (1227) within a specific cluster and perform ‘selective labeling (1604)’, a classification model for the labeled data is induced and/or inferred. In the classification model, the first attribute (1224) and first target attribute (1225) of the second basic video information (1505) are trained as a single model.

In one embodiment of the present invention, when the step of receiving second hierarchical labeling information for the first video information, which is based on first basic video information input by the user, and the step of receiving first hierarchical labeling information based on the second basic video information are omitted, hierarchical clusters are automatically generated by the server (200).

Additionally, the server (200) performs another machine learning process (or another artificial intelligence/deep learning process) using the classification values of the generated first video (or the classification values of the first video), the information of the additional selective labeling for the first video, the first video, meta-information related to the first video, the comparison target video, and meta-information related to the comparison target video as input values. Based on the results of the another machine learning process (or artificial intelligence/deep learning process), a second video corresponding to the first video is generated. In this case, the second video may be a motion-related video of an avatar, item, robot, or an updated version of the first video generated based on the first video.

In other words, the server (200) performs another machine learning process (or another artificial intelligence/deep learning process) using the classification values of the generated first video (or the classification values of the first video), the information of the additional selective labeling regarding the first video that has undergone, the first video, meta-information related to the first video, the comparison target video, and meta-information related to the comparison target video as input values for the pre-set prediction model. Based on the results of this machine learning process (or artificial intelligence/deep learning process), a second video related to the first video is generated.

Additionally, the server (200) transmits (or provides) the generated second video to the terminal (100).

‘First basic video information, second basic video information, etc.’ are visual data continuously collected from the real world via the visual set device (1602), which is input into the induction and/or inference (artificial intelligence inference) algorithm (1200) shown in FIG. 12.

The second induction and/or inference algorithm (1504) operates as follows. The prediction value of the first GAN and/or GNN prediction model (1508) becomes the second hierarchical cluster (1507) through second hierarchical labeling (1220). The data of the second hierarchical cluster (1507) is second selectively labeled (1208), and a second classification model (1209) is induced and/or inferred. The classified second attribute (1226) and second target attribute are used for the induction and/or inference of the second GAN and/or GNN prediction model (1509). This process of induction and/or inference is repeated for the algorithm.

The first GAN and/or GNN prediction model (1508) is either the first GNN regression model type 1 (1204) or type 2 (1205), or the first association rule type 1 (1214) and type 2 (1215).

The second GAN and/or GNN prediction model (1509) is induced and/or inferred with the second selective labeling (1208) of the second hierarchical cluster (1507) from the first video information (1503), which is based on the first basic video information (1501), and with the second attributes (1226) and second target attributes (1227) classified by the second classification model (1209). The second hierarchical cluster (1507) consists of the second attributes (1226) and second target attributes (1227). Furthermore, the first attributes (1224) and first target attributes (1225) based on the second basic video information (1505) are also used for the induction and/or inference of the second GAN and/or GNN prediction model (1509).

Referring to FIG. 15, the first image information and second basic image information are trained as a single model in the second induction and/or inference algorithm (1504), and second video information (1505) is generated for each cluster. The second attributes (1226) and second target attributes (1227) from the first video information (1503), based on the first basic video information (1501), and the first attributes (1224) and first target attributes (1225) from the second basic video information (1505) are labeled and trained as a single model.

In one embodiment of the present invention, the model that predicts video information as a result of correct motions is the first GNN regression model type 2 (1205) or the first association rule type 2 (1215).

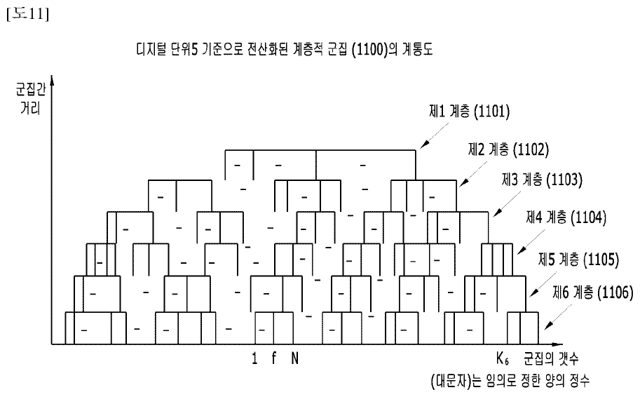

In various embodiments, ‘the first GNN regression model type 2 (1205)’ uses association rules. The video information (target attributes) is predicted using association rules. The video information (target attributes) includes the pattern of objects and physical attribute values in the static image information (attributes) as digital unit belonging to a specific cluster, as shown in FIGS. 8, 10, and 11.

In one embodiment of the present invention, the GNN regression model type 2 are divided into methods that use reverse association rules, methods that use forward association rules, and methods that use bidirectional association rules.

The second basic video information (1505) and the first video information (1503) are trained together in the same model (single model). The first video information (1503) is the labeled data of the first basic video information (1501).

In FIG. 15, from the perspective of the model, the first video information (1503), which is the prediction value of the first induction and/or inference algorithm, and the second basic video information (1505) may have different strengths and weaknesses in terms of accuracy and precision. Both are used as training data for the second induction and/or inference algorithm (1504).

The first labeled video information (1503) is labeled in a second labeling process, and this process continues to repeat. In this process, past labeled data (first video information, 1503) and new data (second basic video information, 1505) are repeatedly processed together. Previously learned data and/or similar label values continue to appear in each repeated learning cycle (epoch), necessitating a process of multiple experiments. Each epoch is divided into mini batch sizes according to the accumulated total number of label units (batch size) for training operations, and various experiments are conducted. During this process, the collective intelligence label values are selectively adopted and averaged into the model.

In FIG. 15, ‘the first induction and/or inference algorithm (1502), the second induction and/or inference algorithm (1504), . . . ’ refers to the induction and/or inference algorithm (1200) in FIG. 12, which represents the overall algorithm as the sum of partial algorithms.

In various embodiments, digital cadavers can be easily created and initialized through 3D printing simulations in virtual space, and their use is gamified through virtual surgery audition games to alleviate the constraints of virtual space. The surgical patterns collected through actual medical institutions and virtual surgery auditions are clustered and patterned to create an initial artificial intelligence model. The precision and success of surgeries are validated by extracting patterns from verified specialists and conducting supervised learning. Each surgery-specific medical artificial intelligence, initially modeled through the above method, independently performs virtual surgeries (e.g., procedures, treatments, etc.) on digital cadavers and artificial cadavers using VR simulators. Additionally, the process is gamified by rewarding doctors for labeling the virtual surgery information performed by the medical artificial intelligence. Medicalartificial intelligence surgery labeling is refined by having doctors either directly perform surgeries in virtual space or correct and improve surgeries conducted by trained artificial intelligence. This labeling behavior is gamified through rewards to reinforce it.

In one embodiment of the present invention, the sliding window operates as follows. Video information is classified by unit of window size. For example, if a total of 50-second videos are divided into five 10-second segments, and the input comes in the order A, B, Z, A, B, the next sequence (Z) is predicted using association rules.

In one embodiment of the present invention, well-known deep learning algorithms such as RNN, LSTM and so on can extend forward direction to both reverse and bidirectional through a modified algorithm called bidirectional LSTM, achieving additional performance improvements. The proposed digital unit can also be expanded in both reverse and bidirectional directions, similar to bidirectional algorithms. Unlike RNN and LSTM, the proposed digital unit combines complex input features. The video scene frames are clustered into characteristic patterns and can be grouped as motion A, motion B, motion C. All surgical motions and/or special motions of specific characters in the game can be re-associated into a sequence of patterns from learned motion clusters (A, B, C, . . . ). In one embodiment of the present invention, if a sequential association pattern such as A→B→D or A→B→F are frequently observed with a high degree of order association within the training data, that pattern is learned along with the sequence. Certain repetitive motions can be learned and reproduced as sequential association patterns of video clusters. Here, “reproduction” means that when part of an initial pattern is provided as input, the subsequent pattern can be inferred through association rules based on the cluster's motion patterns.

Various embodiments explain the association rules for reverse time-series sequences.

Using the first GNN regression model type 1, the output data (traces and results), which are still image information, is predicted. The second GNN regression model type 2 (1205) predicts the vector of the point cloud that caused the output data (traces and results), In reverse. By analyzing the result values, the vector of the point cloud within the GNN framework over time is identified and returned to the platform user. If there is a result value, a rule is found that there is a vector of the point cloud. If the first GNN regression model type 1 presents arbitrary predictions (result values) and/or still image information, the second GNN regression model type 2 returns the vector of the point cloud (cause) over time. To infer the association rules, a transaction set is built to return the dataset of result values and the vector of the point cloud (causes), identifying meaningful relationships between result values. Association rules consist of antecedent and consequent events, and they are included in the set of result and cause values, which are obtained through the association rule inference process. Since vectors are complex information, many association rules exist. Evaluation criteria for finding meaningful association rules are needed. Support, confidence, and lift are used as evaluation metrics. In the association rule algorithm, the respective sets of result and cause values refer to the cluster of still image information and the cluster of video information in digital unit 4 and digital unit 5.

Further explanation is provided on the time-series division selective labeling function mentioned earlier.

Even without hierarchical labeling, the server (200) returns to the user the division timestamps of the first and second image information (e.g., still image information, label values of still image information), and the user performs time-series division selective labeling or body-part-specific selective labeling on the returned values (division timestamps). When time-series division selective labeling or body-part-specific labeling is performed, digital unit 3, digital unit 4, or digital unit 5 is generated.

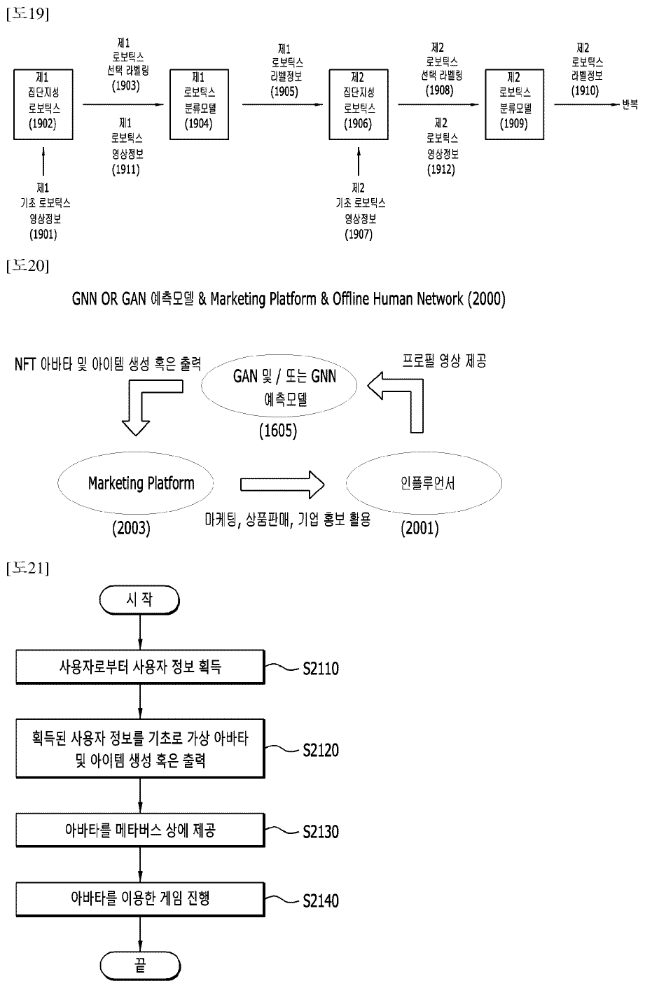

The image information refers to the first video information (1503) or the second video information (1506), and the second selective labeling (1208) or the third selective labeling information receiving step includes the time-series division selective labeling (1701) in FIG. 17. The image information is a repeated prediction value of the GAN and/or GNN prediction model (1605) and refers to ‘the first, second, third, . . . image information.’

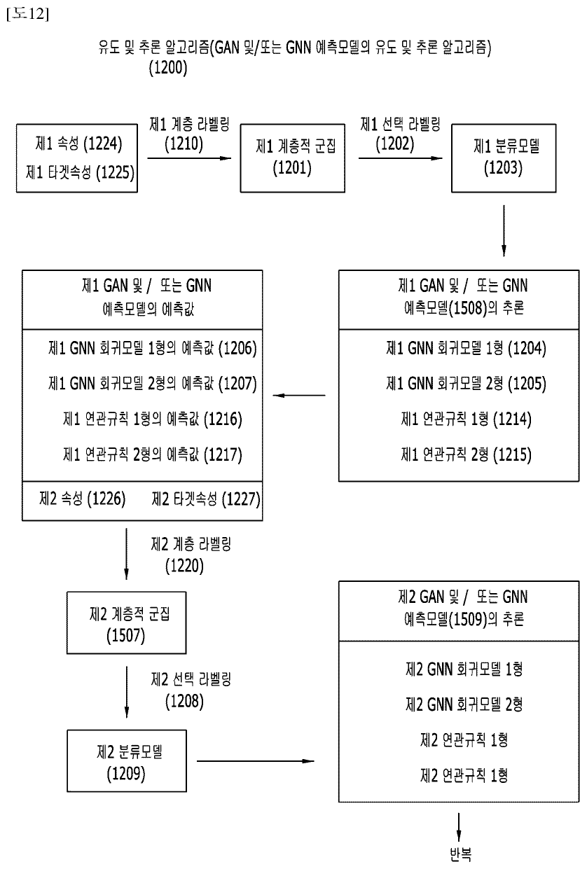

The second hierarchical labeling (1220) or third hierarchical labeling information, which includes time-series division selective labeling, is related to the hierarchical clusters in FIG. 8 or FIG. 10.

In the embodiment of the present invention, even when hierarchical clustering labeling is omitted, time-series division selective labeling (1701) may be included and executed within the second selective labeling (1208) or the third selective labeling, and it can also be executed before or after the second selective labeling (1208) or the third selective labeling.

The second hierarchical cluster (1507) or the third hierarchical cluster is processed (or computerized) based on digital unit 3 or digital unit 4 from FIG. 8 or FIG. 10.

FIG. 8 represents a hierarchical cluster (800) processed based on digital unit 3, and FIG. 10 represents a hierarchical cluster (1000) processed based on digital unit 4.

The method in which a user assigns an ACCEPT or REJECT label to the predicted values of ‘the first, second GNN regression model Type 1’ or ‘the first, second association rule Type 1’ or ‘the first, second GNN regression model Type 2’ or ‘the first, second association rule Type 2’ to selector reject the division timestamp (the still image information or the label value of the attribute) is defined as ‘time-series division selective labeling’ (1701) in FIG. 17.

After the user performs the time-series division selective labeling (1701) in FIG. 17 by referencing the label classification, the second classification model (1209) is induced and/or inferred.

When the artificial intelligence learns the divisional timestamp and returns it to the user, the user selects it using the ACCEPT or REJECT button. The classification model reclassifies the labeled information, and the ‘GNN regression model or association rule (including deep learning)’ returns the collectivized predicted values. The user repeatedly performs the time-series division selective labeling (1701) in FIG. 17. The user, referencing the label classification, inputs the label value through the app execution result screen (or view screen) of the terminal (100).

In one embodiment of the present invention, if the user presses the REJECT button in the time-series division selective labeling (1701), the user moves the marker (or arrow) on the timeline within the playback bar of the app execution result screen (or view screen) of the terminal (100) to capture the still image information at the point where the video is to be divided, and then directly inputs the label value for labeling according to the time-series division by pressing the ACCEPT button.

The digital unit 3 (1705) and digital unit 4 (1706) used in the induction and/or inference algorithm (1200) of FIG. 12 are the divided rectangular cuboid (301) of FIG. 3.

In digital unit 3 (1705), the attribute is the still image information (403) at the end of the k-th stage of a divided motion video of an avatar, human, or robot, and it is represented by the black square in FIG. 4.

Referring to FIG. 4, the still image information at the end of the n-th stage of the divided motion video is also an attribute, and it is the last black square in FIG. 4.

In digital unit 4 (1706), the attribute is the still image information (503) at the end of the L-th stage of a divided motion video of an avatar, human, or robot, and it is represented by the black square in FIG. 5.

Referring to FIG. 4 and FIG. 5, the still image information at the end of the (k, L)-th stage of the divided motion video is also an attribute, and it is the last black square in FIG. 4 and FIG. 5.

FIG. 8 and FIG. 10 represent K3 and K5 clusters based on digital unit 3 (1705) and digital unit 4 (1706).

In various embodiments, the still image information at the beginning of the video is also an attribute, and it becomes digital unit 3 or digital unit 4 when combined with the target attribute, which is the video information.

In one embodiment of the present invention, FIG. 8 or FIG. 10 illustrates a hierarchical clustering dendrogram created based on the label values assigned when the stages of the video are divided by the variable values input into the input field of FIG. 7 or the app execution result screen (or view screen) of the terminal (100).

The time-series division selective labeling (1701) in FIG. 17 divides the video with reference to ‘data unit 3 (1703) or data unit 4 (1704)’, and ‘digital unit 3 (1705) or digital unit 4 (1706)’.

In one embodiment of the present invention, digital unit 3 (1705) or digital unit 4 (1706) divides the video by simultaneously performing time-series division selective labeling (1701) in conjunction with data sorting. The user assigns an ACCEPT or REJECT label to the label values representing the order of the video or the sequence of videos to select or reject the order of the divided videos.

Digital unit 4 is the motion video information divided by time-series division selective labeling (1701), in which the user, referencing the label classification, divides the motions of an avatar, human, or robot into distinctive detailed motions lasting approximately 0.5 to 3 seconds. Digital unit 5 is capable of dividing the video into more detailed segments compared to digital unit 4.

Digital unit 3 is the motion video information divided by time-series division selective labeling (1701), in which the user, referencing the label classification, divides the motions of an avatar, human, or robot into distinctive motions lasting approximately 3 seconds to several tens of seconds.

The data unit described in this embodiment of the present invention refers to the unit of complex feature vectors created by the user, whereas the digital unit refers to the unit of complex feature vectors generated through the interaction between the user and artificial intelligence.

In one embodiment of the present invention, the label classification that divides the motions of an avatar, human, or robot into distinctive detailed motions lasting approximately 0.5 to 3 seconds corresponds to [Table 5] or [Table 10].

In one embodiment of the present invention, data unit 3 and digital unit 3 may be units of video information divided into durations of several seconds to several tens of seconds. When quantum cloud computing devices with over 3000 qubits become commercialized and computing power is significantly improved, data unit 3 and digital unit 3 will be used for the generation and output of video information.

Digital unit 3 (1705) is processed in the same manner as data unit 3 (1703), combining the attribute (still image information) and the target attribute (video information).

Digital unit 4 (1706) is processed in the same manner as data unit 4 (1704), combining the attribute (still image information) and the target attribute (video information).

In one embodiment of the present invention, multiple users (such as Air Force cadets and/or fighter pilots) control a virtual fighter jet using a VEHICLE VR simulator for approximately 1 minute, following scenes from the movie “Top Gun,” and perform labeling to obtain data sets for each data unit and digital unit used in the induction and/or inference algorithm of FIG. 12. Since each type of maneuver in fighter jet piloting has distinctive motions, when multiple users engage in similar virtual flights, the entire video is divided into short clips of about 1 to 2 seconds.

In one embodiment of the present invention, multiple users use a VR treadmill to fire a motorized controller weapon for about 1 minute while following a battle scene from the movie “Saving Private Ryan” and perform labeling. The movements of infantry or engineers in the movie (such as firing a rifle or throwing a grenade) can also be divided into short clips of about 1 to 2 seconds.

In one embodiment of the present invention, the time-series division method for digital unit 3 (1905) is as follows.

Referring to the label classifications such as those in [Table 1] through [Table 4], if the labeling of a dentist or doctor is performed and the induction and/or inference algorithm (1200) of FIG. 12 is further developed, the ‘GNN regression model’ returns the still image information along with the division timestamps and label values (s1, s2, s3, k) to the platform user (such as a doctor or dentist). The user then performs time-series division selective labeling (1701) based on the returned values.

In one embodiment of the present invention, [Table 12] explains the division of a 30-second video, which depicts the removal of the upper central incisor laminate for tooth 11, into 10 stages with intervals of approximately 2 to 4 seconds. The video can be divided into digital unit 4 using the user's time-series division selective labeling (1701).

TABLE 12

| | Method of Tooth Reduction for Maxillary Central | |
|---|---|---|
| Variable Value | Incisor Laminate Treatment | |
| (Label) | NUMBER 11 (Detailed Action Steps) | Information Type |
| 1 | Position a pre-made tooth reduction index in the mouth and | Videos, etc. |
| | on the tooth before the reduction | |
| 2 | The dentist visually checks the index placed on the tooth | Videos, etc. |
| | and measures the reduction amount | |
| 3 | The dentist decides the reduction amount based on their | Videos, etc. |
| | judgment and checks the depth gauge bur (bur for | |
| | indicating reduction depth on the tooth with a dental | |
| | handpiece) before attaching it to the handpiece | |
| 4 | Reduce one-third of the estimated cervical part depth using | Videos, etc. |
| | the depth gauge bur | |
| 5 | Reduce one-third of the estimated middle part depth using | Videos, etc. |
| | the depth gauge bur | |
| 6 | Reduce one-third of the estimated incisal part depth using | Videos, etc. |
| | the depth gauge bur | |
| 7 | Reduce one-third of the cervical part using the actual tooth | Videos, etc. |
| | reduction handpiece bur | |
| 8 | Reduce one-third of the middle part using the actual tooth | Videos, etc. |
| | reduction handpiece bur | |
| 9 | Reduce one-third of the incisal part using the actual tooth | Videos, etc. |
| | reduction handpiece bur | |
| 10 | Trim and finely adjust the entire maxillary central incisor | Videos, etc. |
| | using a trimming bur on the handpiece | |

Even if video information of various patients (avatars and digital cadavers) divided into 10 stages, as described above, belongs to the same specific cluster in FIG. 9, the precise sequence of surgeries and procedures within the videos may vary depending on the medical techniques of the operating physician. Different sequences can be preprocessed based on the label order in [Table 5] and applied to the classification model. Furthermore, for steps with different sequences, omitted parts, and/or additional parts, the video information is organized and clustered according to the label order in [Table 12].

If a dentist performs labeling by referencing the label classification in [Table 12], the dentist can perform time-series division selective labeling by assigning ACCEPT or REJECT labels to the division timestamps (still image information) based on the artificial intelligence's return. The classification model will reclassify the labeled information, and the ‘GNN regression model’ will return more collectivized division timestamps (still image information) and label values. The dentist then selects either the ACCEPT or REJECT button based on the artificial intelligence's return. In this manner, if the dentist performs labeling, the GNN regression model, which divides the video information and returns the still image information, will return the still image information. The induction and/or inference algorithm (1200) in FIG. 12 returns division timestamps (attribute values) and label values to the dentist The dentist assigns labels by pressing the ACCEPT or REJECT button based on the artificial intelligence's predicted values, selecting or rejecting the division timestamps (attributes or attribute label values). The classification model then reclassifies the labeled information, and the ‘GNN regression model Type 1’ returns even more collectivized division timestamps (still image information) and label values. Ultimately, a fully collectivized digital unit 4 (1706) is created.

Further explanation is provided regarding the function of the body-part-specific selective labeling described earlier.

The video information is either the first video information (1503) or the second video information (1506). The second selective labeling (1208) and the third selective labeling information reception steps include body-part-specific selective labeling (1702).

The video information, which is repeated predicted values of the GAN and/or GNN predictive model (1605), is ‘first, second, third, . . . video information’.

By performing body-part-specific selective labeling, the second hierarchical labeling (1220) or third hierarchical labeling information, which includes selective labeling information by body parts, becomes a hierarchical cluster.

In the embodiment of the present invention, even if hierarchical clustering labeling is omitted, body-part-specific selective labeling (1702) may be included in the second selective labeling (1208) and can also be executed before or after the second selective labeling (1208).

The second hierarchical cluster (1507) or the third hierarchical cluster is a computerized cluster based on digital unit 5.

Digital unit 5 (1707) is processed in the same manner as digital unit 4 (1706), combining the attribute (still image information) and the target attribute (video information).

Data unit 3 (1703), data unit 4 (1704), digital unit 3 (1705), or digital unit 4 (1706) is processed into ‘digital unit 5 (1707)’ by body-part-specific selective labeling (1702).

Body-part-specific selective labeling refers to assigning labels to body parts in order to determine the sequence of motions for the body parts of avatars, humans, or robots, thereby changing the order of motions in the actual video.

In one embodiment of the present invention, after performing ‘body-part-specific selective labeling’, the user can assign an ACCEPT or REJECT label to preprocessing tasks (such as deletion or addition) according to the sorting of video data to accept or reject them.

The user references the label classification and performs body-part-specific selective labeling (1702) on the first or second video (or video information) and then induces and/or infers the second and third classification models.

The user references the label classification and performs body-part-specific selective labeling (1702) on the first video information (1503) or the second video information (1506), leading to the division of the video into digital unit 5 (1707).

In digital unit 5 (1707), the attribute is the still image information at the end of the f-th stage of a divided motion video of an avatar, human, or robot, and it is represented by the black square in FIG. 6.

Referring to FIG. 6, the still image information at the end of the f-th stage of the divided motion video is also an attribute, and it is the last black square in FIG. 6.

FIG. 11 represents K6 clusters based on digital unit 5 (1707).

The digital unit 5 (1707) used in the induction and/or inference algorithm (1200) of FIG. 12 is the divided rectangular cuboid (301) of FIG. 3.

In various embodiments, the still image information at the beginning part is also an attribute, and it combines with the target attribute (video information) to become digital unit 5.

In one embodiment of the present invention, FIG. 11 represents a hierarchical clustering dendrogram created based on the label values assigned when the stages of the video are divided according to the variable values (label values) input into the input field of the app execution result screen (or view screen) of the terminal (100).

The motion videos of avatars, humans, or robots are divided into digital unit 5 through body-part-specific selective labeling (1702).’

In one embodiment of the present invention, even though most dentists use an index for tooth removal during laminate treatment of tooth 11, some dentists do not use an index, and others do not use a depth gauge bur. These differences are used for hierarchical clustering, and the video information is sorted and preprocessed accordingly. Additionally, some dentists may not follow the standard sequence (cervical, middle, incisal) during tooth removal, preferring their own sequence. In such cases, labeling is performed to designate the detailed order for body parts like the central, incisal, and cervical areas of the upper central incisor, creating a sequence for the divided videos and producing a label classification that matches the labeling sequence. In addition, the video information is then sorted according to the labeling sequence. Although included in the same specific cluster (in one embodiment of the present invention, a method of deleting tooth No. 11 without using an index), video and still image information, where the order of tooth deletion (the order of deleting the cervical area, middle area, and incisal area) is different, is preprocessed through labeling the order of body parts and sorting the video information. This reduces the error values of the classification model and improves the accuracy of the classification model.

In one embodiment of the present invention, if one dentist removes the tooth in the sequence of cervical, middle, and incisal, while another removes it in the order of middle, incisal, and cervical, the video information is sorted in the standard cervical, middle, incisal sequence and divided accordingly for clustering. Additionally, if the dentist uses a mouse pointer to indicate a specific body part or even just thinks about it, the artificial intelligence detects the boundaries and surfaces of that part through object recognition based on the user's input or thoughts. The artificial intelligence also returns sorted information about the treatment sequence to the user. The user can then judge whether the body part they thought of is correct or not, and/or whether the sequence they thought of is correct or not, and/or whether the label values for the sequence are correct or not. Using only this brain-computer interface, the user can attach ACCEPT or REJECT labels to the video or still image and sort them accordingly. This labeling process is repeated and applied to the induction and/or inference algorithm (1200) of FIG. 12.

In one embodiment of the present invention, [Table 6] explains that the mouth of a healthy adult typically contains around 28 teeth, each assigned a tooth number. The upper right central incisor is numbered 11. In the case of performing a procedure to remove four teeth (tooth numbers 22, 21, 11, 12) for laminate treatment, since not all dentists follow a fixed order of tooth numbers when performing tooth removal for laminates, the above video information is sorted in a certain order (tooth number) and preprocessing is also performed on the video information that has been removed or added.

When performing time-series division labeling, more accurate clustering can be achieved by simultaneously proceeding with hierarchical clustering and sorting (tooth number order) based on the specific procedure order of body parts (tooth number order). If more detailed body-part-specific selective labeling (1702) is required, the method and sequence for laminate treatment and tooth removal of the upper central incisor (tooth 11) may vary depending on the dentist. Therefore, the video information is sorted based on a specific label classification, and any added or omitted video information is preprocessed.

In one embodiment of the present invention, if a video into digital units with small data sizes of less than 0.5 seconds from a metaverse soccer game needs to be obtained, body-part-specific selective labeling (1702) and sorting can be used to subdivide and divide the video. For example, when Son Heung-min performs an instep dribble with three long steps, the soccer ball touches his foot in a predefined sequence of toe touch, first step running, ankle touch, second step running. However, a specific user replicating this movement may perform the touches and runs in the order of ankle touch, first step running, toe touch, second step running. In this case, body-part-specific selective labeling (1702) is performed using a brain-computer interface to assign labels for the touch and running sequence of the user's dribble.

In one embodiment of the present invention, if Jennie's k-th motion from the Jul. 8, 2022, broadcast of Open Concert is described as a front-and-back wave in [Table 10], then in [Table 11], Jennie's front-and-back wave motion consists of raising her left arm, raising her right arm, moving her chest, moving her abdomen, moving her hips, and moving her legs. If a specific user performed the front-and-back wave in the sequence of moving his legs, moving his hips, moving his abdomen, moving his chest, raising his right arm, and raising his left arm, body-part-specific selective labeling (1902) is performed using a brain-computer interface. The specific user's movements are then sorted in the same order as Jennie's. The 3-minute 14-second video can also be divided into approximately 200 short clips of 1 to 2 seconds each. Dance motions are continuous combinations of movements of the head, hands, feet, and torso. Body-part-specific selective labeling (1702) may be omitted, and time-series division selective labeling (1701) can be performed instead.

Additionally, the server (200) can repeatedly perform the processes of selective labeling, classification model inference, prediction model inference, additional selective labeling on the generated first video, additional classification model inference, and additional prediction model inference, all related to a specific topic, for the raw data provided from multiple terminals (100). This process generates (or updates) a collectivized second video related to the specific topic (or related to the comparison target video for the specific topic).

The server (200) can provide the most recently updated (or newly generated) second video to multiple terminals (100) that provided the raw data on the specific topic, either in real-time or upon request from a specific terminal (100).

Thus, all terminals (100) or a specific terminal (100) that provided raw data on the specific topic to the server (200) can receive the latest collectivized second video related to the specific topic.

‘The first, second, third . . . video information’ repeatedly generated by the GAN and/or GNN predictive model (1605) is trained continuously with the base video information (1601) using a single model. Hierarchical labeling and selective labeling (1604) are repeatedly executed. The classification model is repeatedly inferred, and the GAN and/or GNN predictive model (1605) is repeatedly induced and/or inferred.

In one embodiment of the present invention, time-series division selective labeling (1701) and/or body-part-specific selective labeling (1702) are executed repeatedly.

Furthermore, the server (200), in conjunction with the terminal (100), collects motion-related videos of such as real human (or real person), virtual avatars, or items (or motion-related videos related to at least one of a human, avatar, or item), the meta information related to the motion-related video, which are related to a specific topic and output (or managed) on the terminal (100). The specific topic (or specific content) may include medical practices (e.g., procedures, surgeries, etc.), dance, sports activities (e.g., soccer, basketball, table tennis, etc.), games, and e-sports, and so on. In addition, the motion-related videos (or base video information/raw data) related to the human may be videos obtained(or filmed) of real humans (or person/influencers) performing motions (or movements/activities) related to the specific topic. Moreover, the motion-related videos of avatars and/or items may be videos generated from arbitrary raw data related to the specific topic through processes such as selective labeling, classification model inference, and prediction model inference.

In one embodiment of the present invention, the visual data (1801) of avatars, items, and human motions in FIG. 18 includes visual data of vehicle motions controlled by an avatar or human. This visual data (1801) represents the raw data of the real-world user's (or human's) motions.

Additionally, the server (200) reconstructs the collected motion-related videos (or the motion-related videos of the collected real humans, virtual avatars, items and so on) into robotic motion videos in order to implement these collected motion-related videos into an actual robot motion. The robot may include a robotic arm designed to operate in a tooth removal VR simulator using visual data from the tooth removal VR simulator, a robotic arm designed to operate in a surgery VR simulator using visual data from the surgery VR simulator, a vehicle-shaped robot using visual data from a VEHICLE VR simulator, or a humanoid robot designed to operate on a VR treadmill.

That is, the server (200) converts, based on the collected motion-related videos and the meta information related to the motion-related videos, the coordinate information related to real humans, virtual avatars, or items in the motion-related videos into robot coordinate information to apply this motion to an actual robot. The motion-related video is then reconstructed as a robotic motion video.

Additionally, the server (200) transmits the robot motion video (or the reconstructed robot motion video), the meta information related to the robot motion video, the collected motion-related videos, the meta information related to the motion-related videos, the comparison target video searched in relation to the collected motion-related video (or robot motion video) among the multiple comparison target videos managed by the server (200), the meta information related to the comparison target video, and so on, to a selected specific terminal (100) from among multiple terminals (100) previously registered with the server (200).

The specific terminal (100) receives the robot motion video sent by the server (200), the meta information related to the robot motion video, the motion-related video, the meta information for the motion-related video, the comparison target video corresponding to the motion-related video (or robot motion video), and the meta information for the comparison target video.

By connecting with the terminal (100) and precisely measuring the spatial and temporal coordinates of the robot's motions, the robot's motions is evaluated through the display device (1808) and user interface (1809) of the app execution result screen (or view screen) of the terminal (100). The user then performs robotics selective labeling (1810), which enhances the process into a collective intelligence model (1806) operating on the server (200) to infer robotics programming, defined as “Collective Intelligence Robotics (1803).” Before performing the first robotic selective labeling, the user executes basic selective labeling (initial selective labeling) on the base robotics video information, which leads to the inference and/or induction of the first collective intelligence robotics (1803). Hierarchical labeling and/or selective labeling on the base robotics video information can be performed in the same manner as described in FIG. 12.

In one embodiment of the present invention, the visual data output on the app execution result screen (or view screen) of the terminal (100) is the motion screen of a robot in virtual reality, augmented reality, mixed reality, or extended reality, provided by the terminal (100).

The robotics video information (1813) corresponds to the attribute and target attribute of FIGS. 3 to 6 and is the visual data generated by the collective intelligence robotics (1803).

The first collective intelligence robotics (1902) is programmed by inputting the first basic robotics video information (1901), which generates the first robotics video information (1911).

The basic robotics video information (1802) in FIG. 18 is reconstructed as robot motion video (video information) by the server (200), synchronizing the motion data (1801) of avatars, humans, and robots collected from the terminal (100) with the virtual environment's coordinates in order to ensure that the behavioral information and location data of metaverse users are aligned with the coordinates of the virtual environment. The visual data (1801) of avatar motions obtained from the terminal (100) represents the prediction values of the GAN and/or GNN predictive model (1605) from FIG. 16, as well as the ‘the first, second, third . . . video information’ in FIG. 15, and the prediction values of the GAN and/or GNN predictive model (1605) that are repeated throughout the metaverse world. Alternatively, the visual data (1801) of human (or user) movements represents the raw data of the user's motions in the real world. This human motions visual data (1801) is reconstructed as robot motion data (video information) by the server (200), and the reconstructed robot motion video information from the human motions visual data is included in the basic robotics video information (1802).

In one embodiment of the present invention, the visual data output on the app execution result screen (or view screen) of the terminal (100) is the motion screen of the robot (1807) provided by the terminal (100) and may be in virtual reality, augmented reality, extended reality, or mixed reality.

To reduce the discrepancy between the coordinate system in the user interface (1809) of the terminal (100) and the coordinate system in the robot's motions, the robot's size-based real distance coordinate system is estimated, and the angles of the robot's joints are extracted and controlled.

In the embodiment of the present invention, a robot in the form of a robotic arm, humanoid, or vehicle is created using the visual data from the tooth removal VR simulator, surgery VR simulator, VEHICLE VR simulator, and VR treadmill.

Referring to FIG. 18, the basic robotics video information (1802) is input into the collective intelligence robotics (1803). The GAN and/or GNN robotics predictive model included in the collective intelligence robotics (1803) involves an interface API process, and the predictive model outputs the robotics video information (1813) on the app execution result screen (or view screen) of the terminal (100). The GAN and/or GNN robotics predictive model is a model for visual data related to robotic movements, functioning in the same way as the GAN and/or GNN predictive model (1605). The robotics video information (1813) is the ‘the first, second, third, . . . robotics video information’ which is repeatedly output and/or generated by the GAN and/or GNN robotics predictive model. Repeated robotics selective labeling (1810) is performed on this video information.

The visual data output by the collective intelligence robotics (1803) is sent to the robot simulation engine (1804), which operates the robot through API communication (1805), activates the robot (1806), and sends it through the graphics engine (1807) to be displayed via the display device (1808) and user interface (1809).

In one embodiment of the present invention, the robotics programming on the server (200) proceeds as follows. ROS (Robot Operating System), OpenCV (Open Source Computer Vision) and PCL (Point Cloud Library) are used. Vision sensors are interfaced with ROS and the system is programmed using libraries such as OpenCV and PCL.

In one embodiment of the present invention, in the metaverse hospital and dental hospital games, the terminal (100) creates a 3D model of the patient's lesion, aligning the 3D patient coordinate system with the coordinates of the patient on the operating table based on the lesion's location, condition, and video information.

Thus, according to the present invention, in a hospital game, a service can be provided to dentist users that allows them to apply and generated various combinations of items such as medical devices, equipment, and materials on the face and body of the digital cadaver (avatar of the patient), and/or to output the result.

In one embodiment of the present invention, if sufficient visual data on virtual surgeries and tooth removal procedures is obtained through VR simulators operated by doctors and/or dentists, it becomes possible to create artificial intelligence surgery and procedure robots capable of performing automated surgeries and procedures using robotics programming in the VR simulators. When utilizing clusters collected from the ‘data of real medical institutions and virtual tooth simulators and virtual surgery simulators,’ the initial model of an artificial intelligence capable of automated surgery and procedures is created using a sequential model that repeats the association rules and predictions. Robotics selective labeling (1810) is used to enhance the artificial intelligence. The artificial intelligence performs virtual surgeries and procedures, while doctors perform labeling to apply the induction and/or inference algorithm (1200) of FIG. 12 and further enhance the artificial intelligence.

The first robotics video information (1911) in FIG. 19 corresponds to the second attribute and second target attribute of FIGS. 4 to 6. The basic robotics video information (1802) is data belonging to a specific cluster, which is one of the clusters shown in FIGS. 7 to 11. The ‘robotics video information (1813)’ also belongs to the same specific cluster.

Furthermore, the server (200) performs selective labeling on the robot motion video. In this context, selective labeling refers to a labeling method that sets (or assigns) a label (or label value) regarding the presence of errors (or abnormalities) at specific timestamps (or time intervals) within the robot motion video. Any moments (or intervals) in the robot motion video that are not assigned a label (or label value) during the selective labeling process may be assigned a default label value (e.g., an approval label).

In other words, the server (200), in conjunction with the terminal (100), allows the user to assign (or receive/input) labels (or label values) for specific timestamps (or time intervals) of the robot motion video displayed on the terminal (100) based on the user's input (or selection/touch/control).

Additionally, the server (200) receives one or more selective label values for one or more specific timestamps (or specific time intervals) in the robot motion video, the meta information related to the robot motion video, and the identification information of the terminal (100) from which the robot motion video was transmitted.

In the embodiment of the present invention, although it primarily describes setting (or receiving/inputting) one or more selective label values for one or more specific timestamps (or time intervals) within the robot motion video based on user input from the terminal (100), it is not limited to this. The server (200) can perform video analysis on the robot motion video and comparison target videos related to the robot motion video. Based on the results of the video analysis, the server (200) can automatically set one or more selective label values for one or more specific timestamps (or time intervals) in the robot motion video.

Additionally, when the server (200) sets one or more selective label values for one or more specific timestamps (or time intervals) in the robot motion video, the server (200) provides information about the selective label values for the one or more specific timestamps (or time intervals) to the terminal (100). The terminal (100) displays the information about the selective label values set by the server (200) for the one or more specific timestamps (or time intervals) in the robot motion video, and based on the user input of the terminal (100), the final approval of the selective label values for the one or more specific timestamps (or time intervals) can be determined.

At this time, before or after performing selective labeling on the robot motion video, the server (200), in conjunction with the terminal (100), can perform hierarchical labeling on the robot motion video. Selective labeling may be conducted before or after the hierarchical labeling is performed on the robot motion video. Here, hierarchical labeling refers to user-input feature engineering, where labels indicating characteristics of the robot motion video are assigned, and the robot motion video is divided (or classified) into multiple sub-robot motion videos based on these characteristics.

In other words, the server (200), in conjunction with the terminal (100), refers to (or relies on) multiple preset label classifications related to the specific topic for the robot motion video displayed on the terminal (100). Based on the user input (or selection/touch/control) from the terminal (100), it sets (or receives/inputs) labels (or label values) for different specific timestamps (or time intervals) in the robot motion video.

Additionally, the server (200) divides the robot motion video into multiple sub-robot motion videos.

In the embodiment of the present invention, although it primarily describes setting (or receiving/inputting) one or more hierarchical label values for one or more different specific timestamps (or time intervals) in the robot motion video based on user input from the terminal (100), it is not limited to this. The server (200) can perform video analysis on the robot motion video and comparison target videos related to the robot motion video. Based on the results of the video analysis, the server (200) can automatically set one or more hierarchical label values for one or more different specific timestamps (or time intervals) in the robot motion video.

Additionally, if the server (200) sets one or more hierarchical label values for one or more different specific timestamps (or time intervals) in the robot motion video, the server (200) provides information about the hierarchical label values for the one or more different specific timestamps (or time intervals) to the terminal (100). The terminal (100) displays the information about the hierarchical label values set by the server (200) for the one or more different specific timestamps (or time intervals) in the robot motion video, and based on the user input of the terminal (100), the final approval of the hierarchical label values for the one or more different specific timestamps (or time intervals) can be determined.

The video information, which is the first robotics video information (1911), receives the first robotics selective labeling (1903) information.

The induction and/or inference method of the first robotics classification model (1904) is the same as the method of the second classification model in FIG. 12.

First robotics selective labeling (1903) is performed on the first robotics video information (1911), which is the output of the first collective intelligence robotics (1902). The classification model created by classifying the visual data obtained from the first robotics selective labeling (1903) is defined as the ‘first robotics classification model (1904).’ The robotics classification model (1904) is repeated. Robotics selective labeling (1910) is performed in the same manner as selective labeling (1604) in FIG. 16.

In the embodiment of the present invention, the user performs robotics selective labeling (1810) on the robot's movements displayed on the user interface (1809) of the app execution result screen (or view screen) of the terminal (100) as shown in FIG. 18. The robot's movements are the robotics video information (1813).

The initial model of the robot in ‘collective intelligence robotics (1803)’ may have many errors. For somewhat inaccurate robot (1809) motinos, the robotics developer performs supervised learning through robotics selective labeling (1810) and classification. By providing the avatars, items, spatial environments, and narratives generated and displayed in the virtual simulation to collective intelligence robotics (1803), the user performs robotics selective labeling (1810) to conduct supervised learning for the artificial intelligence. The induction and/or inference algorithm (1200) of FIG. 12 enhances collective intelligence robotics (1803).

Additionally, based on the information about the selectively labeled robot motion video, the server (200) performs artificial intelligence-based machine learning and generates (or verifies) classification values for the robot motion video based on the machine learning results. Here, the classification value for the robot motion video (or classification value for the robot motion video/classification value for selectively labeled robot motion video/classification value for hierarchically labeled robot motion video) may be a value classified by the same category, such as selective labeling values, hierarchical labeling values and so on.

That is, the server (200) uses the information about the selectively labeled robot motion video as input for a pre-configured classification model to perform machine learning (or artificial intelligence/deep learning), and based on the machine learning results (or artificial intelligence results/deep learning results), it generates (or verifies) classification values for the robot motion video.

The video information displayed on the user interface (1809) in FIG. 18 is labeled through robotics selective labeling (1810) and classified through the robotics classification model (1811). The classified visual data is the labeled robotics label information (1812) delivered to collective intelligence robotics (1803).

In the embodiment of the present invention, robotics selective labeling (1810) includes hierarchical labeling, time-series division selective labeling (1701), and selective labeling by body parts (1702), similar to the video processing methods in the metaverse.

The information classified by the first robotics classification model (1904) is the first robotics label information (1905).

In one embodiment of the present invention, when multiple users, who are experts in various fields of virtual simulation games, perform robotics selective labeling (1810) through the terminal's (100) interface (1809) and sufficient visual data is acquired, an artificial intelligence robot capable of operating a VR simulator is created. When the initial model of collective intelligence robotics (1803), which manipulates the VR simulator using robot joints, arms, and legs, is developed, the ability of the collective intelligence robotics (1803) model is enhanced through supervised learning from user labeling. Once enhanced, the initial model of collective intelligence robotics (1803) that can operate in the real world may be developed. Even in this case, the collective intelligence robotics (1803) is further enhanced through supervised learning from robotics selective labeling (1810) by users and experts. The collective intelligence robotics (1803) of FIGS. 18 and 19 is enhanced by repeatedly applying the induction and/or inference algorithm (1200) of FIG. 12 and repeated labeling. As collective intelligence robotics (1803) is enhanced, an initial artificial intelligence model capable of automated procedures and surgeries using robotic arms may be developed in real medical environments. In this case, the artificial intelligence's automated capabilities in the initial model are further enhanced through supervised learning from robotics selective labeling (1810) by doctors.

In one embodiment of the present invention, the collective intelligence algorithm, which is evaluated and refined by users (doctors), enhances artificial intelligence reasoning to the level of performing automated surgeries in virtual surgery simulations and virtual tooth removal simulations without errors or mistakes. When an initial artificial intelligence model capable of performing automated procedures and surgeries on the VR simulator using robotic arms is developed, the artificial intelligence model's automated capabilities are enhanced through supervised learning from robotics selective labeling (1810) by doctors. Once enhanced, an initial artificial intelligence model capable of automated procedures and surgeries in real medical environments using robotic arms can be developed. Even in this case, the artificial intelligence's automated capabilities in the initial model are further enhanced through supervised learning from robotics selective labeling (1810) by doctors.

In one embodiment of the present invention, a humanoid robot is created using robot heads, robot arms, robot legs, robot bodies, and robot joints, along with autonomous vehicles, drones, airplanes, and artificial intelligence dental robot and artificial intelligence doctor robot.

Additionally, the server (200) performs machine learning (or artificial intelligence/deep learning) based on the classification value of the generated robot motion video (or classification value of the robot motion video), the information about the selectively labeled robot motion video, the robot motion video, the meta information related to the robot motion video, the comparison target video, and the meta information related to the comparison target video. Based on the machine learning results (or artificial intelligence results/deep learning results), the server generates the first robotics video corresponding to the robot motion video. At this time, the first robotics video may be an motion-related video of an avatar, item, or robot generated based on the robot motion video or an updated version of the robot motion video.

That is, the server (200) performs machine learning (or artificial intelligence/deep learning) based on the classification value of the generated robot motion video (or classification value of the robot motion video), the information about the selectively labeled robot motion video, the robot motion video, the meta information related to the robot motion video, the comparison target video, and the meta information related to the comparison target video as input to a pre-configured predictive model. Based on the machine learning results (or artificial intelligence results/deep learning results), the server generates the first robotics video related to the robot motion video.

Additionally, the server (200) transmits (or provides) the generated first robotics video to the terminal (100).

The second robotics video information (1912) is the predicted video from the second collective intelligence robotics (1906) and is defined as the prediction value of an enhanced predictive model from the repeated application of the induction and/or inference algorithm (1200).

The second robotics video information (1912) corresponds to the third attribute and third target attribute in FIGS. 4 to 6.

The first robotics label information (1905), classified by the first robotics classification model (1904), is input into the second collective intelligence robotics (1906). The second base robotics video information (1907) is also input into the second collective intelligence robotics (1906), where it is programmed as a single model and generates the second robotics video information (1912).

Additionally, the server (200) performs additional selective labeling on the first robotics video. Here, the additional selective labeling refers to a labeling method that sets (or assigns) a label (or label value) regarding the presence of errors (or abnormalities) at specific timestamps (or specific time intervals) within the first robotics video. Any timestamps (or time intervals) in the first robotics video that are not assigned a label (or label value) during the additional selective labeling process may be assigned a default label value (e.g., an approval label).

In other words, the server (200), in conjunction with the terminal (100), allows the user to set (or receive/input) labels (or label values) for different specific timestamps (or specific time intervals) within the first robotics video displayed on the terminal (100), based on user input (or selection/touch/control) from the terminal (100).

Additionally, the server (200) receives one or more additional selective label values for one or more other specific timestamps (or specific time intervals) in the first robotics video transmitted from the terminal (100), one or more time-series division selective label values, one or more body-part selective label values, label values for sorting the order of the sub-robotics videos, and the identification information of the terminal (100).

In the embodiment of the present invention, although it primarily describes setting (or receiving/inputting) one or more additional selective label values for one or more other specific timestamps (or specific time intervals) within the first robotics video based on user input from the terminal (100), it is not limited to this. The server (200) can perform video analysis on the first robotics video and comparison target videos related to the first robotics video. Based on the results of the video analysis, the server (200) can automatically set one or more additional selective label values for one or more other specific timestamps (or specific time intervals) within the first robotics video.

Additionally, if the server (200) sets one or more additional selective label values for one or more other specific timestamps (or specific time intervals) in the first robotics video, the server (200) provides information about the additional selective label values for the one or more other specific timestamps (or specific time intervals) to the terminal (100). The terminal (100) displays the information about the additional selective label values set by the server (200) for the one or more other specific timestamps (or specific time intervals) in the first robotics video, and based on the user input of the terminal (100), the final approval of the additional selective label values for the one or more other specific timestamps (or specific time intervals) can be determined.

At this time, before or after performing additional selective labeling on the first robotics video, the server (200), in conjunction with the terminal (100), can perform additional hierarchical labeling on the first robotics video. Additional selective labeling may be conducted before or after the additional hierarchical labeling is performed on the first robotics video. Here, additional hierarchical labeling refers to user-input feature engineering, where labels indicating characteristics of the first robotics video are assigned, and the first robotics video is divided (or classified) into multiple sub-robotics videos based on these characteristics.

That is, the server (200), in conjunction with the terminal (100), refers to (or relies on) multiple preset label classifications related to the specific topic displayed on the terminal (100). Based on the user input (or selection/touch/control) from the terminal (100), it sets (or receives/inputs) additional labels (or additional label values) for other specific timestamps (or specific time intervals) in the first robotics video.

Additionally, the server (200) divides the first robotics video into multiple sub-robotics videos.

In the embodiment of the present invention, although it primarily describes setting (or receiving/inputting) one or more additional hierarchical labels (or additional hierarchical label values) for one or more other specific timestamps (or specific time intervals) in the first robotics video based on user input from the terminal (100), it is not limited to this. The server (200) can perform video analysis on the first robotics video and comparison target videos related to the first robotics video. Based on the results of the video analysis, the server (200) can automatically set one or more additional hierarchical label values for one or more other specific timestamps (or specific time intervals) in the first robotics video.

Additionally, if the server (200) sets one or more additional hierarchical label values for one or more other specific timestamps (or specific time intervals) in the first robotics video, the server (200) provides information about the additional hierarchical label values for the one or more other specific timestamps (or specific time intervals) to the terminal (100). The terminal (100) displays the information about the additional hierarchical label values set by the server (200) for the one or more other specific timestamps (or time intervals) in the first robotics video, and based on the user input of the terminal (100), the final approval of the additional hierarchical label values for the one or more other specific timestamps (or time intervals) can be determined.

The second robotics video information (1912) is the predicted video from the second collective intelligence robotics (1906) and is defined as the prediction value of an enhanced predictive model from the repeated application of the induction and/or inference algorithm (1200).

The second robotics video information (1912) corresponds to the second attribute (1226) and second target attribute (1227) in FIGS. 4 to 6.

Additionally, the server (200) performs another artificial intelligence-based machine learning on the additional selectively labeled first robotics video and generates (or verifies) classification values for the first robotics video based on the results of the other machine learning. Here, the classification value for the first robotics video (or classification value for the first robotics video) may be a value classified by the same category, such as additional selective labeling values and additional hierarchical labeling values.

That is, the server (200) uses the information about the additional selectively labeled first robotics video as input for the pre-configured classification model to perform other machine learning (or other artificial intelligence/other deep learning), and based on the results of the other machine learning (or other artificial intelligence results/other deep learning results), it generates (or verifies) classification values for the first robotics video.

The second robotics video information (1912) is labeled using the second robotics selective labeling (1908) method by the user, and the second robotics classification model (1909) is induced and/or inferred based on the labeled data. The classified second robotics label information (1910) is input into the third collective intelligence robotics, and this process is repeated.

The first robotics label information (1905) and the second base robotics video information (1907) are trained in a single model of the second collective intelligence robotics (1906). The first collective intelligence robotics (1902) is programmed based on the input of the first basic robotics video information (1901), and the second collective intelligence robotics (1906) is programmed based on the input of the second base robotics video information (1907) and the first robotics label information (1905). This process continues in a repeated cycle.

Additionally, the server (200) performs another machine learning (or artificial intelligence/deep learning) using the classification value of the generated first robotics video (or the classification value of the first robotics video), the information about the additional selectively labeled first robotics video, the first robotics video, the meta information related to the first robotics video, the comparison target video, and the meta information related to the comparison target video as input. Based on the results of this machine learning (or artificial intelligence/deep learning), the server generates the second robotics video corresponding to the first robotics video. The second robotics video may be an motion-related video of an avatar, item, or robot generated based on the first robotics video, or it could be an updated version of the first robotics video.

That is, the server (200) performs another machine learning (or artificial intelligence/deep learning) based on the classification value of the generated first robotics video (or the classification value of the first robotics video), the information about the additional selectively labeled first robotics video, the first robotics video, the meta information related to the first robotics video, the comparison target video, and the meta information related to the comparison target video as input into the pre-configured predictive model. Based on the results of this machine learning (or artificial intelligence/deep learning), the server generates the second robotics video related to the first robotics video.

Additionally, the server (200) transmits (or provides) the generated second robotics video to the terminal (100).

Referring to FIG. 19, from a model perspective, there may be differences in accuracy or precision between the second base robotics video information (1907), which is output and/or generated data from the metaverse in a model perspective, and the first robotics label information (1905), which is output and/or generated data from the first collective intelligence robotics (1902). While both processes represent different forms of labeling, in order to ensure that the model benefits from both, the modified second base robotics video information (1907) and the first robotics label information (1905) are used as training data for the same model (single model) rather than separate models. After the first robotics selective labeling (1903) and the first robotics classification model (1904) have been applied for the initial labeling, the proposed output and/or generated data, i.e., the first robotics label information (1905), is re-labeled using the second robotics selective labeling (1908), and this process continues to be repeated. The previously labeled data (the first robotics label information, 1905) is continuously processed together with other labeled data (the second base robotics video information, 1907) in repeated cycles, and the data previously trained and/or similar label values continue to appear during each epoch, requiring several experimental iterations. Each epoch divides the total number of accumulated unit labels (batch size) into learning computation units (mini-batch size) for various experiments, and during this process, the collective intelligence label values are selectively integrated and averaged, which is reflected in the model.

The robotics selective labeling (1810) in collective intelligence robotics (1803) is performed in the same manner as the selective labeling (1604) for avatars, humans, robots and so on.

In one embodiment of the present invention, for robots performing automated surgeries and dental procedures, where the range of motion and combinations is limited, hierarchical clustering is not required. Instead, robotics selective labeling (1810) is used to precisely label each correct and incorrect part of the video information. For humanoid robots or vehicle robots (such as dancing robots, soccer-playing robots, and bipedal robots) with a higher degree of freedom and/or inference, hierarchical clustering is performed through time-series division selective labeling (1701) and body-part-specific selective labeling (1702) as described in FIG. 17. The robotics video information is divided into digital unit 3 (1705), digital unit 4 (1706), and/or digital unit 5 (1707), and then robotics selective labeling (1810) is performed.

Additionally, the server (200) performs repeated processes of selective labeling, classification model inference, prediction model inference, additional selective labeling on the generated first robotics video, additional classification model inference, and additional prediction model inference (for example, steps S2910 through S2980), for motion-related videos of multiple real humans, virtual avatars, or items collected from multiple terminals (100), related to the specific topic. This process generates (or updates) a collectivized second robotics video related to the specific topic.

At this time, the server (200) can provide the most recently updated (or newly generated) second robotics video to multiple terminals (100) that have provided motion-related videos of real humans, virtual avatars, or items related to the specific topic, either in real-time or upon request from a specific terminal (100).

Accordingly, all terminals (100) or specific terminals (100) that provided motion-related videos of real humans, virtual avatars, or items related to the specific topic to the server (200) can receive the latest collective intelligence-based second robotics video related to the specific topic (or comparison target video related to the specific topic).

The ‘the first, second, third . . . robotics video information’ (1813), repeatedly output and/or generated by the GAN and/or GNN robotics predictive model, is continuously trained with the basic robotics video information (1802) using a single model. Robotics selective labeling (1810) is repeatedly executed. The robotics classification model (1811) is repeatedly induced and/or inferred, and the GAN and/or GNN robotics predictive model is repeatedly induced and/or inferred. The GAN and/or GNN robotics predictive model is included in the collective intelligence robotics (1803).

In one embodiment of the present invention, hierarchical labeling, time-series division selective labeling (1701), and body-part-specific selective labeling (1702), which are the same methods used in processing avatar motion information, are repeatedly executed.

Additionally, the server (200), in conjunction with a blockchain server (undisclosed), issues (or grants) non-fungible tokens (NFTs) for the first video, the second video, the first robotics video, the second robotics video, and other such content generated based on the raw data provided from the terminal (100), the motion-related videos of avatars and/or items.

The NFT (or NFT content) issued by the server (200) may be associated with any digital artwork owned by the owner of the raw data, avatar, and/or item motion-related videos. The digital artwork (such as the first video, the second video, the first robotics video, the second robotics video, etc.) corresponds to the generated content (or MR content/immersive content). The address pointing to the digital file within the original digital asset and a unique identifier (such as asset information, author information, owner information, etc.) may be embedded in the token.

Additionally, the server (200) configures the display of the issued NFT alongside markers on the screen of the terminal (100), where the first video, second video, first robotics video, second robotics video, etc., are displayed.

Moreover, when the marker displayed alongside the first video, second video, first robotics video, second robotics video, etc., is selected by user touch on the terminal (100), the server (200) verifies the NFT corresponding to the selected marker. The information about the verified NFT (such as asset information, author information, owner information, etc.) may be displayed on one side of the terminal's (100) screen (or as a popup on the screen where the first video, second video, first robotics video, second robotics video, etc., are displayed). At this time, the terminal (100) may display the information about the verified NFT in virtual reality, augmented reality, mixed reality, extended reality, or similar formats.

Additionally, the server (200) provides transaction functions (or sale functions/ownership transfer functions) related to the issued NFTs of the first video, second video, first robotics video, second robotics video, etc.

In other words, the video information (such as the first video, second video, first robotics video, second robotics video, etc.) is video information assigned with an NFT, and the platform system for providing video information with assigned NFTs operates as a flywheel structure where users, participants, and companies can generate profits, earn money, and enhance entertainment elements simultaneously.

Referring to FIG. 20, the platform system for providing virtual avatar generation and/or output using GAN and/or GNN operates as a flywheel structure where users (individuals), participants (influencers (2001) or people promoting their characters on social media), and company (advertisers and/or manufacturers) can generate profits, earn money, and enhance entertainment elements simultaneously.

The video information with NFTs assigned is the ‘the first, second, third . . . video information’ that is repeatedly output and generated by the GAN and/or GNN predictive model (1605).

Referring to FIG. 20, the GNN and/or GAN predictive model (1605) operates on the server (200) from FIG. 1. The GNN and/or GAN predictive model (1605) utilizes the base video information (first basic video information 1501 and second base video information 1505 from FIG. 15) provided by users and influencers (2001) to generate or output NFT avatars and items on the marketing platform (2003). Companies and investors can own profile NFTs and product NFTs of influencers (2001) and use them for marketing and/or corporate promotions. The profile (e.g., videos, photos, etc.) represents the generated avatar, and the products represent items.

In one embodiment of the present invention, deepfakes of users and influencers (2001) are used to advertise on the marketing platform (2003) and are automatically registered in domestic and international NFT markets through programming.

In one embodiment of the present invention, the marketing platform (2003) refers to any platform that enables marketing.

On the metaverse, NFTs act as intermediaries that connect avatars and items with their digital twins in the real world, including owners, creators, advertisers, and physical products.

Additionally, participants are rewarded with promotional fees, and users are issued NFTs for avatars and items, granting them uniqueness. The value of these NFTs is measured, and profits are generated as costs are refunded according to the value.

Referring to FIG. 14, the server (200) objectifies the human body separately and connects meta information and the information such as gender, age, body type, and ethnicity (e.g., Asian). Items (e.g., products) are also objectified and connected to meta information. At this time, each avatar ID is linked to a user ID, item ID, and NFT ID.

Various real-world values and asset information can be included in meta information form and converted into NFTs, ensuring uniqueness for items in NFT form. These NFTs can then be traded or sold. The platform ensures that ownership of the NFT grants usage rights for real-world value, and usage history and stages of service are synchronized with the platform's database, where the NFT meta information is updated and referenced.

In one embodiment of the present invention, real-world value associated with NFT ownership may include rights to use a digital cadaver, which is the avatar of a patient.

Referring to FIG. 20, the server (200) from FIG. 1 can create items in the metaverse based on actual products being sold and provide instructions for purchasing the physical product in the real world.

In one embodiment of the present invention, influencers (2001) using the service of the present invention can promote their avatars or the service itself on their social media networks, and the server (200) can acquire promotional content uploaded to the social media channels. The server (200) can analyze users entering through social media channels and, based on the analysis, calculate the promotional costs to be paid to the social media platform. The server (200) can generate and provide different links for each influencer (2001) and reward them based on the users entering through these links. Additionally, the server (200) can analyze user registration, item purchase amounts, and provide additional rewards to influencers (2001).

In one embodiment of the present invention, influencers (2001) may include celebrities, actors, athletes, and more.

In one embodiment of the present invention, each area within the metaverse, including land, sea, and buildings, is assigned an NFT, allowing it to function like a real estate registry. Users can trade these areas using NFTs.

In one embodiment of the present invention, each object in the metaverse game can consist of complex elements such as patterns, colors, materials, and designs. The server (200) links these elements to meta information such as brand, product ID, seller ID, creator ID, advertiser ID, and owner ID, converting them into NFTs. Additionally, the server (200) objectifies cap, accessories, clothing, and other items, linking them to meta information such as user, creator, uniqueness ID, or representative object ID. Each item ID may be linked to an NFT ID. Furthermore, the server (200) assigns NFTs to items purchased by users, such as accessories, enabling transactions within the metaverse.

In one embodiment of the present invention, the server (200) provides dental, plastic surgery, and other store content within the metaverse. When users pay for a desired procedure, surgery, or item, GAN and/or GNN are used to alter part or all of an avatar or digital cadaver. The server (200) issues NFTs for the digital cadaver and the user's avatar character combined with the purchased items (e.g., surgical equipment, tools, techniques). Users can receive NFTs for the digital cadaver and sell them for profit. Thus, according to this embodiment, users can enjoy customizing their digital cadaver with various item combinations using GAN and/or GNN and receive NFTs for the completed digital cadaver, providing uniqueness and a potential source of profit.

In one embodiment of the present invention, the server (200) issues NFTs for avatars combined with purchased items. Users can receive NFTs for their avatars and sell them for profit. Thus, according to this embodiment, users can coordinate various item combinations for their avatars using GAN and/or GNN (1605), providing uniqueness and a source of entertainment, while NFTs are issued for the combination-completed avatars, offering a way to generate profit. Additionally, the server (200) assigns NFTs to items purchased by users, such as accessories, enabling transactions within the metaverse.

In one embodiment of the present invention, the server (200) provides services such as virtual makeup trials, trying on clothes, receiving recommendations for makeup or fashion styles, inserting a user's face into celebrity videos, and checking their style.

Additionally, the server (200) performs a process of sending information related to video information, providing corrections and alerts for minor or critical mistakes made by the user based on label values corresponding to the user's input in the labeling process (e.g., selective labeling, hierarchical labeling, time-series division labeling, body-part-specific labeling) for raw data, the first video, the second video, avatar and/or item motion-related videos, the first robotics video, the second robotics video, etc (including approval labels for correct actions and rejection labels for incorrect actions).

Referring to FIG. 16, the server (200) conducts supervised learning for artificial intelligence using selective labeling (1604) based on correct and incorrect decisions made by the user. The server (200) also intervenes with corrections or stop alerts for minor or critical mistakes made by the user on the terminal (100).

In one embodiment of the present invention, the video information is repeated as ‘the second, third, fourth, . . . ’ sequences.

The video information is the ‘the first, second, third, . . . video information’ that is repeatedly generated by the predictive values of the GAN and/or GNN predictive model (1605).

In one embodiment of the present invention, human interaction with collective intelligence robotics (1803) occurs by providing a warning/alert signal. Automated surgery artificial intelligence, which impacts a patient's life, does not replace the doctor but is included as a haptic system in the robotic arm steering device that assists in precise surgery. When the system detects a potential error in the procedure, it provides a warning signal, such as vibration, allowing interaction and intervention with the doctor. If the warning signal is ignored and the surgery is carried out, this behavior may be used as separate labeled data, indicating that ‘acting in such a manner is the correct answer for this situation.’ Through this feedback, the virtual world artificial intelligence assists real-world surgeries, and as more users engage, the system becomes increasingly precise.

In one embodiment of the present invention, when avatars, humans, or robots in videos labeled with not ACCEPT or REJECT labels perform motions, the artificial intelligence provides supervised learning and sends an alert. The alerts can be used in virtual simulations, such as virtual surgery, driving, or flight, as well as in real-world surgeries, driving, or flight.

In one embodiment of the present invention, alerts can be issued through visual information, audio information, or haptic devices.

In one embodiment of the present invention, if a surgeon makes a mistake during a gastric cancer surgery, a REJECT label is applied to the video. The artificial intelligence will execute supervised learning process based on this. When an artificial intelligence-assisted robotic surgeon assists in stomach cancer surgery, it detects incorrect surgical actions in virtual surgery games and/or actual stomach cancer surgeries and sends an alert.

In one embodiment of the present invention, when a user is piloting a fighter jet in a virtual war game and controls the jet and/or gets shot down by an enemy aircraft, the user can assign ACCEPT or REJECT labels to the video. The artificial intelligence will execute supervised learning process based on this and send alerts when detecting incorrect maneuvers in real fighter jet combat.

For example, if a user in a VR treadmill police game, playing the role of a thief, commits theft or a crime, and applies a REJECT label to the video, the artificial intelligence will execute supervised learning process based on this and later detect and alert similar behaviors in real security systems.

Additionally, the information transmission stage of video information may involve the robot autonomously performing corrective motions or autonomous operations in response to user mistakes.

In other words, the collective intelligence robotics (1803) in FIGS. 18 and 19 executes supervised learning process based on the visual data labeled with robotics selective labeling (1810), and the artificial intelligence robot operates autonomously. The system corrects user mistakes or performs autonomous operations on the terminal (100).

In one embodiment of the present invention, the robotics video information is repeated as ‘the second, third, fourth, . . . ’ sequences.

The video information is the ‘the first, second, third, . . . robotics video information’ that is repeatedly generated by the predictive values of the GAN and/or GNN robotics predictive model.

In one embodiment of the present invention, information labeled with ACCEPT, REJECT, not ACCEPT, or not REJECT labels is used by the artificial intelligence to send alerts to the user and to autonomously operate to solve or avoid problems. The autonomous actions of collective intelligence robotics (1803) are possible both in VR simulators and in the real world.

In one embodiment of the present invention, this is also applicable to virtual surgeries, autonomous driving of various drones (VEHICLE), autonomous flight, or autonomous actions of humanoid robots.

In one embodiment of the present invention, advanced surgical artificial intelligence assists real-world surgeries by using robotic arms on artificial cadavers or real patients, correcting minor or critical mistakes made by the doctor and providing an alert to halt the procedure. The artificial intelligence robotic arm operates a VR simulator, and doctors label the surgical information, gamifying the process. For surgery information with additional labeling, the medical artificial intelligence is further enhanced by fine-tuning the existing algorithm model. Ultimately, the artificial intelligence robotic arm can perform surgeries on real bodies, with doctors labeling the process.

In one embodiment of the present invention, the autonomous surgical robot in a virtual surgery game can perform gastric cancer surgery on a VR simulator. When the doctor applies selective labeling (1604) in the virtual surgery, the artificial intelligence executes supervised learning process based on this and the artificial intelligence surgeon robot gradually becomes more advanced. The advanced artificial intelligence surgeon robot can automatically perform real surgeries, and the doctor can further enhance the artificial intelligence by applying selective labeling again. Through repeated algorithms, the collective intelligence robotics (1803) becomes an autonomous artificial intelligence surgeon robot or artificial intelligence dentist robot.

In one embodiment of the present invention, in a virtual fighter jet flying game, if a user presses the ACCEPT button to label a video where a vehicle robot shoots down an enemy aircraft, the artificial intelligence executes supervised learning process based on this and learns the piloting of virtual or real fighter jets. In a virtual fighter jet flight game or during actual fighter jet flight, active maneuvers can be performed, such as evasive maneuvers or attack maneuvers.

In one embodiment of the present invention, when a human user applies selective labeling (1604) on the autonomous driving of a VEHICLE robot in a VR simulator, the artificial intelligence executes supervised learning process based on this, and the VEHICLE robot becomes increasingly advanced. The advanced robot can eventually perform automatic real-world driving, and the human user can apply robotics selective labeling (1810) again to further enhance the artificial intelligence.

In one embodiment of the present invention, in a virtual dance competition on a VR treadmill, if a humanoid robot competes in a dance event and a real dance expert, domain expert, robotics developer, or user applies robotics selective labeling (1810), the artificial intelligence executes supervised learning process based on this, and the humanoid robot's motions gradually become more advanced.

The information processing system (10) utilizing collective intelligence may also include an external server (not shown).

The external server can be connected to the service-providing server (200) via a network, and the server (200) stores and manages various information to perform the method for generating and/or providing virtual avatars using GAN and/or GNN on a platform.

Additionally, the external server stores various information and data that are generated and/or output as the server (200) performs the method of generating and/or providing virtual avatars using GAN and/or GNN.

In one embodiment of the present invention, the external server is a separate storage server located outside of the server (200).

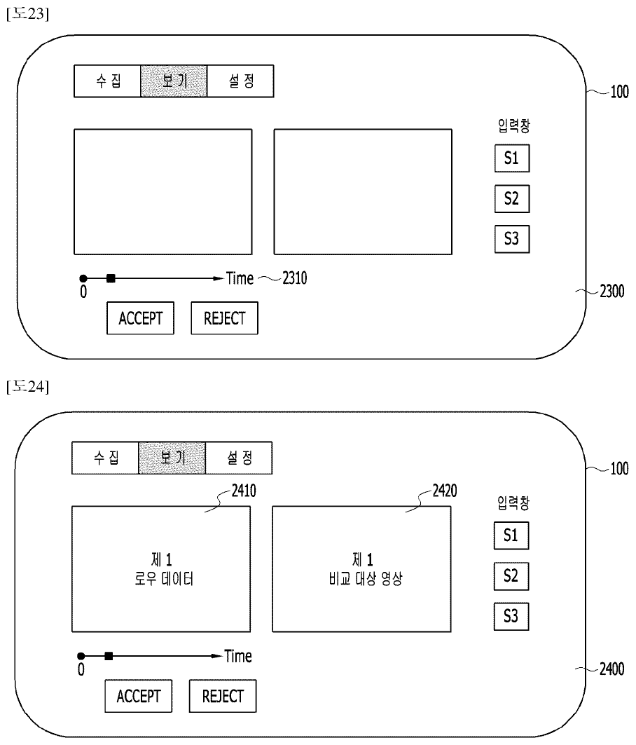

FIG. 21 is a flowchart illustrating a method of generating and/or providing a platform for virtual avatars and items using GNN and/or GAN according to an embodiment of the present invention.

Referring to FIG. 21, the server (200) obtains user information from the user (S2110). Based on the acquired user information, the server generates virtual avatars using GAN or outputs them using GNN (S2120), provides the avatars in the metaverse (S2130), and conducts metaverse games using the avatars (S2140).

In one embodiment of the present invention, the server (200) creates avatars for games that can be played on the metaverse national platform. Some of the competitive games that may take place within the metaverse nation include courtroom games, police games, firefighter games, art creation games, agriculture games, trade games, land development games, construction games, financial investment games, energy generation games, government agency operation games, war and battle games, shooting games, strategy games, arcade games, sports games, audition games, and so on. The digital cadaver is a type of avatar.

According to the present invention, services can be provided in metaverse games that allow users to try on cosmetics, fashion items, and clothing by applying them to their own face and body and combining them in various ways.

Additionally, the present invention provides a marketing and advertising platform for companies offering items and an online purchase connection platform. For influencers, it provides a platform that converts a series of marketing activities into profits by driving purchases through various images and videos shared on SNS and tracking the results.

In FIG. 21, the computer program includes one or more instructions for performing a platform provision method related to the generation and/or output of virtual avatars. The steps include obtaining user information from the user (S2110), generating or outputting virtual avatars and items based on the acquired user information (S2120), providing the avatars in the metaverse (S2130), and conducting virtual games using the avatars (S2140).

Referring to FIG. 21, the server (200) obtains user information from the user (S2110). The user information may include gender, age, body type, race, and the user's facial image, but is not limited to these. Based on the acquired user information, the server (200) generates or outputs virtual avatars and items (S2120). The server (200) provides the avatars in the metaverse (S2130) and conducts various games using the avatars in conjunction with game servers (not shown) (S2140).

In this way, labeling is performed on one or more raw data related to specific content provided by the user. The labeled raw data is processed through pre-configured classification models and prediction models to perform learning functions. Additional labeling is performed on the first video, which is the output of the prediction model. Further learning is conducted through classification and prediction models on the additionally labeled first video, resulting in the output of the second video.

Additionally, as described above, the motion-related videos of real humans, virtual avatars, or items can be reconstructed into robot motion videos. Labeling is performed on the reconstructed robot motion videos, and the labeled robot motion videos are processed through pre-configured classification models and prediction models for learning. Additional labeling is performed on the first robotics video, which is the result of the learning process, and the additional labeled first robotics video is processed through classification and prediction models for further learning, resulting in the output of the second robotics video.

Hereinafter, the information processing method using collective intelligence according to the present invention will be described in detail with reference to FIGS. 1 to 32.

FIG. 22 is a flowchart illustrating an information processing method using collective intelligence according to the first embodiment of the present invention.

First, the terminal (100), in conjunction with one or more visual set devices (not shown), on a specific topic, collects one or more raw data, meta information related to the raw data, comparison target videos, and meta information related to the comparison target videos. The visual set devices may include cameras, LiDAR, eye trackers, motion capture and motion trackers, medical equipment (e.g., CT, scanners, MRI, medical ultrasound, etc.), and more. The specific topic (or specific content) may include medical activities (e.g., procedures, surgeries), dance, sports (e.g., soccer, basketball, table tennis), games, and e-sports. The raw data (or source data/original data/visual data/real-world videos) may include sequential still images (or multiple sequential still images), videos, and measurement values obtained (or collected/recorded/measured) in the real world. The measurement values may include video information (or 3D data) measured by the LiDAR, eye tracker, motion capture and motion tracker, and medical equipment.

Additionally, the terminal (100) transmits the collected raw data related to the specific topic, the meta information related to the raw data, the comparison target videos, the meta information related to the comparison target videos, and the identification information of the terminal (100) to the server (200). The identification information of the terminal (100) may include MDN, mobile IP, mobile MAC, SIM card unique information, serial numbers, and more.

For example, the first terminal (100), in conjunction with the first camera included in the visual set device installed at the first dental clinic, collects the first raw data related to the first surgery (e.g., implant surgery) performed by the first dentist, the meta information related to the first raw data, the first comparison target video related to the first surgery, and the meta information related to the first comparison target video.

Additionally, The first terminal then transmits the collected first raw data related to the first dentist's first surgery, the meta information related to the first raw data, the first comparison target video related to the first surgery, the meta information related to the first comparison target video, and the identification information of the first terminal to the server (200).

In another example, the second terminal (100), in conjunction with the second camera included in the visual set device installed at the second dance studio, collects the second raw data related to a cover dance where Hong Gil-dong follows the dance moves of Jennie from BLACKPINK, the meta information related to the second raw data, the second comparison target video related to the cover dance, and the meta information related to the second comparison target video. If the raw data is a robot motion video, Hong Gil-dong becomes the robot, and the dance moves performed by Jennie become the correct data for the robot's motions. A professional dancer labeling the robot motion video may be a domain expert (e.g., a robotics engineer) capable of evaluating the robot's movements.

The second terminal then transmits the collected second raw data related to Hong Gil-dong's cover dance of Jennie's moves, the meta information related to the second raw data, the second comparison target video related to the cover dance, the meta information related to the second comparison target video, and the identification information of the second terminal to the server (200) (S2210).

Subsequently, the server (200) receives one or more raw data, the meta information related to the raw data, the comparison target videos, the meta information related to the comparison target videos, and the identification information of the terminal (100) transmitted from the terminal (100).

Additionally, the server (200) performs selective labeling on the received one or more raw data. Here, the selective labeling refers to a labeling method where a label (or label value) is set (or assigned) based on the presence or absence of errors (or anomalies) at specific timestamps (or time intervals) in the raw data. At this time, any timestamps (or time intervals) in the raw data that are not assigned a label (or label value) through selective labeling may be assigned a pre-configured default label value (e.g., an approval label).

That is, the server (200), in conjunction with the terminal (100), sets (or receives/inputs) a label (or label value) at specific timestamps (or time intervals) in the raw data displayed on the terminal (100) based on the user input (or user selection/touch/control) from the terminal (100).

At this time, the terminal (100) executes a dedicated app that has been pre-installed on the device, displaying the app execution result screen. The app execution result screen includes a collection menu (or button/item) for collecting one or more raw data related to the specific topic, meta information related to the raw data, and a view menu for displaying the collected information or information provided by the server (200), as well as a settings menu for configuring preferences. The terminal (100) is registered as a member with the server (200), which provides the dedicated app, and performs a login procedure when executing the app using an ID and password or a barcode or QR code containing the ID. This allows the terminal to perform various functions of the app, such as raw data collection, hierarchical labeling for information/video, selective labeling for information/video, time-series division selective labeling for information/video, or body-part-specific labeling for information/video.

Additionally, when a pre-configured view menu is selected on the app execution result screen of the terminal (100), the terminal displays the view screen corresponding to the selected view menu to display the collected information or information provided by the server (200). The view screen includes a video display area for displaying raw data or generated videos, a comparison target video display area for displaying comparison target videos, a hierarchical label input menu for selecting variable values (or label values) for hierarchical labeling, a selective label input menu for selecting settings for selective labeling, and a playback bar for controlling playback/pause/stop functions of the video.

Additionally, when the playback bar or playback button on the view screen is selected, the terminal (100) displays (or outputs) the collected raw data in the video display area and displays (or outputs) the comparison target video corresponding to the collected raw data (or the comparison target video provided by the server) in the comparison target video display area. At this time, the terminal (100) performs synchronization based on the meta information corresponding to the raw data and the comparison target video, displaying the synchronized raw data and comparison target video in the video display area and the comparison target video display area, respectively.

Additionally, based on user input (or user selection/touch/control) from the terminal (100), the terminal (100) sets (or receives/inputs) a label (or label value) for correct or incorrect motions of objects in the raw data displayed in the video display area at specific timestamps (or time intervals).

That is, at one or more specific timestamps in the raw data displayed in the video display area, the terminal (100) receives user input to assign label values for correct motions (e.g., a pre-configured approval/ACCEPT label) or incorrect motions (e.g., a pre-configured rejection/REJECT label).

In this way, based on the user input from a domain expert related to the specific topic, the terminal (100) sets (or receives/inputs) one or more selective labels (or label values) at one or more specific timestamps (or time intervals) in the raw data related to the specific topic.

Additionally, the terminal (100) transmits one or more selective label values, meta information related to the raw data, and the identification information of the terminal (100) at one or more characteristic timestamps (or specific intervals) in the raw data to the server (200).

Furthermore, the server (200) receives one or more selective label values, meta information related to the raw data, and the identification information of the terminal (100) at one or more specific timestamps (or specific intervals) in the raw data transmitted from the terminal (100).

At this time, before or after performing selective labeling on one or more raw data, the server (200), in conjunction with the terminal (100), can perform hierarchical labeling on the raw data and then perform selective labeling on the raw data either before or after the hierarchical labeling. Here, the hierarchical labeling (or hierarchical tagging) refers to a labeling method where a label (or label value) is attached to indicate the characteristics of the raw data, and the raw data is divided (or categorized) into multiple subsets based on these characteristics through input feature engineering provided by the user.

That is, the server (200), in conjunction with the terminal (100), sets (or receives/inputs) a label (or label value) at other specific timestamps (or time intervals) in the raw data displayed on the terminal (100) based on the user input (or user selection/touch/control) and by referencing (or relying on) multiple pre-configured label classifications related to the specific topic.

For example, the first terminal executes the pre-installed Dr. David app and displays the result screen of the app execution. At this time, the first dentist of the first terminal may be logged into the Dr. David app using a first ID and a first password.

Additionally, when the view menu is selected from the app execution result screen of the Dr. David app, the first terminal displays the view screen (2300) corresponding to the selected view menu, as shown in FIG. 23.

Furthermore, when the playback bar (2310) on the view screen (2300) is selected, as shown in FIG. 24, the first terminal outputs the collected first raw data in the video display area (2410) and outputs the collected first comparison target video in the comparison target video display area (2420). At this time, the first terminal outputs the data in a synchronized state between the first raw data and the first comparison target video.

Moreover, the first terminal references the label classifications set in advance, according to [Table 1] through [Table 4], and based on input from the first dentist regarding the first surgery (e.g., implant surgery), receives the first-first hierarchical label values (e.g., the dental implant surgery corresponding to S1) for the first raw data, the first-second hierarchical label values (e.g., a case of narrow mandibular molar bone width corresponding to S2), and the first-third hierarchical label values (e.g., a surgery involving block bone grafting corresponding to S3).

Additionally, the first terminal divides the first raw data into pre-configured 10-second intervals.

The first terminal also receives, based on the first dentist's selections, the first-first Accept label value at the first-first timestamp (e.g., 1 minute and 10 seconds), the first-second Reject label value at the first-second time interval (e.g., between 1 minute 45 seconds and 1 minute 58 seconds), and the first-third Accept label value at the first-third timestamp (e.g., 2 minutes and 20 seconds) for the first raw data displayed in the video display area (2410) and the first comparison target video displayed in the comparison target video display area (2420).

The first terminal then transmits the first-first Accept label value at the first-first timestamp (e.g., 1 minute 10 seconds), the first-second Reject label value at the first-second time interval (e.g., between 1 minute 45 seconds and 1 minute 58 seconds), the first-third Accept label value at the first-third timestamp (e.g., 2 minutes 20 seconds), the first-first hierarchical label values (e.g., dental implant surgery corresponding to S1) for the first raw data, the first-second hierarchical label values (e.g., narrow mandibular molar bone width corresponding to S2), the first-third hierarchical label values (e.g., surgery involving block bone grafting corresponding to S3), the information about the division (e.g., 10-second interval division), the meta information related to the first raw data, and the identification information of the first terminal to the server (200).

The server (200) receives, for the first raw data, the first-first Accept label value at the first-first timestamp (e.g., 1 minute 10 seconds), the first-second Reject label value at the first-second time interval (e.g., between 1 minute 45 seconds and 1 minute 58 seconds), the first-third Accept label value at the first-third timestamp (e.g., 2 minutes 20 seconds), the first-first hierarchical label values (e.g., dental implant surgery corresponding to S1), the first-second hierarchical label values (e.g., narrow mandibular molar bone width corresponding to S2), the first-third hierarchical label values (e.g., surgery involving block bone grafting corresponding to S3), the information about the division (e.g., 10-second interval division), the meta information related to the first raw data, and the identification information of the first terminal from the first terminal.

In another example, the second terminal executes the pre-installed Dr. David app and displays the result screen of the app execution. At this time, the second professional dancer of the second terminal may be logged into the Dr. David app using a second ID and a second password.

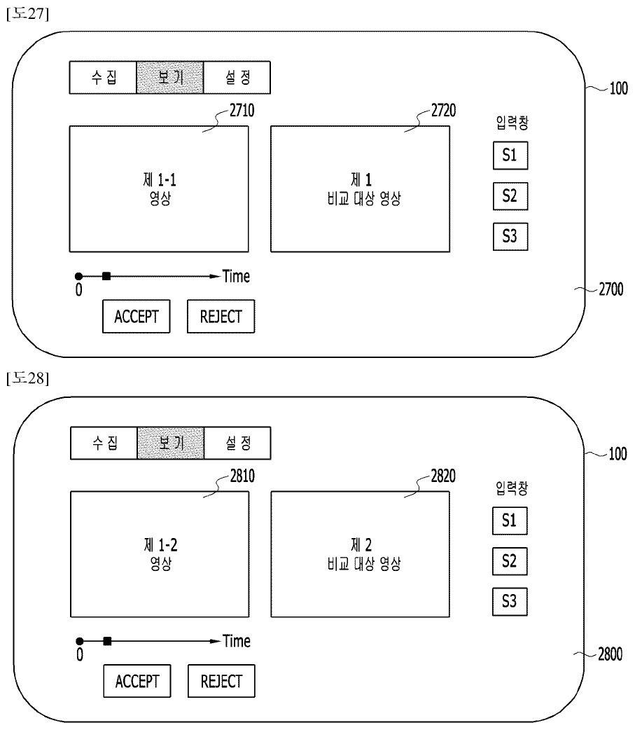

Additionally, when the view menu is selected from the app execution result screen of the Dr. David app, the second terminal displays the view screen (2500) corresponding to the selected view menu, as shown in FIG. 25.

Furthermore, when the playback bar (2510) on the view screen (2500) is selected, as shown in FIG. 26, the second terminal outputs the collected second raw data in the video display area (2610) and outputs the collected second comparison target video in the comparison target video display area (2620). At this time, the second terminal outputs the second row data and the second comparison target image in a synchronized state.

Moreover, the second terminal references the label classifications set in advance, according to [Table 7] through [Table 11], and based on input from the second professional dancer regarding Hong Gil-dong's cover dance, receives the second-first hierarchical label values (e.g., BLACKPINK Jennie corresponding to S1) for the second raw data, the second-second hierarchical label values (e.g., “As If It's Your Last” with a duration of 3 minutes and 14 seconds corresponding to S2), and the second-third hierarchical label values (e.g., “Open Concert” broadcasted on Jul. 8, 2022, corresponding to S3).

Additionally, the second terminal divides the second raw data into pre-configured 3-second intervals.

The second terminal also receives, based on the second professional dancer's selections, the second-first Reject label value at the second-first time interval (e.g., between 30 seconds and 45 seconds), the second-second Accept label value at the second-second time interval (e.g., between 1 minute 10 seconds and 1 minute 20 seconds), and the second-third Accept label value at the second-third timestamp (e.g., 1 minute 50 seconds), for the second raw data displayed in the video display area (2610) and the second comparison target video displayed in the comparison target video display area (2620).

The second terminal then transmits the second-first Reject label value at the second-first time interval (e.g., between 30 seconds and 45 seconds), the second-second Accept label value at the second-second time interval (e.g., between 1 minute 10 seconds and 1 minute 20 seconds), the second-third Accept label value at the second-third timestamp (e.g., 1 minute 50 seconds), the second-first hierarchical label values (e.g., BLACKPINK Jennie corresponding to S1), the second-second hierarchical label values (e.g., “As If It's Your Last” corresponding to S2), the second-third hierarchical label values (e.g., “Open Concert” on Jul. 8, 2022, corresponding to S3), the information about the division (e.g., 3-second interval division), the meta information related to the second raw data, and the identification information of the second terminal to the server (200).

The server (200) receives the second-first Reject label value at the second-first time interval (e.g., between 30 seconds and 45 seconds), the second-second Accept label value at the second-second time interval (e.g., between 1 minute 10 seconds and 1 minute 20 seconds), the second-third Accept label value at the second-third timestamp (e.g., 1 minute 50 seconds), the second-first hierarchical label values (e.g., BLACKPINK Jennie corresponding to S1), the second-second hierarchical label values (e.g., “As If It's Your Last” corresponding to S2), the second-third hierarchical label values (e.g., “Open Concert” on Jul. 8, 2022, corresponding to S3), the information about the division (e.g., 3-second interval division), the meta information related to the second raw data, and the identification information of the second terminal from the second terminal (S2220).

Subsequently, the server (200) performs artificial intelligence-based machine learning based on the information related to the selectively labeled raw data and generates (or confirms) the classification values for the raw data based on the machine learning results. Here, the classification values for the raw data may be the values classified by selective labeling values, hierarchical labeling values, and other similar criteria.

That is, the server (200) performs machine learning (or artificial intelligence/deep learning) by using the information related to the selectively labeled raw data as input values for the pre-configured classification model, and generates (or confirms) the classification values for the raw data based on the machine learning results (or artificial intelligence results/deep learning results).

For example, the server (200) performs machine learning using the classification model with the input of the selectively labeled information from the first raw data, such as the first-first Accept label value at the first-first timestamp (e.g., 1 minute 10 seconds), the first-second Reject label value at the first-second time interval (e.g., between 1 minute 45 seconds and 1 minute 58 seconds), and the first-third Accept label value at the first-third timestamp (e.g., 2 minutes 20 seconds). Based on the machine learning results, the server classifies the first-first Accept label value, the first-third Accept label value, and the first-second Reject label value for the first raw data.

In another example, the server (200) performs machine learning using the classification model with the input of the selectively labeled information from the second raw data, such as the second-first Reject label value at the second-first time interval (e.g., between 30 seconds and 45 seconds), the second-second Accept label value at the second-second time interval (e.g., between 1 minute 10 seconds and 1 minute 20 seconds), and the second-third Accept label value at the second-third timestamp (e.g., 1 minute 50 seconds). Based on the machine learning results, the server classifies the second-second Accept label value, the second-third Accept label value, and the second-first Reject label value for the second raw data (S2230).

Subsequently, the server (200), using the classification values for the raw data, the selectively labeled raw data information, the raw data, the meta information related to the raw data, the comparison target video, and the meta information related to the comparison target video as input value, performs machine learning (or artificial intelligence/deep learning). Based on the machine learning results (or artificial intelligence results/deep learning results), the server generates the first video corresponding to the raw data. This first video may include motion-related videos of avatars, items, or robots generated based on the raw data, or updated videos (e.g., videos where the motions/behaviors of a person or human in the raw data have been updated).

That is, the server (200) performs machine learning (or artificial intelligence/deep learning) using the classification values for the generated raw data, the selectively labeled raw data information, the raw data, the meta information related to the raw data, the comparison target video, and the meta information related to the comparison target video as input values for the pre-configured prediction model, and generates the first video related to the raw data based on the machine learning results (or artificial intelligence results/deep learning results).

Additionally, the server (200) transmits the generated first video to the terminal (100).

Furthermore, the terminal (100) receives the first video transmitted from the server (200) and outputs the first video in the video display area instead of the currently displayed raw data. At this time, the terminal (100) may also divide the screen of the terminal (100) and output the raw data, the comparison target image, and the first image simultaneously in a synchronized state.

For example, the server (200) performs machine learning using the input of the classification values of the first raw data, such as the first-first Accept label value, the first-third Accept label value, and the first-second Reject label value, (as information regarding the selectively labeled first raw data) the first-first Accept label value at the first-first timestamp (e.g., 1 minute 10 seconds), the first-second Reject label value in the first-second time interval (e.g., from 1 minute 45 seconds to 1 minute 58 seconds), and the first-third Accept label value at the first-3 timestamp (e.g., 2 minutes 20 seconds), the raw first data, the meta information related to the first raw data, the comparison target video, and the meta information related to the comparison target video. Based on the machine learning results, the server generates the first-first video related to the first raw data.

The server (200) also transmits the generated first-first video to the first terminal.

Additionally, the first terminal receives the first-first video transmitted from the server (200) and outputs the first-first video instead of the first raw data currently displayed in the video display area.

In another example, the server (200) performs machine learning using the input of the classification values of the second raw data, such as the second-second Accept label value, the second-third Accept label value, and the second-first Reject label value, (as information regarding the selectively labeled second raw data) the second-first Reject label value in the second-1 time interval (e.g., from 30 seconds to 45 seconds), the second-second Accept label value in the second-second time interval (e.g., from 1 minute 10 seconds to 1 minute 20 seconds), and the second-third Accept label value at the second-third timestamp (e.g., 1 minute 50 seconds), the second raw data, the meta information related to the second raw data, the comparison target video, and the meta information related to the comparison target video. Based on the machine learning results, the server generates the first-second video related to the second raw data.

Additionally, the server (200) transmits the generated first-second video to the second terminal.

The second terminal then receives the first-second video transmitted from the server (200) and outputs the first-second video instead of the second raw data currently being displayed in the video display area (S2240).

Subsequently, the server (200) performs additional selective labeling on the first video. Here, the additional selective labeling refers to a labeling method where a label (or label value) is set (or assigned) to indicate the presence or absence of errors (or anomalies) at another specific timestamp (or another specific time interval) in the first video. At this time, any timestamp (or time interval) in the first video that is not assigned a label (or label value) through additional selective labeling may be assigned a pre-configured default label value (e.g., an approval label).

That is, the server (200), in conjunction with the terminal (100), sets (or receives/inputs) a label (or label value) at another specific timestamp (or specific time interval) in the first video displayed on the terminal (100), based on user input (or user selection/touch/control) from the terminal (100).

At this time, when the playback bar or playback button in the view screen of the app execution result screen displayed on the terminal (100) is selected, the terminal (100) displays (or outputs) the first video in the video display area, and displays (or outputs) the comparison target video corresponding to the raw data (or the first video) or the comparison target video provided by the server (200) in the comparison target video display area. At this time, the terminal (100) performs synchronization based on the meta information corresponding to the first video and the comparison target video, and displays the synchronized first video and comparison target video in the video display area and the comparison target video display area, respectively.

Additionally, the terminal (100) sets (or receives/inputs) a label (or label value) for correct or incorrect motions of objects (or avatars) in the first video displayed in the video display area at another specific point (or interval), based on user input (or user selection/touch/control) from the terminal (100).

That is, at one or more additional specific timestamps in the first video displayed in the video display area, the terminal (100) receives user input to assign label values for correct motions (e.g., a pre-configured approval/ACCEPT label) or incorrect motions (e.g., a pre-configured rejection/REJECT label).

In this way, the terminal (100) sets (or receives/inputs) one or more additional selective labels (or additional selective label values) at one or more additional specific timestamps (or specific time intervals) in the first video generated on the specific topic, based on user input from a domain expert related to the specific topic using the terminal (100).

At this time, the terminal (100) performs a time-series division selective labeling function or a body-part-specific selective labeling function based on the user input from the terminal (100).

The terminal (100) performs the time-series division selective labeling function through the following process.

That is, the terminal (100) receives label values for each of the divided sub-videos of the first video, based on user input. These label values indicate whether the division status of each sub-video is correct (e.g., a pre-configured approval/ACCEPT label) or incorrect (e.g., a pre-configured rejection/REJECT label). Additionally, to arrange the order of the sub-videos, the terminal receives label values indicating the sequence of the sub-videos (or, if the division timestamps are incorrect or require adjustment, label values to adjust the division timestamps). The body-part-specific labeling can be omitted. Here, the division of the first video into multiple sub-videos may be based on the information from the hierarchical labeling function performed on the raw data, or it may be the result of the artificial intelligence function or video analysis function performed by the server (200) on the raw data.

Accordingly, the terminal (100) receives, based on user input, label values indicating whether the division status of each sub-video is correct or incorrect for the first video, and also receives label values for arranging the order of the sub-videos (or label values indicating the sequence of the sub-videos/label values to adjust the division timestamps if the division timestamp is incorrect or needs to be corrected).

Additionally, the terminal (100) performs the body-part-specific selective labeling function through the following process.

That is, for each avatar (or object) included in the divided sub-videos of the first video, the terminal receives, based on user input, label values for the order of the avatars (or object's) motions in the sub-videos (or label values for whether the avatars motions are correct or incorrect). The terminal also receives, based on user input, label values to arrange the order of the multiple sub-videos(or label values to adjust the sequence of sub-videos containing the avatar) in order to arrange the motion sequence by body part in motions of the avatar(or object) in the multiple sub-videos. Here, the division of the first video into multiple sub-videos may be based on the information for the multiple sub-videos, which are divided according to hierarchical labeling function performed on the raw data or the artificial intelligence or video analysis function performed by the server (200).

Accordingly, Based on the user input of the terminal (100) for the first video, the terminal (100) receives label values for the order of the avatar's (or object's) motions in the multiple sub-videos (or label values for whether the avatar's motions are correct or incorrect). The terminal also receives label values to arrange the order of the multiple sub-videos (or label values to adjust the sequence of sub-videos containing the avatar) or label values for the order of the multiple sub-images/label values for adjusting the sequence of sub-images containing the avatar.

Additionally, the terminal (100) transmits, at one or more additional specific timestamps (or specific time intervals) related to the first image, the one or more additional selective label values, the one oe more time-series division selective label values, the one or more body-part-specific selective label values, the label values for arranging the order of the sub-videos, and the identification information of the terminal (100) to the server (200).

Furthermore, the server (200) receives, at one or more additional specific timestamps (or specific time intervals) related to the first image, the one or more additional selective label values, the one or more time-series division selective label values, the one or more body-part-specific selective label values, the label values for arranging the order of the sub-videos, and the identification information of the terminal (100) transmitted from the terminal (100).

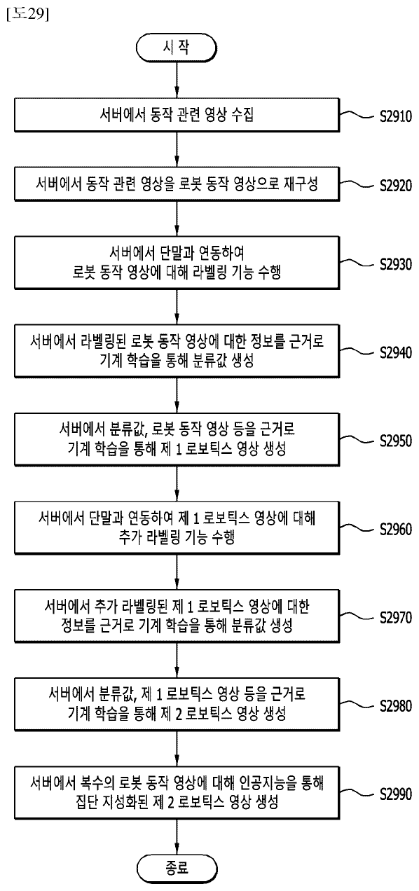

For example, when the playback bar in the view screen of the first terminal is selected, as shown in FIG. 27, the first terminal outputs the first-first video in the video display area (2710) and the first comparison target video in the comparison target video display area (2720). At this time, the first terminal synchronizes and outputs the first-first video and the first comparison target video. Here, the first comparison target video and the second comparison target video displayed in the comparison target video display areas (2720, 2820) are video outputs of label classifications related to avatar movements as shown in [Table 1] through [Table 11].

Additionally, the first terminal references the label classifications in [Table 12] and, based on input from the first dentist of the first terminal, divides the first-first video into multiple time intervals, ranging from the first-first-first time interval to the first-first-tenth time interval, with each time interval having a duration of 2 to 4 seconds, for the surgery of removing tooth 11 for maxillary central incisor laminate treatment, which is detailed process in the first surgery (e.g., implant surgery). Then, the first terminal receives the first-first-first label value to the first-first-tenth label value for each divided time intervals ranging from the first-first-first time interval to the first-first-tenth time interval.

In order to arrange the order for the first-first-first time interval to the first-first-tenth time interval, the first terminal also receives, based on input from the first dentist of the first terminal, label values (e.g., label values for arranging first-first-first time interval, first-first-second time interval, first-first-third time interval, first-first-sixth time interval, first-first-seventh time interval, first-first-eighth time interval, first-first-fourth time interval, first-first-fifth time interval, first-first-ninth time interval, and first-first-tenth time interval).

Additionally, the first terminal transmits the first-first-first label value to the first-first-tenth label value for each of the first-first-first time interval to the first-first-tenth time interval related to the first-first video, the label values for arranging the order (e.g., label values for arranging first-first-first time interval, first-first-second time interval, first-first-third time interval, first-first-sixth time interval, first-first-seventh time interval, first-first-eighth time interval, first-first-fourth time interval, first-first-fifth time interval, first-first-ninth time interval, and first-first-tenth time interval), and the identification information of the first terminal to the server (200).

Furthermore, the server (200) receives the first-first-first label value to the first-first-tenth label value for each of the first-first-first time interval to the first-first-tenth time interval related to the first-first video, the label values for arranging the order (e.g., label values for arranging first-first-first time interval, first-first-second time interval, first-first-third time interval, first-first-sixth time interval, first-first-seventh time interval, first-first-eighth time interval, first-first-fourth time interval, first-first-fifth time interval, first-first-ninth time interval, and first-first-tenth time interval), and the identification information of the first terminal from the first terminal.

In another example, when the playback baron the view screen of the second terminal is selected, as shown in FIG. 28, the second terminal outputs the first-second video in the video display area (2810) and the second comparison target video in the comparison target video display area (2820). At this time, the second terminal synchronizes and outputs the first-second video and the second comparison target video.

Additionally, regarding Hong Gil-dong's cover dance following the motions of BLACKPINK's Jennie, the second terminal refers to the label classifications from [Table 11] and, based on the input from the second professional dancer of the second terminal divides the first-second video into the first-second-first time interval to the first-second-twentieth time interval, which are multiple intervals of 2 to 4 seconds, according to the order of the body parts that move the most when BLACKPINK's Jennie performs front/back waves. The second terminal receives the first-second-first label value to the first-second-twentieth label value for the first-second-first time interval to the first-second-twentieth time interval.

Moreover, for the first-second-first time interval to the first-second-twentieth time interval, the second terminal also receives label values based on input from the second professional dancer to arrange the order of the intervals (e.g., first-second-first time interval to first-second-seventh time interval, first-second-thirteenth time interval to first-second-seventeenth time interval, first-second-eighth time interval to first-second-tenth time interval, first-second-eighteenth time interval to first-second-twentieth time interval, and first-second-eleventh time interval to first-second-twelfth time interval).

Additionally, the second terminal transmits the first-second-first label value to the first-second-twentieth label value for the first-second-first time interval to the first-second-twentieth time interval related to the first-second video, the label values for arranging the order (e.g., first-second-first time interval to first-second-seventh time interval, first-second-thirteenth time interval to first-second-seventeenth time interval, first-second-eighth time interval to first-second-tenth time interval, first-second-eighteenth time interval to first-second-twentieth time interval, and first-second-eleventh time interval to first-second-twelfth time interval), and the identification information of the second terminal to the server (200).

Furthermore, the server (200) receives the dataset transmitted from the second terminal, which includes the first-second-first label value to the first-second-twentieth label value for the first-second-first time interval to the first-second-twentieth time interval related to the first-second video, the label values for arranging the order (e.g., label values for arranging first-second-first time interval to first-second-seventh time interval, first-second-thirteenth time interval to first-second-seventeenth time interval, first-second-eighth time interval to first-second-tenth time interval, first-second-eighteenth time interval to first-second-twentieth time interval, and first-second-eleventh time interval to first-second-twelfth time interval), and the identification information of the second terminal (S2250).

Subsequently, the server (200) performs additional machine learning based on the information from the additional selective labeling of the first video and, based on the results of the machine learning, generates (or confirms) classification values for the first video. The classification values (or classification values for the first video) may include additional selective label values and additional hierarchical label values, classified by category.

That is, the server (200) performs machine learning (or additional artificial intelligence/deep learning) based on the information from the additional selective labeling of the first video as input for the pre-configured classification model and generates (or confirms) classification values for the first video based on the results of the additional machine learning (or artificial intelligence/deep learning results).

For example, the server (200) performs additional machine learning using the classification model with the input of the additional selective label values for the first-first video, which are the first-first-first label value to the first-first-tenth label value for the first-first-first time interval to the first-first-tenth time interval related to the first-first video. The server (200) classifies the first-first-first label value to the first-first-seventh label value and the first-first-tenth label value as the Accept labels (and (the first-first-eighth label value to the first-first-ninth label value as the Reject labels based on the results of the additional machine learning.

In another example, the server (200) performs additional machine learning using the information from the additional selectively labeled first-second video, which is first-second-first label value to first-second-twentieth label value for each of the first-second-first time interval to the time first-second-twentieth time interval, as input for the classification model. Based on the results of the additional machine learning, the server classifies the first-second-first label value to the first-second-eighth label value and the first-second-twelfth label value to the first-second-twentieth label value as the Accept labels and the first-second-ninth label value to the first-second-eleventh label value as the Reject labels (S2260).

Subsequently, the server (200) performs additional machine learning (or additional artificial intelligence/deep learning) using the classification values for the first video, the information from the selectively labeled first video, the first video, the meta information related to the first video, the comparison target video, and the meta information related to the comparison target video. Based on the results of the additional machine learning (or additional artificial intelligence results/deep learning results), the server generates a second video corresponding to the first video. The second video may include motion-related videos of avatars, items, or robots generated based on the first video, or it may be an updated version of the first video.

That is, the server (200) performs additional machine learning (or artificial intelligence/deep learning) using the classification values for the first video, the information from the selectively labeled first video, the first video, the meta information related to the first video, the comparison target video, and the meta information related to the comparison target video as input for the pre-configured prediction model. Based on the results of the additional machine learning (or artificial intelligence/deep learning results), the server generates the second video related to the first video.

Additionally, the server (200) transmits the generated second video to the terminal (100).

Furthermore, the terminal (100) receives the second video transmitted from the server (200) and outputs the second video instead of the first video currently being displayed in the video display area. The terminal may also divide its screen to simultaneously display the raw data, the comparison target video, the first video, and the second video in a synchronized manner.

For example, the server (200) performs additional machine learning using the classification model for the generated first-first video, with the input of the first-first-first label value to the first-first-seventh label value and the first-first-tenth label value as the Accept labels, the first-first-eighth label value to the first-first-ninth label value as the Reject labels, the first-first-first label value to the first-first-tenth label value for each of the first-first-first time interval to the first-first-tenth time interval related to the first-first video as the selectively labeled information for the first-first video, the label values for arranging the order (e.g., the label values for first-first-first time interval, first-first-second time interval, first-first-third time interval, first-first-sixth time interval, first-first-seventh time interval, first-first-eighth time interval, first-first-fourth time interval, first-first-fifth time interval, first-first-ninth time interval, and first-first-tenth time interval), the first-first video, the meta information related to the first-first video, the first comparison target video, and the meta information related to the first comparison target video, etc. The server (200), then generates a second-first video corresponding to the first-first video based on the result of the machine learning.

Additionally, the server (200) transmits the generated second-first video to the first terminal.

Furthermore, the first terminal receives the second-first video transmitted from the server (200) and outputs it in place of the first-first video currently being displayed in the video display area.

In another example, the server (200) performs additional machine learning using the first-second-first label value to the first-second-eighth label value and the first-second-twelfth label value to the first-second-twentieth label value as the Accept labels, the first-second-ninth label value to the first-second-eleventh label value as the Reject labels, first-second-first label value to first-second-twentieth label value for each of the first-second-first time interval to the time first-second-twentieth time interval as the information for the selectively labeled first-second video, the label values for arranging the order (e.g., label values for arranging first-second-first time interval to first-second-seventh time interval, first-second-thirteenth time interval to first-second-seventeenth time interval, first-second-eighth time interval to first-second-tenth time interval, first-second-eighteenth time interval to first-second-twentieth time interval, and first-second-eleventh time interval to first-second-twelfth time interval), the first-second video, the meta information related to the first-second video, the second comparison target video, and the meta information related to the second comparison target video, etc. Based on the results of the additional machine learning, the server generates a second-second video corresponding to the first-first-second video.

Additionally, the server (200) transmits the generated second-second video to the second terminal.

Additionally, the second terminal receives the second-second video transmitted from the server (200) and outputs the received second-second video instead of the first-first-second video that is currently being displayed in the video display area (S2270).

Subsequently, for the multiple raw data provided from the terminal (100), the server (200) repeats the selective labeling process, classification model inference process, prediction model inference process, and the additional selective labeling process for the generated first video, the additional classification model inference process, and the additional prediction model inference process (e.g., from steps S2210 to S2270) for the multiple raw data provided by the multiple terminals (100) related to the specific topic, and generates or updates the second collectively intelligent video related to the specific topic (or related to the comparison target video related to the specific topic).

At this time, the server (200) may provide the most recently updated (or newly generated) second video to the multiple terminals (100) that provided the raw data related to the specific topic, either in real-time or upon request from specific terminals (100).

Thus, all terminals (100) or specific terminals (100) that provided the raw data related to the specific topic to the server (200) can receive the most recent collectively intelligent second video related to the specific topic.

For example, the server (200) repeats the selective labeling process, classification model inference process, prediction model inference process, additional selective labeling process, additional classification model inference process, and additional prediction model inference process for the 101st to the 200th raw data related to the first surgery (e.g., implant surgery), provided by the 101st to the 200th terminals (100), and generates or updates the collectively intelligent second video related to the first surgery (S2280).

FIG. 29 is a flowchart illustrating the information processing method using collective intelligence according to the second embodiment of the present invention.

First, the server (200), in conjunction with the terminal (100), for the specific topic, collects motion-related videos a real human, virtual avatar, or item that are displayed (or managed) on the terminal (100) (or motion-related videos related to at least one of the human, avatar, or item), meta information related to the motion-related videos, and other information. Here, the specific topic (or specific content) may include medical procedures (e.g., treatments, surgeries, etc.), dance, sports events (e.g., soccer, basketball, table tennis, etc.), games, e-sports, etc. The motion-related videos related to humans may be videos capturing (or filming) the motions (or actions/behaviors) of real humans (or person/influencers) involved in the specific topic. Additionally, motion-related videos of avatars and/or items may be videos generated through selective labeling processes, classification model inference processes, prediction model inference processes, etc., based on arbitrary raw data related to the specific topic.

For example, the server (200), in conjunction with the third terminal (100), collects the third motion-related video of the third avatar's motions and meta information related to the third motion-related video outputted by the third terminal (S2910).

Subsequently, the server (200) reconstructs the collected motion-related videos (or the collected motion-related videos of real humans, virtual avatars, or items) as robot motion videos to implement the collected motion-related video as actual robot motions. Here, the robots may include a robotic arm designed to work with the tooth removal VR simulator using visual data from the tooth removal VR simulator, a robotic arm designed to work with the surgery VR simulator using visual data from the surgery VR simulator, a robot designed as a VEHICLE using visual data from the VEHICLE VR simulator, or a humanoid robot designed to work with the VR treadmill.

That is, the server (200), based on the collected motion-related videos and meta information related to the motion-related videos, converts the coordinate information related to the motions of real humans, virtual avatars, or items contained in the motion-related videos into robot coordinate information to apply the motions of real humans, virtual avatars, or items to actual robots, and reconstructs the motion-related videos into robot motion videos (or basic robotics videos).

Additionally, the server (200) transmits the robot motion video (or the reconstructed robot motion video), meta information related to the robot motion video, the collected motion-related video, meta information related to the motion-related video, and the comparison target videos which is searched in relation to the collected motion-related video (or robot motion video) among the multiple comparison target videos managed by the server (200), meta information related to the comparison target videos, to a specific terminal (100), which is selected from multiple pre-registered terminals (100) in the server (200).

Furthermore, the specific terminal (100) receives the robot motion video, meta information related to the robot motion video, the motion-related video, meta information related to the motion-related video, the comparison target video corresponding to the motion-related video (or robot motion video), and the meta information of the comparison target video transmitted from the server (200).

For example, the server (200), based on the third motion-related video related to the motion of the third avatar and the meta information related to the third motion-related video, reconstructs the third motion-related video into a third robot motion video in order to apply the motions of the third avatar to a surgical robot for joint replacement surgery.

Additionally, the server (200) transmits the reconstructed third robot motion video, meta information related to the third robot motion video, the collected third motion-related video of the third avatar's movement, meta information related to third motion-related video, the third comparison target video corresponding to the third motion-related video, and the meta information of the third comparison target video to the fourth terminal (100), which is selected from the multiple pre-registered terminals (100) in the server(200).

Furthermore, the fourth terminal receives the third robot motion video, meta information related to the third robot motion video, the collected third motion-related video of the third avatar's movement, meta information related to third motion-related video, the third comparison target video corresponding to the third motion-related video, and the meta information of the third comparison target video transmitted from the server (200) (S2920).

Subsequently, the server (200) performs selective labeling on the robot motion video. Here, selective labeling refers to assigning a label (or label value) indicating the presence or absence of errors (or anomalies) at specific timestamps (or specific time intervals) in the robot motion video. At this time, timestamps (or time intervals) in the robot motion video that have not been assigned a label (or label value) by the selective labeling may be assigned a default label value (e.g., an approval label).

That is, the server (200), in conjunction with the terminal (100), allows the user to input (or select/touch/control) the labels for specific timestamps (or specific time intervals) in the robot motion video displayed on the terminal (100).

At this time, the terminal (100) runs a dedicated app that was pre-installed and displays the app's execution result screen. The app's execution result screen includes a collection menu (or button/item) for collecting one or more raw data and meta information related to the one or more raw data for a specific topic, a view menu for displaying collected information or information provided by the server (200), and a settings menu for configuring options. At this time, the terminal (100) must be registered as a member of the server (200) that provides the dedicated app. The user logs in using an ID and password or a barcode or QR code containing the ID, allowing them to use the various features of the app (e.g., raw data collection function, hierarchical labeling function for information/video, selective labeling function for information/video, time-series division labeling function for information/video, and body part-specific labeling function for information/video).

Additionally, when a pre-set view menu is selected on the app's execution result screen, the terminal (100) displays the corresponding view screen to show the collected information or data provided by the server (200). The view screen includes a video display area for showing the raw data or generated video, a comparison target video display area for showing comparison target videos, a hierarchical label input menu for selecting variable values (or label values) for hierarchical labeling, a selection label input menu for selecting label values for selective labeling, and a playback bar for providing play/pause/stop functionality for the video.

Furthermore, if the playback bar on the app's execution result screen or the play button on the view screen is selected, the terminal (100) displays (or outputs) the robot motion video in the video display area and displays (or outputs) the comparison target video corresponding to the robot motion video (or comparison target video corresponding to the robot motion video provided by the server (200)) in the comparison target video display area. At this time, the terminal (100) synchronizes the robot motion video and the comparison target video using the corresponding meta information for each video, allowing synchronized videos to be displayed in both the video display area and the comparison target video display area.

Additionally, the terminal (100) allows users to set (or receive/input) labels (or label values), at specific timestamps (or specific time intervals), for correct or incorrect motions of objects within the robot motion video displayed in the video display area of the terminal (100), based on user inputs (e.g., selection/touch/control).

In other words, the terminal (100) receives label values for correct motions (such as a preset approval/accept/ACCEPT label) or incorrect motions (such as a preset rejection/REJECT label) at one or more specific timestamps in the robot motion video.

Thus, for robot motion videos related to a particular topic, the terminal (100) assigns (or receives/input) one or more selection labels (or selection label values) for one or more specific timestamps (or time intervals) according to the input from the expert user associated with that specific topic.

Furthermore, the terminal (100) transmits one or more selected label values at one or more specific timestamps (or specific intervals) related to the robot motion video, meta information related to the robot motion video, and the terminal's (100) identification information to the server (200).

The server (200) receives, from the terminal (100), one or more selected label values at one or more specific timestamps (or specific intervals) related to the robot motion video, meta information related to the robot motion video, and the terminal's (100) identification information.

For example, the fourth terminal (100) runs the Dr. David app pre-installed on the device and displays the app's results screen. At this time, the fourth orthopedic surgeon logs into the Dr. David app using the fourth ID and the fourth password.

When the view menu is selected in the Dr. David app result screen, as shown in FIG. 30, the fourth terminal displays the view screen (3000) corresponding to the selected menu.

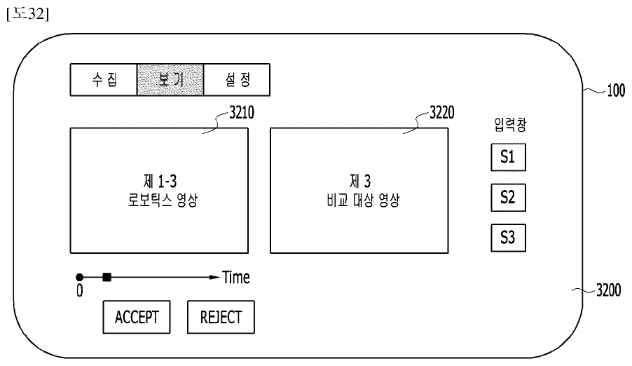

Furthermore, when the playback bar (3010) on the view screen (3000) is selected, as shown in FIG. 31, the fourth terminal outputs the third robot motion video in the video display area (3110) and the third comparison target video related to the third robot motion video in the comparison video display area (3120). The fourth terminal synchronizes and outputs the third robot motion video and the third comparison target video. Here, the third comparison target video is created in a manner similar to [Table 1] to [Table 11] with label classification related to robot motions, and serves as a correct dataset for robot motions, which is output as video.

For the outputted third robot motion video related to the artificial joint surgery, the fourth terminal also references a pre-set number of label classifications and, based on the input of the fourth orthopedic surgeon using the fourth terminal, receives a third-first hierarchical label value (e.g., artificial joint surgery corresponding to S1), a third-second hierarchical label value (e.g., right knee joint corresponding to S2), and a third-third hierarchical label value (e.g., partial replacement surgery corresponding to S3).

The fourth terminal also divides the third robot motion video into 5-second intervals as pre-set.

Additionally, for the third robot motion video displayed in the video display area (3110) within the viewing screen (3100) and the third comparison target video displayed in the comparison target video display area (3120) within the same screen, based on the selection of the fourth specialist surgeon, the fourth terminal receives the third-first Reject label value at the third-first timestamp (e.g., 35 seconds), the third-second Accept label value for the third-second time interval (e.g., 1 minute 10 seconds to 1 minute 30 seconds), the third-third Accept label value for the third-third time interval (e.g., 1 minute 35 seconds to 1 minute 50 seconds), and the third-fourth Accept label value for the third-fourth time interval (e.g., 2 minutes 5 seconds to 2 minutes 25 seconds).

Additionally, the fourth terminal transmits, for the third robot motion video, the third-first Reject label value at the third-first timestamp (e.g., 35 seconds), the third-second Accept label value for the third-second time interval (e.g., 1 minute 10 seconds to 1 minute 30 seconds), the third-third Accept label value for the third-third time interval (e.g., 1 minute 35 seconds to 1 minute 50 seconds), and the third-fourth Accept label value for the third-fourth time interval (e.g., 2 minutes 5 seconds to 2 minutes 25 seconds), the third-first hierarchical label value (e.g., artificial joint surgery corresponding to S1), the third-second hierarchical label value (e.g., right knee joint corresponding to S2), and the third-third hierarchical label value (e.g., partial replacement surgery corresponding to S3), the information for the division (e.g., 5-second interval division), identification information of the fourth terminal, to the server(200)

Additionally, the server (200) receives the following information transmitted from the fourth terminal: the third-first Reject label value at the third-first timestamp (e.g., 35 seconds), the third-second Accept label value for the third-second time interval (e.g., 1 minute 10 seconds to 1 minute 30 seconds), the third-third Accept label value for the third-third time interval (e.g., 1 minute 35 seconds to 1 minute 50 seconds), and the third-fourth Accept label value for the third-fourth time interval (e.g., 2 minutes 5 seconds to 2 minutes 25 seconds), the third-first hierarchical label value (e.g., artificial joint surgery corresponding to S1), the third-second hierarchical label value (e.g., right knee joint corresponding to S2), and the third-third hierarchical label value (e.g., partial replacement surgery corresponding to S3), the information for the division (e.g., 5-second interval division), identification information of the fourth terminal (S2930).

Additionally, based on the information about the selectively labeled robot operation video, the server (200) performs machine learning based on artificial intelligence, generating (or confirming) classification values for the robot operation video based on the results of the machine learning. Here, the classification values of the robot operation video (or the classification values of the robot operation video) can be values classified by the selectively labeled values and hierarchical labeled values for each identical item.

In other words, the server (200) performs machine learning (or artificial intelligence/deep learning) based on the information about the selectively labeled robot operation video as input into a pre-established classification model and generates (or confirms) classification values for the robot operation video based on the results of the machine learning (or artificial intelligence results/deep learning results).

For example, the server (200) performs machine learning based on the following information about the selectively labeled third robot operation video: the third-first Reject label value at the third-first timestamp (e.g., 35 seconds), the third-second Accept label value for the third-second time interval (e.g., 1 minute 10 seconds to 1 minute 30 seconds), the third-third Accept label value for the third-third time interval (e.g., 1 minute 35 seconds to 1 minute 50 seconds), and the third-fourth Accept label value for the third-fourth time interval (e.g., 2 minutes 5 seconds to 2 minutes 25 seconds). The server then classifies the third-second Accept label value, the third-third Accept label value, the third-fourth Accept label value and the third-first Reject label value, for the third robot operation video based on the machine learning results (S2940).

Additionally, the server (200) performs machine learning (or artificial intelligence/deep learning) using the classification values generated for the robot motion video (or the classification values of the robot motion video), the information about the selectively labeled robot motion video, the robot motion video, the meta information related to the robot motion video, the comparison target video, and the meta information related to the comparison target video, as input data. Based on the machine learning (or artificial intelligence/deep learning) results, the server generates the first robotics video corresponding to the robot motion video. At this time, the first robotics video can be an avatar, item, or robot motion-related video generated based on the robot motion video or an updated version of the robot motion video.

In other words, the server (200) performs machine learning (or artificial intelligence/deep learning) using the classification values generated for the robot motion video (or the classification values of the robot motion video), the information about the selectively labeled robot motion video, the robot motion video, the meta information related to the robot motion video, the comparison target video, and the meta information related to the comparison target video as input data into a pre-established prediction model, and generates the first robotics video related to the robot motion video based on the machine learning (or artificial intelligence/deep learning) results.

Additionally, the server (200) transmits the generated first robotics video to the terminal (100).

Additionally, the terminal (100) receives the first robotics video transmitted from the server (200) and outputs the received first robotics video in the video display area instead of the robot motion video currently being displayed. At this time, the terminal (100) may divide the screen of the terminal (100) and output the robot motion video, the comparison target video, and the first robotics video simultaneously in a synchronized state.

For example, for the generated third robot motion video, the server (200) performs machine learning using the following information as input to the prediction model: the classification values for the third-second Accept label value, the third-third Accept label value, the third-fourth Accept label value and the third-first Reject label value, the third-first Reject label value at the third-first timestamp (e.g., 35 seconds), the third-second Accept label value for the third-second time interval (e.g., 1 minute 10 seconds to 1 minute 30 seconds), the third-third Accept label value for the third-third time interval (e.g., 1 minute 35 seconds to 1 minute 50 seconds), and the third-fourth Accept label value for the third-fourth time interval (e.g., 2 minutes 5 seconds to 2 minutes 25 seconds), the third robot motion video, the meta information related to the third robot motion video, the third comparison target video, and the meta information related to the third comparison target video. Based on the machine learning results, the server generates the first-third robotics video related to the third robot operation video.

Additionally, the server (200) transmits the generated first-third robotics video to the fourth terminal.

Additionally, the fourth terminal receives the first-third robotics video transmitted from the server (200), and replaces the third robot operation video currently being displayed in the video display area with the received first-third robotics video, and outputs the first-third robotics video (S2950).

Subsequently, the server (200) performs additional selective labeling on the first robotics video. Here, the additional selective labeling refers to the labeling method where labels (or label values) are set (or attached) to indicate the presence or absence of errors (or anomalies) at another specific timestamps (or another specific time interval) of the first robotics video. At this time, for any timestamps (or time interval) of the first robotics video that does not have a label (or label value) set according to the additional selective labeling, a pre-set default label value (e.g., an approval label) may be applied.

In other words, the server (200), in conjunction with the terminal (100), sets (or receives/inputs) a label (or label value) for another specific timestamps (or another specific time interval) of the first robotics video displayed on the terminal (100), based on user input (or user selection/touch/control) from the terminal (100).

At this time, if the playback bar included in the view screen within the app execution result screen displayed on the terminal (100) is selected, or if the play button in the view screen is selected, the terminal (100) displays (or outputs) the first robotics video in the video display area, and displays (or outputs) the comparison target video corresponding to the robot motion video (or the first robotics video) or the comparison target video corresponding to the robotics motion video/the first robotics video provided by the server (200) in the comparison video display area. At this time, the terminal (100) synchronizes the first robotics video and the comparison target video based on the respective meta information for the first robotics video and the comparison target video, and displays the synchronized first robotics video and comparison target video in the video display area and the comparison video display area, respectively.

Additionally, the terminal (100), for the first robotics video displayed in the video display area of the terminal (100), based on user input (or user selection/touch/control), sets (or receives/inputs) a label (or label value) regarding correct or incorrect motions(or actions) of an object (or avatar) contained in another specific timestamp (or another specific time interval) of the first robotics video.

In other words, at one or more other specific timestamps (or specific time intervals) in the first robotics video displayed in the video display area, the terminal (100) receives input for label values for correct motions (e.g., a pre-set approval/ACCEPT label) or incorrect motions (e.g., a pre-set rejection/REJECT label) based on user input.

Thus, the terminal (100) sets (or receives/inputs) one or more additional selective labels (or additional selective label values) at one or more other specific timestamps (or specific time intervals) in the first robotics video, based on user input from an expert related to the specific subject using the terminal (100).

At this time, the terminal (100) performs the time-series division selective labeling function or the body-part-specific selective labeling function based on user input from the terminal (100).

The terminal (100) performs the time-series division selective labeling function through the following process.

That is, the terminal (100) receives, for each of the multiple sub-robotics videos divided from the first robotics video, the label values for the correct state (or correct motion) (e.g., a pre-set approval/ACCEPT label) or incorrect state (or incorrect motion) (e.g., a pre-set rejection/REJECT label), based on user input for each sub-robotics video. The terminal also receives, based on user input, the label values indicating the order of the multiple sub-robotics videos to sort them (or label values to adjust the division timestamps if the division is incorrect or requires adjustment). Here, the division of the first robotics video into multiple sub-robotics videos may be based on the information of the multiple sub robot motion video divided by performing the hierarchical labeling of the robot motion video, or it may be the result of the artificial intelligence or video analysis functions performed by the server (200) on the robot operation video.

Accordingly, the terminal (100), based on user input of the terminal (100) for the firs robotics video, receives the label values for the correct or incorrect state of the division for each of the multiple sub-robotics videos, and the label values for sorting the multiple sub-robotics videos (or label values for the order of the multiple sub robotics videos/label values for adjusting the division timestamps if the division timestamps is incorrect or needs to be corrected) are also received.

Additionally, the terminal (100) performs the body-part-specific selective labeling function through the following process.

That is, for the avatar (or object) included in the multiple sub-robotics videos divided from the first robotics video, the terminal (100) receives the label values for the sequence of motions of the avatar (or object) included in the multiple sub-robotics videos (or label values indicating whether the sequence of motions of the avatar is correct state or incorrect state), based on user input. The terminal also receives, based on user input, the label values for the sequence of motions in the multiple sub-robotics videos (or the label values for adjusting the sequence of the sub-robotics videos including the avatar) in order to sort the motion sequence by body part for the avatar (or object) included in the multiple sub-robotics videos. Here, the division of the first robotics video into multiple sub-robotics videos may be based on the information of the multiple sub robotics data divided by performing the hierarchical labeling of the robot motion video, or it may result from the artificial intelligence or video analysis functions performed by the server (200).

Accordingly, based on the user input of the terminal (100) for the first robotics video, the terminal (100) receives the label values for the sequence of motions of the avatar (or object) included in the multiple sub-robotics videos derived from the first robotics video (or label values indicating whether the sequence of motions of the avatar is correct or incorrect), and also receives the label values for sorting the sequence of the multiple sub-robotics videos (or the label values for sorting the motions of the avatar included in the multiple sub-robotics videos or label values indicating the sequence of the multiple sub-robotics videos/label values for adjusting the sequence of the sub-robotics videos including the avatar.

Additionally, the terminal (100) transmits one or more additional selective label values, one or more time-series division selective label values, one or more body-part-specific selective label values, the label values for sorting the sequence of the multiple sub-robotics videos, at one or more other specific timestamps (or other specific time interval) related to the first robotics video, and the identification information of the terminal (100) to the server (200).

Additionally, the server (200) receives one or more additional selective label values, one or more time-series division selective label values, one or more body-part-specific selective label values, the label values for sorting the sequence of the multiple sub-robotics videos, at one or more other specific timestamps (or other specific time interval) related to the first robotics video, and the identification information of the terminal (100) transmitted from the terminal (100).

For example, as shown in FIG. 32, when the playback bar in the view screen of the fourth terminal is selected, the fourth terminal outputs the first-third robotics video in the video display area (3210) and outputs the third comparison target video in the comparison video display area (3220). At this time, the fourth terminal outputs the first-third robotics video and the third comparison target video in a synchronized state.

Additionally, the fourth terminal, by referring to pre-set multiple label classifications, receives input from the fourth specialist surgeon of the fourth terminal regarding the detailed motions of the third surgery (e.g., artificial joint surgery) for the outputted first-third robotics video. Based on the input, the fourth terminal divides the first-third robotics video into the first-third-first time interval through the first-third-fifteenth time interval, which are 2 to 4 seconds each, and receives the first-third-first label value to the first-third-fifteenth label value for the first-third-first time interval to the first-third-fifteenth time interval.

Additionally, the fourth terminal receives the label values for sorting the sequence (e.g., label values for sorting the first-third-first time interval to first-third-fifth time interval, first-third-eleventh time interval to first-third-fifteenth time interval, and first-third-sixth time interval to first-third-tenth time interval) based on the input from the fourth specialist surgeon of the fourth terminal for the first-third-first time interval to the first-third-fifteenth time interval.

Additionally, the fourth terminal transmits the first-third-first label value to the first-third-fifteenth label value for the first-third-first time interval to the first-third-fifteenth time interval of the first-third robotics video, the label values for sorting the sequence (e.g., label values for sorting the first-third-first time interval to first-third-fifth time interval, first-third-eleventh time interval to first-third-fifteenth time interval, and first-third-sixth time interval to first-third-tenth time interval), and the identification information of the fourth terminal to the server (200).

Additionally, the server (200) receives the first-third-first label value to the first-third-fifteenth label value for the first-third-first time interval to the first-third-fifteenth time interval of the first-third robotics video, the label values for sorting the sequence (e.g., label values for sorting the first-third-first time interval to first-third-fifth time interval, first-third-eleventh time interval to first-third-fifteenth time interval, and first-third-sixth time interval to first-third-tenth time interval), and the identification information of the fourth terminal transmitted from the fourth terminal (S2960).

Subsequently, the server (200) performs other machine learning based on artificial intelligence, using the information about the additional selectively labeled first robotics video, and generates (or confirms) classification values for the first robotics video based on the other machine learning results. Here, the classification values of the first robotics video (or the classification values of the first robotics video) may be values classified by each items, such as additional selective labeling values and additional hierarchical labeling values.

In other words, the server (200) performs other machine learning (or other artificial intelligence/deep learning) based on the information about the additional selectively labeled first robotics video as input into a pre-set classification model, and generates (or confirms) classification values for the first robotics video based on the other machine learning results (or other artificial intelligence results/deep learning results).

For example, the server (200) performs other machine learning using the information about the additional selectively labeled first-third robotics video, including the first-third-first label value to the first-third-fifteenth label value for the first-third-first time interval to the first-third-fifteenth time interval of the first-third robotics video, as input into the classification model, and based on the other machine learning results, classifies the first-third robotics video into the first-third-first label value to the first-third-fifth label value and the first-third-eleventh label value to the first-third-fifteenth label value as Accept labels, and the first-third-sixth label value to the first-third-tenth label value as Reject labels (S2970).

Subsequently, the server (200) performs other machine learning (or other artificial intelligence/deep learning) using the classification values generated for the first robotics video (or the classification values for the first robotics video), the information about the additional selectively labeled first robotics video, the first robotics video, the meta information related to the first robotics video, the comparison target video, and the meta information related to the comparison target video as input data. Based on the other machine learning results (or other artificial intelligence results/deep learning results), the server generates the second robotics video corresponding to the first robotics video. Here, the second robotics video may be a video related to the motion of an avatar, item, or robot generated based on the first robotics video, or an updated version of the first robotics video.

In other words, the server (200) performs other machine learning (or other artificial intelligence/deep learning) based on the classification values generated for the first robotics video, the information about the additional selectively labeled first robotics video, the first robotics video, the meta information related to the first robotics video, the comparison target video, and the meta information related to the comparison target video as input into a pre-set prediction model, and generates the second robotics video related to the first robotics video based on the other machine learning results (or other artificial intelligence results/deep learning results).

Additionally, the server (200) transmits the generated second robotics video to the terminal (100).

Additionally, the terminal (100) receives the second robotics video transmitted from the server (200), and outputs the received second robotics video in the video display area, replacing the first robotics video currently being displayed. At this time, the terminal (100) may divide the screen and simultaneously output the motion-related video, the comparison target video, the first robotics video, and the second robotics video in a synchronized state.

For example, the server (200) performs other machine learning using the following information as input into the prediction model. The information includes the first-third-first label value to the first-third-fifth label value and the first-third-eleventh label value to the first-third-fifteenth label value as Accept label, the classification value for the first-third-sixth label value to the first-third-tenth label value as Reject label for the first-third robotics video. The information also includes the first-third-first label value to the first-third-fifteenth label value for the first-third-first time interval to the first-third-fifteenth time interval, which are from the additional selectively labeling. The information also includes the label values for sorting the sequence (e.g., the label values for sorting first-third-first time interval to first-third-fifth time interval, first-third-eleventh time interval to first-third-fifteenth time interval, and first-third-sixth time interval to first-third-tenth time interval), the first-third robotics video, the meta information related to the first-third robotics video, the third comparison target video, and the meta information related to the third comparison target video. Based on the other machine learning results, the server generates the second-third robotics video corresponding to the first-third robotics video.

Additionally, the server (200) transmits the generated second-third robotics video to the fourth terminal.

Additionally, the fourth terminal receives the second-third robotics video transmitted from the server (200) and outputs the received second-third robotics video instead of the first-third robotics video currently being displayed in the video display area (S2980).

Subsequently, the server (200), for the specific subject, repeats the processes of selective labeling, processes of classification model inference, processes of prediction model inference, processes of additional selective labeling on the generated first robotics video, processes of additional classification model inference, and processes of additional prediction model inference (e.g., from step S2910 to S2980) on the multiple actual human and virtual avatar or item movement-related videos collected from the multiple terminals (100). Thereby, a second robotics video, collective-intelligence-based, is generated (or updated) in relation to the specific topic.

At this time, the server (200), for the specific subject, may provide the most recently updated (or newly generated) second robotics video to the multiple terminals (100) that provided the actual human or virtual avatar or item movement-related videos, either in real-time or upon request from a specific terminal (100).

Accordingly, all terminals (100) or specific terminals (100) that provided actual human or virtual avatar or item motion-related videos for the specific subject (or for comparison target videos related to the specific subject) can receive the latest second robotics video, aggregated through collective intelligence, for the specific subject.

For example, the server (200) performs the processes of selective labeling, the processes of classification model inference, the processes of prediction model inference, the processes of additional selective labeling on the generated first robotics video, the processes of additional classification model inference, and the processes of additional prediction model inference for each of the 201st to 300th motion-related videos provided by the 201st to 300th terminals (100) regarding the third surgery (e.g., artificial joint surgery), thereby updating the second robotics video, aggregated through collective intelligence, for the third surgery (S2990).

The embodiments of the present invention, as described above, perform labeling on one or more raw data items related to specific content provided by the user. It performs machine learning function on the labeled raw data using pre-set classification models and prediction models, and performs additional labeling on the first video output from the prediction model, and performs additional machine learning on the additionally labeled first video using the classification models and prediction models to output the second video. This process enables the avatar and/or item related to the raw data to be provided to the user and improves the inference capabilities of artificial intelligence through the labeling of raw data.

Additionally, as described above, the embodiments of the present invention reconstruct actual human or virtual avatar or item movement-related videos as robot operation videos. It performs labeling on the reconstructed robot operation videos, performs learning on the labeled robot operation videos using pre-set classification models and prediction models, performs additional labeling on the first robotics video output from the learning process, and performs additional learning on the additionally labeled first robotics video using the classification models and prediction models to output the second robotics video. This iterative application of the artificial intelligence results to the classification models and prediction models of the artificial intelligence improves the learning capabilities of the artificial intelligence.

The foregoing description can be modified and varied by those skilled in the art without departing from the essential characteristics of the present invention. Therefore, the embodiments disclosed in the present invention are intended to be illustrative, not restrictive, and the scope of the present invention should not be limited by these embodiments. The scope of protection of the present invention should be interpreted by the following claims, and all technical ideas within the scope of equivalence should be considered to be included in the scope of the present invention.

### The Mode for Carrying Out the Invention

The mode for carrying out the invention has been described together with the best mode for carrying out the invention.

### INDUSTRIAL APPLICABILITY

The present invention performs labeling on one or more raw data related to specific content provided by a user, carries out a learning fuction through a predetermined classification model and prediction model with respect to the labeled raw data, performs additional labeling on a first image which is an output value of the prediction model, carries out additional learning through the classification model and the prediction model with respect to the additionally labeled first image to output a second image, and thereby provides the user with an avatar and/or item related to the raw data, and improves the inference capability of artificial intelligence through the labelling of the raw data, thus having industrial applicability.

What is claimed is:

1. An information processing system using collective intelligence comprises:
a terminal,
transmitting at least one more raw data collected in relation to a specific subject, meta information related to the raw data, comparison target video, meta information related to the comparison target video, and identification information of the terminal;
and
a server,
receiving at least the one more raw data related to the specific subject, the meta information related to the raw data, the comparison target video, the meta information related to the comparison target video, and identification information of the terminal transmitted from the terminal,
generating selective labeling information on at least the one more raw data in conjunction with the terminal,
generating classification values for the raw data based on a result of machine learning based on the selective labeling information on the raw data,
generating a first video corresponding to the raw data based on a result of machine learning based on the classification values of the raw data, the selective labeling information on the raw data, the raw data, the meta information related to the raw data, the comparison target video, and meta information related to the comparison target video, and
transmitting the generated first video to the terminal.

2. The information processing system of claim 1,
wherein the server generates additional selective labeling information on the generated first video in conjunction with the terminal,
generates classification values for the generated first video based on a result of machine learning based on the additional selective labeling information on the generated first video, generates a second video corresponding to the first video based on a result of machine learning based on the classification values of the generated first video, the additional selective labeling information on the generated first video, the generated first video, the meta information related to the generated first video, the comparison target video, and the meta information related to the comparison target video, and
transmits the generated second video to the terminal.

3. The information processing system of claim 1,
wherein the server generates collectivized second video in relation to the specific subject, using the multiple raw data provided from the multiple terminals, by repeatedly performing:
the step of generating the selective labeling information on the raw data,
the step of generating the classification values for the raw data,
the step of generating the first video corresponding to the raw data,
the step of generating the additional selective labeling information on the generated first video,
the step of generating the classification values on the generated first video, and
the step of generating the second video corresponding to the first video.

4. A method for processing information using collective intelligence, comprising:
receiving, by a server, at least one more raw data related to a specific subject, meta information related to the raw data, comparison target video, meta information related to the comparison target video, and identification information of a terminal transmitted from the terminal;
generating, by the server in conjunction with the terminal, selective labeling information on the at least one raw data;
generating, by the server, classification values for the raw data based on a result of machine learning based on the selective labeling information on the raw data;
generating, by the server, a first video corresponding to the raw data based on a result of machine learning based on the classification values of the raw data, the selective labeling information on the raw data, the raw data, the meta information related to the raw data, the comparison target video, and the meta information related to the comparison target video; and
transmitting, by the server, the generated first video to the terminal; and
outputting, by the terminal, the first video transmitted from the server.

5. The method for processing information of claim 4,
the step of generating the selective labeling information on the at least one raw data includes,
setting the selective labeling information for at least one more specific timestamp or specific time interval for the raw data displayed on the terminal, according to user input.

6. The method for processing information of claim 4,
the step of generating the selective labeling information on the at least one raw data includes,
setting the selective labeling information for a correct motion or a incorrect motion of an object movement included in the raw data at a specific timestamp or a specific time interval for the raw data displayed on the terminal, according to user input.

7. The method for processing information of claim 4,
after or before the step of the generating the selective labeling information, further comprising,
performing hierarchical labeling on the at least one more raw data in conjunction with the terminal.

8. The method for processing information of claim 7,
wherein the step of performing hierarchical labeling includes:
setting the selective labeling information for at least one more a different specific timestamp or a different specific time interval for the raw data displayed on the terminal, according to user input, based on the plurality of the pre-set selective labeling information for the raw data;
dividing the raw data into a plurality of sub-raw data.

9. The method for processing information of claim 4,
wherein the step of generating classification values for the raw data based on the result of machine learning includes,
performing machine learning using the raw data already having the selective labeling information as input data, and
generating classification values for the raw data without the selective labeling information based on the result of the machine learning.

10. The method for processing information of claim 4,
the step of generating a first video corresponding to the raw data based on the result of the machine learning includes:
performing machine learning using the classification values for the raw data, the selective labeling information on the raw data, the raw data, the meta information related to the raw data, the comparison target video, and the meta information related to the comparison target video as input data, and
generating the first video related to the raw data based on the result of the machine learning.

11. The method for processing information of claim 4, further comprising:
generating, by the server in conjunction with the terminal, additional selective labeling information on the generated first video;
generating, by the server, classification values for the generated first video based on a result of machine learning based on the additional selective labeling information on the generated first video;
generating, by the server, a second video corresponding to the generated first video based on a result of machine learning based on the classification values of the generated first video, the selective labeling information on the generated first video, the generated first video, the meta information related to the generated first video, the comparison target video, and the meta information related to the comparison target video;
transmitting, by the server, the generated second video to the terminal;
outputting, by the terminal, the second video transmitted from the server; and
generating, by the server, collectivized second video in relation to the specific subject, using the multiple raw data provided from the multiple terminals, by repeatedly performing the selective labeling generating process, the classification values generating process, the first video generation process, additional selective labeling process for the generated first video, classification values generating process, and second video generation process.

12. The method for processing information of claim 11,
wherein the step of generating the additional selective labeling information includes:
dividing, by the terminal, the generated first video into a plurality of sub-videos based on a plurality of divided sub-raw data according to hierarchical labeling for the raw data;
receiving, by the terminal, label values for correct motion or incorrect motion for each of the plurality of the divided sub-videos according to user input;
receiving, by the terminal, label values indicating an order of the plurality of sub-videos according to user input for sorting the order of the plurality of sub-videos;
transmitting, by the terminal, the label values for correct motion of incorrect motion for the plurality of the sub-videos, the label values for sorting the order of the plurality of the sub-videos, and the identification information of the terminal to the server; and
receiving, by the server, the label values for correct motion or incorrect motion for the plurality of the sub-videos, the label values for sorting the order of the plurality of the sub-videos, and the identification information of the terminal transmitted from the terminal according to a process of a time-series division selective labeling function for the generated first video.

13. The method for processing information of claim 11,
wherein the step of generating the additional selective labeling information includes:
dividing, by the terminal, the generated first video into a plurality of sub-videos based on a plurality of divided sub-raw data according to hierarchical labeling for the raw data;
receiving, by the terminal, label values for an order of avatar's motions included in the plurality of the sub-videos;
receiving, by the terminal, label values for an order of the multiple sub-videos according to user input, to sort the order of the avatar's motions included in the plurality of the sub-videos by body part;
transmitting, by the terminal, the label values for the order of the avatar's motions included in the multiple sub-videos, the label values for sorting the order of the multiple sub-videos, and the identification information of the terminal to the server; and
receiving, by the server, the label values for the order of the avatar's motions included in the multiple sub-videos, the label values for sorting the order of the multiple sub-videos, and the identification information of the terminal transmitted from the terminal, according to a process of a body parts selective labeling function for the generated first video.

14. An information processing system using collective intelligence comprising:
a server,
collecting motion-related videos related to at least one more of actual humans, avatars, and items in relation to a specific subject, and meta information related to the motion-related videos,
constructing the collected motion-related videos into robot motion videos to implement the collected motion-related videos as actual robot motions,
generating selective labeling information on the robot motion videos in conjunction with a terminal,
generating classification values for the robot motion videos based on a result of machine learning based on artificial intelligence using the selective labeling information on the robot motion videos,
generating a first robotics video corresponding to the robot motion videos based on the classification values of the generated robot motion videos, the selective labeling information on the robot motion videos, the robot motion videos, meta information related to the robot motion videos, comparison target videos, and meta information related to the comparison target videos,
transmitting the generated first robotics video to the terminal; and
the terminal, outputting the first robotics video transmitted from the server.

15. The information processing system of claim 14,
wherein the server,
generates additional selective labeling information on the generated first robotics video in conjunction with the terminal,
generates classification values for the generated first robotics video based on a result of machine learning based on the additional selective labeling information on the generated first robotics video,
generates a second robotics video corresponding to the generated first robotics video based on a result of machine learning based on the classification values of the generated first robotics video, the additional selective labeling information on the generated first robotics video, the generated first robotics video, meta information related to the generated first robotics video, comparison target video, and meta information related to the comparison target video, and
transmits the generated second robotics video to the terminal

16. The information processing system of claim 15,
wherein the server generates a collectivized second robotics video related to the specific subject,
in relation to the specific subject, for the motion-related videos related to at least one more actual humans, avatars, and items provided from the plurality of terminals,
by repeatedly performing:
the step of generating the selective labeling information on the robot motion videos,
the step of generating the classification values for the robot motion videos,
the step of generating the first robotics video corresponding to the robot motion videos,
the step of generating the additional selective labeling information on the generated first robotics video,
the step of generating the classification values for the generated first robotics video, and
the step of generating the second video corresponding to the generated first robotics video.

17. A method for processing information using collective intelligence, comprising:
collecting, by a server, motion-related videos related to at least one more of actual humans, avatars, and items in relation to a specific subject, and meta information related to the motion-related videos;
reconstructing, by the server, the collected motion-related videos into robot motion videos to implement the collected motion-related videos as actual robot motions;
generating, by the server in conjunction with a terminal, selective labeling information on the robot motion videos;
generating, by the server, classification values for the robot motion videos based on a result of machine learning using artificial intelligence based on the selective labeling information on the robot motion videos;
generating, by the server, a first robotics video corresponding to the robot motion videos based on the classification values of the generated robot motion videos, the selective labeling information on the robot motion videos, the robot motion videos, meta information related to the robot motion videos, comparison target videos, and meta information related to the comparison target videos;
transmitting, by the server, the generated first robotics video to the terminal; and
outputting, by the terminal, the first robotics video transmitted from the server.

18. The method for processing information of claim 17, further comprising:
performing hierarchical labeling on the robot motion videos, by the server in conjunction with the terminal, before or after the step of generating the selective labeling information on the robot motion videos.

19. The method for processing information of claim 17, further comprising:
generating, by the server, additional selective labeling information on the generated first robotics video in conjunction with the terminal;
generating, by the server, classification values for the generated first robotics video based on a result of machine learning based on the additional selective labeling information on the generated first robotics video,
generating, by the server, a second robotics video corresponding to the generated first robotics video based on a result of machine learning based on the classification values of the generated first robotics video, the additional selective labeling information on the generated first robotics video, the generated first robotics video, meta information related to the generated first robotics video, comparison target video, and meta information related to the comparison target video,
transmitting, by the server, the generated second robotics video to the terminal,
outputting, by the terminal, the first robotics video transmitted from the server, and
generating, by the server, a collectivized second robotics video related to the specific subject in relation to the specific subject, for the motion-related videos related to at least one more actual humans, avatars, and items provided from the plurality of terminals,
wherein the step of the generating the collectivized second robotics video related to the specific subject includes,
by repeatedly performing:
the step of generating the selective labeling information on the robot motion videos,
the step of generating the classification values for the robot motion videos,
the step of generating the first robotics video corresponding to the robot motion videos,
the step of generating the additional selective labeling information on the generated first robotics video,
the step of generating the classification values for the generated first robotics video, and
the step of generating the second video corresponding to the generated first robotics video.
